(19) United States
(12) Patent Application Publication
(10) Pub. No.: US 2026/0027736 A1
(43) Pub. Date: Jan. 29, 2026

(54) HEAD AND NECK ASSEMBLY OF A HUMANOID ROBOT

(71) Applicant: Figure AI Inc., San Jose, CA (US)

(72) Inventors: Keyvan Yeganeh, San Jose, CA (US); Katarina Rodak, San Jose, CA (US); David McCall, San Jose, CA (US); Sydney Hardy, San Jose, CA (US)

(21) Appl. No.: 19/286,240

(22) Filed: Jul. 30, 2025

Related U.S. Application Data
(63) Continuation-in-part of application No. 29/954,572, filed on Jul. 27, 2024.
(63) Continuation-in-part of application No. 19/033,973, filed on Jan. 22, 2025.
Application No. 19/033,973 is a continuation-in-part of application No. 29/935,680, filed on Apr. 3, 2024.
Application No. 29/935,680 is a continuation-in-part of application No. 29/928,748, filed on Feb. 15, 2024.
Application No. 29/928,748 is a continuation-in-part of application No. 29/889,764, filed on Apr. 17, 2023.
Application No. 19/033,973 is a continuation-in-part of application No. 18/919,263, filed on Oct. 17, 2024, now Pat. No. 12,365,094.
(60) Provisional application No. 63/626,105, filed on Jan. 29, 2024.
(60) Provisional application No. 63/626,030, filed on Feb. 21, 2024.
(60) Provisional application No. 63/626,028, filed on Feb. 27, 2024.
(60) Provisional application No. 63/626,035, filed on Feb. 27, 2024.
(60) Provisional application No. 63/561,316, filed on Mar. 5, 2024.
(60) Provisional application No. 63/564,741, filed on Mar. 13, 2024.
(60) Provisional application No. 63/626,034, filed on Mar. 13, 2024.
(60) Provisional application No. 63/566,595, filed on Mar. 18, 2024.
(60) Provisional application No. 63/573,226, filed on Apr. 2, 2024.
(60) Provisional application No. 63/573,528, filed on Apr. 3, 2024.
(60) Provisional application No. 63/634,697, filed on Apr. 16, 2024.
(60) Provisional application No. 63/626,037, filed on May 28, 2024.
(60) Provisional application No. 63/677,087, filed on Jul. 30, 2024.
(60) Provisional application No. 63/700,749, filed on Sep. 29, 2024.
(60) Provisional application No. 63/705,715, filed on Oct. 10, 2024.
(60) Provisional application No. 63/705,929, filed on Oct. 10, 2024.
(60) Provisional application No. 63/707,547, filed on Oct. 15, 2024.
(60) Provisional application No. 63/707,897, filed on Oct. 16, 2024.
(60) Provisional application No. 63/707,949, filed on Oct. 16, 2024.
(60) Provisional application No. 63/708,003, filed on Oct. 16, 2024.
(60) Provisional application No. 63/717,321, filed on Nov. 7, 2024.
(60) Provisional application No. 63/718,771, filed on Nov. 11, 2024.
(60) Provisional application No. 63/770,620, filed on Mar. 12, 2025.
(60) Provisional application No. 63/770,654, filed on Mar. 12, 2025.
(60) Provisional application No. 63/839,612, filed on Jul. 7, 2025.

(51) Int. Cl. B25J 19/02; B25J 9/00; B25J 19/00

(52) U.S. Cl. CPC B25J 19/023; B25J 9/0009; B25J 19/0075

(57) ABSTRACT

A head and neck assembly for a humanoid robot, including a head portion having an exterior surface defining an overall shape resembling a human head; a neck portion extending from the head portion; a head housing assembly enclosing the head portion and neck portion; an electronics assembly contained within the head housing assembly; and a head actuator assembly configured to move the head portion relative to a torso of the humanoid robot.

### CROSS REFERENCE TO RELATED APPLICATIONS

This application is: (i) a continuation in-part of U.S. Design patent application Ser. No. 29/954,572 filed Jul. 27, 2024; (ii) a continuation in-part of U.S. patent application Ser. No. 19/033,973 filed Jan. 22, 2025, which is: (a) a continuation in-part of U.S. Design patent application Ser. No. 29/935,680 filed Apr. 3, 2024, which is a continuation in-part of U.S. Design patent application Ser. No. 29/928,748 filed Feb. 15, 2024, which is a continuation in-part of Ser. No. 29/889,764 filed Apr. 17, 2023, (b) a continuation in-part of Ser. No. 18/919,263 filed Oct. 17, 2024, and (c) claims priority to and the benefit of U.S. Provisional Patent Application Nos. 63/561,316 filed Mar. 5, 2024, 63/564,741 filed Mar. 13, 2024, 63/566,595 filed Mar. 18, 2024, 63/573,226 filed Apr. 2, 2024, 63/573,528 filed Apr. 3, 2024, 63/626,028 filed Feb. 27, 2024, 63/626,030 filed Feb. 21, 2024, 63/626,034 filed Mar. 13, 2024, 63/626,035 filed Feb. 27, 2024, 63/626,037 filed May 28, 2024, 63/626,105 filed Jan. 29, 2024, 63/634,697 filed Apr. 16, 2024, 63/707,547 filed Oct. 15, 2024, 63/707,897 filed Oct. 16, 2024, 63/707,949 filed Oct. 16, 2024, 63/708,003 filed Oct. 16, 2024; and (iii) this application claims the benefit of and priority to U.S. Provisional Patent Application Nos. 63/677,087 filed Jul. 30, 2024, 63/700,749 filed Sep. 29, 2024, 63/705,715 filed Oct. 10, 2024, 63/705,929 filed Oct. 10, 2024, 63/717,321 filed Nov. 7, 2024, 63/718,771 filed Nov. 11, 2024, 63/770,620 filed Mar. 12, 2025, 63/770,654 filed Mar. 12, 2025, and 63/839,612 filed Jul. 7, 2025, each of which is expressly incorporated by reference herein in its entirety.

### TECHNICAL FIELD

This disclosure relates to a head of a robot, specifically a head of a humanoid robot. The head of the humanoid robot includes a plurality of components configured to provide the robot with the ability to communicate with nearby humans using a display that is protected by a frontal shell.

### BACKGROUND

The current labor market within the United States is confronting an unprecedented labor shortage, characterized by over 10 million unfilled positions. A significant proportion of these vacancies pertain to occupations that are deemed unsafe, undesirable, or involve hazardous working conditions. This persistent and escalating shortage of available labor has created an urgent imperative for the development and deployment of advanced robotic systems capable of performing tasks that are unattractive or pose risks to human workers. To effectively address this widening gap in the workforce, it has become critical to design and engineer robots that can operate with high efficiency and reliability within human-centric environments. These environments often demand capabilities such as physical dexterity, sustained endurance, precise manipulation, and the ability to navigate complex spaces designed for humans.

Advanced general-purpose humanoid robots have emerged as a promising solution to meet these challenges. These robots are meticulously engineered to replicate the human form and emulate human functionality, typically featuring bipedal locomotion with two legs, bilateral manipulation abilities with two arms, and a display to facilitate interaction with human users. The anthropomorphic design enables these robots to seamlessly integrate into environments originally designed for humans, thereby minimizing the need for extensive modifications to existing infrastructures. As these robots endeavor to mimic the human body, it becomes essential to equip them with a head design that not only meets functional requirements but also enhances aesthetic appeal and durability. The head is a critical component for human-robot interaction, serving as the primary interface through which the robot communicates and engages with nearby humans. A well-designed head can significantly improve the robot's ability to convey information, express intentions, and respond to human cues, thereby fostering a more intuitive and natural interaction experience.

To meet these requirements, the present disclosure introduces an innovative head design that incorporates a versatile display system. This display is capable of adapting its visual output to suit a wide range of operational tasks by rendering icons, graphics, expressive animations, and informative text. The adaptability of the display allows the robot to present contextually relevant information and provide visual feedback, all of which enhance the robot's ability to interact effectively with human users. By making the robot's appearance more relatable and intuitive, the display fosters improved engagement and facilitates smoother human-robot collaboration.

Considering the sensitive and fragile nature of display technologies, and acknowledging the often challenging and harsh environments in which humanoid robots are deployed, it is advantageous to position the display behind a protective shield. This strategic placement serves multiple purposes. Firstly, the shield safeguards the display from potential contaminants such as dust, moisture, chemicals, and particulate matter that could adversely affect its performance and longevity. Secondly, the shield provides protection against physical impacts, vibrations, and mechanical stresses that may occur during operation, especially in industrial or outdoor settings. By mitigating the risks of damage to the display, the shield contributes to the overall robustness and reliability of the robot. Moreover, the integration of the display behind a shield contributes to a sleek and futuristic aesthetic, enhancing the robot's visual appeal.

In summary, the disclosed head design addresses the critical need for a durable, adaptable, and aesthetically pleasing interface for a general-purpose humanoid robot. By combining a versatile display with the frontal shell, the design ensures that the robot can effectively communicate and interact with humans while withstanding the rigors of diverse operational environments. This innovation not only enhances the functionality and user experience but also extends the operational lifespan of the robot, thereby providing a more sustainable and cost-effective solution for addressing the current labor market challenges.

### SUMMARY OF THE INVENTION

The presently disclosed subject matter is directed to a humanoid robot comprising an upper region including: (i) a torso, (ii) a pair of arm assemblies coupled to the torso, and (iii) a head and neck assembly coupled to the torso and having a neck portion and a head portion coupled to the neck portion. The robot includes a central region coupled to the upper region. The robot includes a lower region coupled to the central region and spaced apart from the upper region, the lower region including a pair of legs. While the humanoid robot is in a neutral state and the head portion is in a forward-facing orientation, the head portion includes a display screen oriented in the forward-facing orientation. The head portion includes an upper camera and a lower camera positioned in the head portion, wherein both the upper camera and the lower camera are oriented in the forward-facing orientation and horizontally centered on and aligned along a sagittal plane of the humanoid robot, and wherein the upper camera is positioned above the display screen and the lower camera is positioned below the display screen. The head portion includes a frontal shield having a curvilinear outer surface positioned forward of each of the upper camera, the lower camera, and the display screen, wherein the display screen is covered by and visible through the frontal shield, and wherein the frontal shield includes an upper aperture aligned with the upper camera through which a line of sight of the upper camera extends and the frontal shield includes a lower aperture aligned with the lower camera through which a line of sight of the lower camera extends.

In certain designs, the robot's head is equipped with a frontal shield featuring a complex, curvilinear outer surface that curves both vertically and horizontally. This shield has upper and lower apertures, where the upper aperture is dedicated exclusively to the line of sight for the upper camera. The lenses for the upper and lower cameras are positioned within these respective apertures and behind the shield's surface. These cameras work together to provide stereo vision, with their parallel lines of sight oriented along the sagittal plane and angled downward between 6 and 9 degrees. Their forward-facing fields of view, which range from approximately 57.6 to 86.4 degrees, overlap. The head portion may also feature a horizontally curved display screen, a rear shell, and a separate illumination assembly that lights up a side region between the frontal shield and rear shell, ensuring visibility from angles where the main display might be obscured.

The presently disclosed subject matter is directed to a humanoid robot comprising an upper region including: (i) a torso, (ii) a pair of arm assemblies coupled to the torso, and (iii) a head and neck assembly coupled to the torso and having a neck portion and a head portion coupled to the neck portion. The robot includes a central region coupled to the upper region. The robot includes a lower region coupled to the central region and spaced apart from the upper region, the lower region including a pair of legs. While the humanoid robot is in a neutral state and the head portion is in a forward-facing orientation, the head portion includes a display screen oriented in the forward-facing orientation. The head portion includes an upper camera and a lower camera positioned in the head portion, wherein both the upper camera and the lower camera are oriented in the forward-facing orientation and horizontally centered on and aligned along a sagittal plane of the humanoid robot, wherein the upper camera is positioned above the display screen and the lower camera is positioned below the display screen, and wherein a forward-facing field of view of the upper camera overlaps with a forward-facing field of view of the lower camera. The head portion includes an intermediate cover that includes: an upper sensor opening aligned with the upper camera through which a line of sight of the upper camera extends, a lower sensor opening aligned with the lower camera through which a line of sight of the lower camera extends, and a screen opening contoured to the shape of the display screen. The head portion includes a frontal shield having a curvilinear outer surface positioned forward of each of the intermediate shell, the upper camera, the lower camera, and the display screen, wherein the display screen is visible through the frontal shield, and wherein a line of sight of the upper camera extends through the frontal shield.

In some embodiments, the humanoid robot's head portion features upper and lower cameras that cooperate to provide stereo vision, with their lines of sight being parallel and oriented along the sagittal plane. The lower camera's line of sight may extend through the frontal shield, whereas the upper camera's line of sight passes through an upper sensor opening in an intermediate cover, which exclusively permits passage for the upper camera and no other camera or sensor. Additionally, the head portion can include a rear shell and an illumination assembly, distinct from the screen display, that is configured to illuminate a region on the side of the head between the frontal shield and the rear shell. This illuminated region is visible from positions where at least a portion of the screen display is obscured from view.

The presently disclosed subject matter is directed to a humanoid robot comprising an upper region including: (i) a torso, (ii) a pair of arm assemblies coupled to the torso, and (iii) a head and neck assembly coupled to the torso and having a neck portion and a head portion coupled to the neck portion. The robot includes a central region coupled to the upper region. The robot includes a lower region coupled to the central region and spaced apart from the upper region, the lower region including a pair of legs. While the humanoid robot is in a neutral state and the head portion is in a forward-facing orientation, the head portion includes a first camera in the head portion and having a first line of sight. The head portion includes a second camera positioned in the head portion and having a second line of sight that is substantially parallel with the first line of sight, and wherein the first and second cameras are not coupled to a single PCB. The head portion includes an intermediate cover that includes: (i) a first sensor opening aligned with an extent of the first camera, and wherein the first sensor opening does not permit a line of sight of another camera, and (ii) a second sensor opening aligned with an extent of the second camera, and wherein the second sensor opening does not permit a line of sight of another camera. The head portion includes a shield that is positioned forward of: (i) an extent of the intermediate cover, (ii) an extent of the first camera, and (iii) an extent of the second camera, and wherein: (i) at least a portion of the first and second cameras is visible through the shield, and (ii) at least a portion of the first and second cameras is obscured by the intermediate cover.

In some embodiments, the humanoid robot is defined by sagittal and transverse planes, where its lines of sight are positioned within a reference plane running parallel to either of them. The head includes a shield with a complex outer surface, having a larger radius of curvature along a horizontal plane and a smaller radius of curvature along a vertical plane. The shield's rear edge is non-linear due to a recess and forms an obtuse angle with a horizontal reference plane. Positioned behind this shield is a curved display. The head also features a rear shell and a separate illumination assembly that lights up a region between the shield and the shell, ensuring this area is visible from angles where the main display might be obscured.

The presently disclosed subject matter is directed to a humanoid robot comprising an upper region including: (i) a torso, (ii) a pair of arm assemblies coupled to the torso, and (iii) a head and neck assembly coupled to the torso and having a neck portion and a head portion coupled to the neck portion. The robot includes a central region coupled to the upper region. The robot includes a lower region coupled to the central region and spaced apart from the upper region, the lower region including a pair of legs. While the humanoid robot is in a neutral state and the head portion is in a forward-facing orientation, the head portion includes a first camera positioned in the head portion and having a first line of sight. The head portion includes a head housing assembly: (i) having an intermediate cover, and wherein said intermediate cover is configured to obscure from an external viewpoint at least a portion of the first camera, (ii) an exterior surface that includes a non-zero radius of curvature along an extent of a vertical plane. An aperture is formed in an extent of the head housing assembly and configured to allow the first line of sight to extend therethrough, and wherein said aperture includes at least one substantially semi-circular edge.

In some embodiments, the robot further comprises a second camera: (i) that is separate from the first camera, and (ii) is positioned in the head portion and rearward of an head housing assembly, and wherein the second camera includes a second line of sight that is substantially parallel with the first line of sight. In some embodiments, the head portion includes an illumination assembly to light up a region on its side, and this illuminated region may be visible from a position where a separate display on the robot is not. The head housing's exterior surface can feature a radius of curvature along a horizontal plane that is greater than its non-zero radius of curvature along a vertical plane. Additionally, the head housing assembly can have a rear edge that forms an obtuse angle with a horizontal reference plane and includes a recess, causing the edge to be non-linear.

The presently disclosed subject matter is directed to a humanoid robot comprising an upper region including: (i) a torso, (ii) a pair of arm assemblies coupled to the torso, and (iii) a head and neck assembly coupled to the torso and having a neck portion and a head portion coupled to the neck portion. The robot includes a central region coupled to the upper region. The robot includes a lower region coupled to the central region and spaced apart from the upper region, the lower region including a pair of legs. The robot includes a vertical reference plane abuts an extent of a rear surface of the neck portion. The robot includes a horizontal reference plane that intersects with the vertical reference plane and extends through the rear surface of the neck portion. While the humanoid robot is in a neutral state and the head portion is in a forward-facing orientation, the head portion includes a shield: (i) having an outer surface that has: (a) a first radius of curvature along an extent of a horizontal plane, and (b) a second radius of curvature along an extent of a vertical plane, and wherein the second radius of curvature is less than the first radius of curvature, (ii) including a rear edge, and wherein an obtuse angle is formed between an extent of the rear edge and the horizontal reference plane, and (iii) lacking an extent that is positioned rearward of the vertical reference plane.

In some versions, the robot's head includes a shield or intermediate cover with an aperture, providing a dedicated line of sight for a first camera that is not shared by any other sensor. A separate, second camera may be located in the head behind the shield, with its line of sight running substantially parallel to the first camera's. Both lines of sight lie within a single reference plane that is parallel to the robot's sagittal or transverse plane. This head portion also contains a display positioned rearward of the shield, and another camera may be situated below this display, which is curved along a horizontal plane. The shield itself can feature a non-linear rear edge due to a recess. Furthermore, the head may incorporate a rear shell and a separate illumination assembly that lights up a region on the side of the head between the shield and rear shell, ensuring visibility from angles where the main display might be obscured.

The presently disclosed subject matter is directed to a head and neck assembly for a humanoid robot. Particularly, the assembly comprises a head portion having an exterior surface defining an overall shape resembling a human head, wherein the exterior surface is substantially curvilinear and lacks pronounced human facial structures. The assembly includes a frontal shield covering a frontal region of the head portion, wherein the frontal shield is formed as a separate and distinct component from internal electronics. The assembly includes a display positioned behind the frontal shield and separated therefrom by a gap. The assembly includes a head actuator assembly configured to move the head portion relative to a torso of the humanoid robot.

The presently disclosed subject matter is directed to a head housing assembly for a humanoid robot. Particularly, the assembly comprises a frontal shield having a curved surface and sensor apertures. The assembly includes an intermediate cover positioned behind the frontal shield and defining a first sub-volume. The assembly includes a rear shell coupled to the intermediate cover and defining a second sub-volume separated from the first sub-volume by the intermediate cover. The assembly includes a plurality of light emitter housings formed in the intermediate cover and positioned in gaps between the frontal shield and the rear shell.

The presently disclosed subject matter is directed to a vision system for a humanoid robot head. Particularly, the system comprises an upper camera positioned in a forehead region of the head. The system includes a lower camera positioned in a chin region of the head, wherein the upper camera and lower camera are arranged in a vertical orientation along a sagittal plane of the robot. The system includes a computing device running a custom-built algorithm configured to integrate data from the upper camera and lower camera to provide stereo vision.

The presently disclosed subject matter is directed to a method of manufacturing a humanoid robot head. Particularly, the method comprises forming a head housing assembly with a frontal shield separate from internal display components. The method includes positioning a curved display behind the frontal shield with a gap therebetween. The method includes arranging two cameras in a vertical orientation within the head housing assembly. The method includes installing light emitters in lateral regions of the head housing assembly between the frontal shield and a rear shell.

The presently disclosed subject matter is directed to a humanoid robot head. Particularly, the head comprises a housing defining an egg-shaped exterior surface that is symmetrical about a sagittal plane and asymmetrical about transverse and coronal planes. The head includes a deformable neck cover extending from the housing to a torso connection, wherein the neck cover conceals head actuators positioned underneath. The head includes an electronics assembly contained within the housing.

The presently disclosed subject matter is directed to a display system for a humanoid robot. Particularly, the system comprises a curved display screen positioned at an angle relative to a coronal plane and tilted downward from horizontal. The system includes a transparent frontal shield covering the curved display screen and separated therefrom. The system includes sensor apertures formed in the frontal shield to provide unobstructed access for cameras positioned behind the frontal shield.

The presently disclosed subject matter is directed to a communication system for a humanoid robot head. Particularly, the system comprises a plurality of light emitting assemblies positioned on lateral sides of the head in temporal and buccal regions. The system includes a plurality of antennas housed within the head. The system includes wireless communication modules positioned in a torso of the robot and connected to the antennas via wiring extending through a neck portion.

The presently disclosed subject matter is directed to a modular robot head assembly. Particularly, the assembly comprises a removable frontal shield configured to protect internal components. The assembly includes an intermediate cover defining openings for a display and sensors. The assembly includes a rear shell coupled to the intermediate cover. The assembly includes an internal mounting frame configured to support electronic components and couple to a head actuator.

The presently disclosed subject matter is directed to a method of providing stereo vision in a humanoid robot. Particularly, the method comprises capturing image data with an upper camera positioned above a display screen. The method includes capturing image data with a lower camera positioned below the display screen, wherein the upper and lower cameras are vertically aligned. The method includes processing the image data from both cameras using a custom algorithm to generate three-dimensional spatial information.

The presently disclosed subject matter is directed to a protective system for a humanoid robot head. Particularly, the system comprises a freeform frontal shield having a curved surface with varying curvature. The system includes a display positioned behind the frontal shield as a separate component. The system includes physical apertures in the frontal shield aligned with camera lenses to prevent signal distortion while maintaining protection of internal electronics.

The presently disclosed subject matter is directed to a head and neck assembly for a humanoid robot. Particularly, the assembly comprises a head portion having an exterior surface defining an overall shape resembling a human head, wherein the head portion includes a frontal region, a crown region, a chin region, and lateral temple regions. The assembly includes a neck portion extending downwardly from the head portion. The assembly includes a head housing assembly enclosing the head portion and neck portion, the head housing assembly including a frontal shield made of transparent impact-resistant polymer covering the frontal region and crown region, an intermediate cover positioned rearward of the frontal shield and defining a rectangular screen opening and vertically aligned upper and lower sensor openings, and a rear shell coupled to the intermediate cover. The assembly includes an electronics assembly contained within the head housing assembly, the electronics assembly including a curved rectangular display positioned in the screen opening and angled downward at 6.7 to 8.2 degrees relative to a horizontal plane, an upper camera positioned in the upper sensor opening above the curved display, a lower camera positioned in the lower sensor opening below the curved display and vertically aligned with the upper camera in a sagittal plane of the humanoid robot, and four light emitting assemblies positioned laterally on opposite sides of the head portion in the temple regions and adjacent to trapezoidal recesses formed in a rear perimeter edge of the frontal shield. The assembly includes a head actuator assembly configured to move the head portion relative to a torso of the humanoid robot, the head actuator assembly including a head twist actuator having a vertical rotational axis and a head nod actuator having a horizontal rotational axis perpendicular to the vertical rotational axis, wherein the head twist actuator is located at a base of the neck portion.

The presently disclosed subject matter is directed to a humanoid robot head assembly. Particularly, the assembly comprises a head housing having a curved exterior surface with a maximum width in a temple region located 30-50% of a head height from a top end, wherein the head housing includes a freeform frontal shield extending from a chin region to a crown region and a rear shell coupled to an intermediate cover, wherein the head housing is symmetrical about a sagittal plane and asymmetrical about coronal and transverse planes. The assembly includes a display system including a curved rectangular display having a convex curvature conforming to the intermediate cover and tilted downward at an angle of 6.7 to 7.9 degrees from horizontal, wherein the curved display is positioned behind the frontal shield with a gap of at least 2 mm therebetween. The assembly includes a dual camera vision system including an upper camera positioned in a frontal region above the curved display and a lower camera positioned in a chin region below the curved display, wherein both cameras are vertically aligned in a sagittal plane and angled downward at 6.7 to 8.2 degrees relative to a horizontal plane, and wherein neither camera is positioned where human eyes would typically be located. The assembly includes an illumination system including first and second light emitting assemblies positioned on a left lateral side of the head housing and third and fourth light emitting assemblies positioned on a right lateral side of the head housing, wherein each light emitting assembly includes an LED light emitter housed in a trapezoidal light emitter housing formed in the intermediate cover and positioned in corresponding recesses of the frontal shield. The assembly includes a two-degree-of-freedom actuator system including a head twist actuator for rotating the head housing about a vertical axis and a head nod actuator for tilting the head housing about a horizontal axis, wherein the actuators are coupled by an actuator coupler extending through a neck portion, and wherein the head twist actuator is positioned at a base of the neck portion where it interfaces with a torso.

The presently disclosed subject matter is directed to a robotic head system. Particularly, the system comprises a head enclosure having an egg-shaped exterior profile when viewed frontally, the head enclosure including a transparent frontal shield covering frontal and crown regions, an intermediate support member defining openings for electronic components, and a rear cover completing a head shape, wherein the head enclosure has a maximum width in a temple region located 30-50% of a head height from a top end. The system includes a curved display screen mounted within the intermediate support member and visible through the frontal shield, wherein the curved display screen has a rectangular shape with convex curvature and is angled downward between 6.4 and 7.9 degrees from horizontal, and wherein the curved display screen occupies between 25% and 50% of the frontal shield. The system includes a stereo vision system including an upper RGB camera positioned above the curved display screen in a forehead region and a lower RGB camera positioned below the curved display screen in a chin region, wherein the upper and lower cameras are vertically spaced apart and aligned in a central sagittal plane of the head enclosure, and wherein the cameras are configured to provide stereo vision through vertical rather than horizontal arrangement. The system includes a status indication system including four LED light emitting devices positioned in lateral regions of the head enclosure, wherein two light emitting devices are positioned on each side of the head enclosure in temple and buccal regions, and wherein each light emitting device is housed in an angled trapezoidal housing formed in the intermediate support member and positioned in corresponding recesses in the frontal shield. The system includes a dual-actuator head movement system including a first rotary actuator providing yaw rotation about a vertical axis and a second rotary actuator providing pitch rotation about a horizontal axis perpendicular to the vertical axis, wherein the first rotary actuator is positioned at a base of a neck structure where it interfaces with a torso.

The presently disclosed subject matter is directed to a head and neck assembly for a bipedal humanoid robot. Particularly, the assembly comprises a head portion with an exterior surface having curvilinear characteristics and lacking flat surfaces, wherein the head portion includes anatomical regions corresponding to frontal, temporal, occipital, and chin regions of a human head, and wherein the head portion has a maximum width in the temporal region located 30-50% of a head height from a top end. The assembly includes a housing system including a curved frontal shield made of impact-resistant transparent polymer having a thickness greater than 2 mm extending from the chin region to a crown region, an intermediate cover positioned behind the frontal shield and including sensor apertures and a rectangular display opening, and a rear shell coupled to the intermediate cover to enclose internal components. The assembly includes an integrated electronics system including a curved rectangular display positioned in the display opening and angled downward at 6.7 to 8.2 degrees, an upper camera mounted above the display in the frontal region, a lower camera mounted below the display in the chin region and vertically aligned with the upper camera in a sagittal plane, wireless communication antennas including Wi-Fi and 5G antennas positioned within the head portion, and four lateral illumination assemblies positioned adjacent to a rear edge of the frontal shield in trapezoidal recesses. The assembly includes a neck assembly including an upper securement member coupled to the head portion, a deformable neck cover extending from the head portion to a torso connection, and internal actuator components. The assembly includes a head movement system including a head twist actuator for horizontal rotation and a head nod actuator for vertical tilting, wherein the head twist actuator is positioned at a base of the neck assembly where it interfaces with a torso, and wherein the head nod actuator is positioned within the head portion.

The presently disclosed subject matter is directed to a humanoid robot head system. Particularly, the system comprises a head structure having an overall egg-shaped configuration with a maximum width in temple regions and tapering toward chin and crown regions, wherein the head structure includes a frontal transparent shield having a thickness of at least 2 mm, an intermediate structural member, and a rear cover assembly, and wherein the head structure is symmetrical about a sagittal plane and asymmetrical about coronal and transverse planes. The system includes a visual display system including a curved rectangular screen positioned behind the frontal shield and angled downward at 6.7 to 7.9 degrees from horizontal, wherein the curved screen has a convex curvature and is separated from the frontal shield by a protective gap of at least 2 mm, and wherein the curved screen occupies between 25% and 50% of the frontal shield. The system includes a dual-camera sensing system including an upper camera positioned in a forehead region above the curved screen and a lower camera positioned in a chin region below the curved screen, wherein both cameras are aligned vertically in a sagittal plane of the robot and oriented at a downward angle of 6.7 to 8.2 degrees, and wherein the cameras are configured to provide stereo vision through vertical rather than horizontal arrangement. The system includes a lateral lighting system including four LED light emitting assemblies positioned on opposite sides of the head structure, wherein each light emitting assembly includes an LED light source housed in a trapezoidal housing formed in the intermediate structural member and positioned adjacent to corresponding recesses in the frontal shield. The system includes a two-axis head articulation system including a vertical-axis twist actuator positioned at a base of a neck region where it interfaces with a torso and a horizontal-axis nod actuator positioned within the head structure, connected by an actuator coupling mechanism extending through the neck region.

The presently disclosed subject matter is directed to a robotic head assembly. Particularly, the assembly comprises a head housing having a human-like exterior shape with curved surfaces and including a freeform frontal shield covering frontal regions, an intermediate cover with defined openings, and a rear shell completing the head enclosure, wherein the head housing has a maximum width in a temple region located 30-50% of a head height from a top end. The assembly includes a display assembly including a curved display screen positioned within the intermediate cover and visible through the frontal shield, wherein the display screen is rectangular with convex curvature and tilted downward at an angle between 6.7 and 7.9 degrees from horizontal, and wherein the display screen occupies between 25% and 50% of the frontal shield. The assembly includes a vertically-aligned camera system including an upper camera positioned above the display screen in a frontal region and a lower camera positioned below the display screen in a chin region, wherein both cameras are centered in a sagittal plane and angled downward at 6.7 to 8.2 degrees, and wherein the cameras are configured to provide stereo vision through vertical rather than horizontal arrangement. The assembly includes a side-mounted illumination system including four LED light emitting assemblies positioned laterally on the head housing in temple and buccal regions, wherein each light emitting assembly includes an LED light source housed in an angled trapezoidal housing and positioned in corresponding recesses formed in a rear edge of the frontal shield. The assembly includes a neck structure extending from the head housing and including actuator mounting components. The assembly includes a head positioning system including a twist actuator providing rotation about a vertical axis and positioned at a base of the neck structure where it interfaces with a torso, and a nod actuator providing rotation about a horizontal axis perpendicular to the vertical axis and positioned within the head housing.

The presently disclosed subject matter is directed to a head and neck system for a humanoid robot. Particularly, the system comprises a head component having an exterior profile resembling a human head with curved surfaces and including frontal, temporal, occipital, and chin anatomical regions, wherein the head component has a maximum width in the temporal regions located 30-50% of a head height from a top end. The system includes a multi-part housing including a transparent frontal shield having a thickness of at least 2 mm extending from the chin region to a crown region, an intermediate support structure defining apertures for electronic components, and a rear cover coupled to the intermediate support structure. The system includes an electronic display system including a curved rectangular display mounted in the intermediate support structure and angled downward at 6.7 to 7.9 degrees from horizontal, wherein the curved display is positioned behind the frontal shield with a separation gap of at least 2 mm, and wherein the curved display occupies between 25% and 50% of the frontal shield. The system includes a stereo camera system including an upper camera positioned in the frontal region above the curved display and a lower camera positioned in the chin region below the curved display, wherein the cameras are vertically aligned in a central sagittal plane and oriented downward at 6.7 to 8.2 degrees, and wherein the cameras are configured to provide stereo vision through vertical rather than horizontal arrangement. The system includes a status lighting system including four LED light emitting units positioned on lateral sides of the head component in temple and buccal regions, wherein each light emitting unit is housed in a trapezoidal housing formed in the intermediate support structure and positioned in corresponding recesses in the frontal shield. The system includes a neck assembly extending from the head component and including structural support elements. The system includes a dual-actuator movement system including a head twist actuator for yaw rotation positioned at a base of the neck assembly where it interfaces with a torso, and a head nod actuator for pitch rotation positioned within the head component, wherein the actuators are mechanically coupled to provide two degrees of freedom.

The presently disclosed subject matter is directed to a humanoid robot head apparatus. Particularly, the apparatus comprises a head structure with an egg-shaped exterior when viewed from front and top, the head structure including a curved frontal shield made of transparent impact-resistant polymer having a thickness of at least 2 mm, an intermediate structural component with defined openings, and a rear shell assembly, wherein the head structure has a maximum width in temple regions located 30-50% of a head height from a top end. The apparatus includes a curved display device positioned within the intermediate structural component and visible through the frontal shield, wherein the display device has a rectangular configuration with convex curvature and is angled downward between 6.7 and 7.9 degrees from horizontal, and wherein the display device occupies between 25% and 50% of the frontal shield. The apparatus includes a dual-camera vision apparatus including an upper camera mounted above the display device in a forehead region and a lower camera mounted below the display device in a chin region, wherein both cameras are vertically aligned in a sagittal plane and angled downward at 6.7 to 8.2 degrees, and wherein the cameras are configured to provide stereo vision through vertical rather than horizontal arrangement. The apparatus includes a lateral illumination apparatus including four LED light sources positioned on opposite sides of the head structure in temple and buccal regions, wherein each light source is contained in an angled trapezoidal housing formed in the intermediate structural component and positioned adjacent to corresponding recesses in the frontal shield. The apparatus includes a neck component extending downward from the head structure and containing actuator elements. The apparatus includes a head articulation apparatus including a twist actuator providing rotation about a vertical axis and positioned at a base of the neck component where it interfaces with a torso, and a nod actuator providing rotation about a horizontal axis and positioned within the head structure, wherein the actuators are connected by a coupling mechanism.

The presently disclosed subject matter is directed to a robotic head and neck unit. Particularly, the unit comprises a head portion having a curved exterior surface defining a human-like head shape with frontal, temporal, occipital, and chin regions, wherein the head portion has a maximum width in the temporal regions located 30-50% of a head height from a top end. The unit includes a housing assembly including a freeform transparent frontal shield having a thickness of at least 2 mm covering the frontal and crown regions, an intermediate cover positioned rearward of the frontal shield and defining sensor and display openings, and a rear shell coupled to the intermediate cover. The unit includes a display unit including a curved rectangular screen positioned in the display opening and angled downward at 6.7 to 7.9 degrees from horizontal, wherein the screen has convex curvature and is separated from the frontal shield by a gap of at least 2 mm, and wherein the screen occupies between 25% and 50% of the frontal shield. The unit includes a camera unit including an upper camera positioned above the screen in the frontal region and a lower camera positioned below the screen in the chin region, wherein both cameras are vertically aligned in a sagittal plane and angled downward at 6.7 to 8.2 degrees, and wherein the cameras are configured to provide stereo vision through vertical rather than horizontal arrangement. The unit includes a lighting unit including four LED light emitters positioned laterally on the head portion in temple and buccal regions, wherein each light emitter is housed in a trapezoidal housing formed in the intermediate cover and positioned in corresponding recesses of the frontal shield. The unit includes a neck unit extending from the head portion and including support structures. The unit includes an actuation unit including a twist actuator for horizontal rotation positioned at a base of the neck unit where it interfaces with a torso, and a nod actuator for vertical rotation positioned within the head portion, wherein the actuators provide coordinated head movement with two degrees of freedom.

The presently disclosed subject matter is directed to a head system for a bipedal humanoid robot. Particularly, the system comprises a head assembly having an exterior shape resembling a human head with curved surfaces and including anatomical regions corresponding to frontal, temporal, occipital, and chin areas, wherein the head assembly has a maximum width in the temporal regions located 30-50% of a head height from a top end. The system includes a protective housing including a curved frontal shield made of transparent impact-resistant polymer having a thickness of at least 2 mm extending from chin to crown regions, an intermediate support member with defined apertures, and a rear cover completing the head enclosure. The system includes a visual interface including a curved display positioned behind the frontal shield and angled downward at 6.7 to 7.9 degrees from horizontal, wherein the display has rectangular shape with convex curvature and is separated from the frontal shield by a gap of at least 2 mm, and wherein the display occupies between 25% and 50% of the frontal shield. The system includes a sensing interface including an upper camera positioned above the display in the frontal region and a lower camera positioned below the display in the chin region, wherein both cameras are vertically aligned in a sagittal plane and angled downward at 6.7 to 8.2 degrees, and wherein the cameras are configured to provide stereo vision through vertical rather than horizontal arrangement. The system includes a signaling interface including four LED light emitting elements positioned on lateral sides of the head assembly in temple and buccal regions, wherein each element is housed in an angled trapezoidal housing formed in the intermediate support member and positioned adjacent to corresponding recesses in the frontal shield. The system includes a neck interface extending from the head assembly and containing mechanical components. The system includes a motion interface including a twist actuator providing yaw rotation positioned at a base of the neck interface where it interfaces with a torso, and a nod actuator providing pitch rotation positioned within the head assembly, wherein the actuators are coupled to provide two-axis head movement.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate with, connect with, command and/or be commanded by, control and/or be controlled by, and/or interact with;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIG. 2-3A and the corresponding rotational axes of said actuators;

FIG. 4 is a block diagram of sensors for the humanoid robot of FIGS. 2-3B;

FIG. 5 is a block diagram of a communication interface for the humanoid robot of FIGS. 2-3B;

FIG. 6 a perspective view of a head and neck assembly of a robot of FIG. 3A, shown with a frontal shell;

FIG. 7 a perspective view of the head and neck assembly of a robot of FIG. 6, shown without the frontal shell;

FIG. 8 a front view of the head and neck assembly of FIG. 6;

FIG. 9 a front view of the head and neck assembly of FIG. 6, shown without the frontal shell;

FIG. 10A is a side view of the head and neck assembly of FIG. 6;

FIG. 10B is a side view of the head and neck assembly of FIG. 10A, wherein the center and reference planes are indicated;

FIG. 10C is a side view of the head and neck assembly of FIG. 10A showing various anatomical regions of the head portion and a field of view of a camera included in the sensor assembly;

FIG. 11 is a side view of the head and neck assembly of FIGS. 10A-10C, shown without the frontal shell;

FIG. 12 an exploded view of the head of FIG. 6, showing: (i) a housing that includes the frontal shell, (ii) internal support assembly, (iii) electronics assembly that includes a screen and a pair of vertically arranged sensors, and (iv) a head twist and head nod actuators;

FIG. 13 is a front view of the head of FIG. 6;

FIG. 14 is a perspective cross-sectional view of the head along line 14-14 of FIG. 13;

FIG. 15 is a perspective cross-sectional view of the head along line 15-15 of FIG. 13;

FIG. 16 a left side view of the head portion of FIG. 6;

FIG. 17 a front view of the head portion of FIG. 16;

FIG. 18 shows a perspective view of the electronics assembly contained in the head of FIG. 17, the electronics assembly including vertically spaced cameras, a screen, controller, antenni, and light assembly;

FIG. 19 shows a top view of the electronics assembly of FIG. 18;

FIG. 20 shows a front view of the electronics assembly of FIG. 18;

FIG. 21 is a cross-sectional view of the electronics assembly taken along line 21-21 of FIG. 20;

FIG. 22 is a top view of the robot of FIG. 3A, shown with a field of view of the cameras in the head;

FIG. 23 is a perspective view of the display included in the electronics assembly of FIG. 18;

FIG. 24 is a side view of the display included in the head and neck assembly of FIG. 23;

FIG. 25 is a top view of the display included in the head and neck assembly of FIG. 23;

FIG. 26A is a front view of the head of the robot of FIG. 6 showing an icon indicating a battery status on an/or through the frontal shell;

FIG. 26B is a front view of the head of the robot showing another icon indicating a low battery status on an/or through the frontal shell;

FIG. 26C is a front view of the head of the robot showing another icon indicating an alert or system failure event on an/or through the frontal shell;

FIG. 26D is a front view of the head of the robot showing an icon indicating a particular mode of the robot on an/or through the frontal shell;

FIG. 26E is a front view of the head of the robot showing an icon indicating a particular task being performed by the robot on an/or through the frontal shell;

FIG. 26F is a front view of the head of the robot showing an additional robot status icon on an/or through the frontal shell;

FIG. 27 is a side view of the head and neck assembly of FIG. 6 showing orientations and fields of view of the upper and lower cameras included in the electronics assembly;

FIG. 28 is an enlarged view of a portion of the head and neck assembly of FIG. 27 showing one of the illumination assemblies;

FIG. 29 is a cross section taken along line 30-30 in FIG. 28 showing the illumination assemblies mounted to lateral sides of the head to reside between the frontal shell and the rear shell;

FIG. 30 is an enlarged view of a portion of the head and neck assembly of FIG. 30 showing one of the illumination assemblies in detail;

FIG. 31 is a perspective view of the illumination assemblies;

FIG. 32 illustrates the field of view of the sensors of the electronics assembly of the head of the robot of FIG. 6; and

FIG. 33 illustrates the depth of field of the sensors of the electronics assembly of the head of the robot of FIG. 6.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

The head disclosed in this Application is designed to be a component within a robot system, potentially a versatile humanoid robot. The head is coupled to the torso and includes two actuators that allow the head to: (i) twist or rotate, and (ii) tilt or change the pitch. Unlike conventional robots, said actuators are hidden underneath a deformable neck shield. Said deformable neck shield may be made from a polymer-based material and is designed to extend to the jaw line of the head enclosure and into a rear extent of the head enclosure. The deformable neck shield does not extend into the side regions of the head. This configuration ensures that the neck shield is sufficiently attached to the head, but minimizes the head's surface area covered by said deformable neck shield. Minimizing the coverage of the deformable neck shield in the side regions of the head allows for the inclusion of more durable materials in these regions without using overlapping materials. This is beneficial over conventional robot heads because it reduces materials and/or increases the lateral protection for the electronics contained within said head.

The disclosed head has an overall shape that generally resembles a human head. As such, the head does not include large flat surfaces (e.g., opposed sides of a head, or is not in the shape of: (a) cube, (b) hexagonal prism, or (c) pentagonal prism). Instead, almost all the surfaces in said robot head are curvilinear or have a curvilinear aspect. However, as shown in the Figures, the head does include sensor covers or multiple lenses. Said sensor cover or lenses include one positioned in a lower portion of the head and one in an upper portion of the head. Both sensor covers or lenses are designed to decrease sensor signal distortion that may be caused if said sensor signals are required to travel through a curvilinear cover, shield, or lens. Additionally, while said overall head shape is designed to be human-like, the disclosed head lacks human facial structures (e.g. checks, eye sockets, or other moving structures). The head enclosure may be injection molded or 3D printed, wherein said outer shell may include any known polymer material, including urethanes, PMMA, ABS, nylons, polyamides, etc.

The frontal region of the head is covered by a large freeform frontal transparent/semi-transparent shield, wherein the curvature of said frontal shield changes horizontally and laterally across the head. The freeform nature of the frontal shield causes said shield to be separate and distinct from the screen that is positioned behind said shield. This positional relationship allows the frontal shield to protect the screen and electronics contained in the head from damage, which provides a substantial benefit over conventional robot heads that lack this feature. For example, certain tasks (e.g., moving and cutting sheet metal) that the robot may perform on the factory floor may damage or break a screen that is not protected behind a shield. As shown in the Figures, the frontal shield does not extend over the entirety of the crown region 370, behind an auricular region 356, nor does it extend into the rear region.

The disclosed frontal visor or shield may occupy any portion or ratio of the robot's head and may have any configuration. The frontal visor or shield may be made from any known material (e.g. glass, plastic, or another polymer) and may be curved in a single direction, curved in two directions (e.g., vertically and horizontally), or may be a freeform design that may include multiple curves. The visor may not extend to the crown of the head, and may not extend rearward pass a location where a humans ears would be located. In other embodiment, the entire head may be a shield, the shield may extent around rearward of the car location, and/or the shield may extend past the crown of the head. The shield is designed to protect the sensors and electronics (e.g., the shield) from environmental factors (e.g., dust). However, in other embodiments, said frontal visor or shield may be omitted and replaced with a monolithic screen or a plurality of screens. In further embodiments, said head may include a combination of an exterior screen and shields that extend above and below said screen.

Unlike conventional robot heads, the disclosed head includes a screen that is curved in a single direction and is positioned on an angle relative to the coronal plane. The curved nature of the screen allows for the inclusion of a larger screen within the head, which increases the amount of information that can be displayed on said screen. This provides a benefit over conventional robot heads that lack this feature because said conventional robots must either forgo displaying as much information (while not altering the size of the information) or increase the size of their head. Additionally, being able to display more information on the disclosed screen is beneficial because the disclosed robot may not include any other screens within said robot. Further, including one primary single screen within the robot is beneficial because it reduces: (i) battery usage of said screens and (ii) the inclusion of fragile components within the robot. The screen may be configured to display robot status, sensor data, and/or other relevant information to a nearby human. However, said screen is not configured to display human-like facial features (e.g. eyes, nose, mouth, etc.), but instead is designed to use generic blocks or shapes. The disclosed screen may occupy the entire frontal visor or shield, between 100% and 75% of the frontal visor or shield, between 75% and 50% of the frontal visor or shield, between 50% and 25% of the frontal visor or shield, or less than 25% of the frontal visor or shield. In other words, the screen size to frontal visor or shield size may be any ratio. The screen may be curved in a single direction, curved in two directions (e.g., vertically and horizontally), or may be a freeform design that may include multiple curves.

Unlike conventional robot heads, the disclosed head includes two separate sensor assemblies. The first sensor assembly is positioned within the robot's forehead region, while the second sensor assembly is positioned within the robot's chin region. The position of the first sensor assembly: (i) enables a larger screen to be utilized within the head, and (ii) allows the robot to see into a bin that is placed on a high shelf, while the position of the second sensor assembly enables the robot to see what it is carrying (including looking into a bin). By using two sensor assemblies, the robot can see in stereo vision. Said stereo vision is provided by the combination of the vertically arranged sensor assemblies, not horizontal, triangular, or other geometric arrangements. The vertical arrangement of two sensor assemblies (i.e. cameras) reduces the number of sensors for frontal data collection to two cameras positioned vertically instead of three or more cameras. This reduction of sensor assemblies is beneficial because it reduces the heat generated within the head and creates additional free space within said head.

The sensor assemblies that are arranged in a vertical orientation are directly coupled to a computing device (e.g. processor) that can be located in the head of the robot, wherein said computing device is running a custom-built algorithm to integrate the data from the top and bottom sensor assemblies (e.g., cameras) into stereo vision or to extract 3D information from the collected data. The vertical camera arrangement allows freedom to minimize the space required by the cameras; thus, allowing more room for other electronics within the head. For example, the placement of the sensor assemblies can recover at least 10% of the space that was required by commercially available (e.g. RealSense by Intel) stereo vision sensors. In other words, the robot lacks commercially available sensors (e.g., RealSense by Intel or other pre-packaged camera systems) that include horizontally spaced cameras. In addition to recovering said space by omitting said commercially available sensors, the vertical arrangement of the sensor assemblies with the custom-built algorithms reduces heat generation, removes supply issues, reduces latency, and reduces power consumption. Furthermore, the disclosed vertical configuration of sensors is beneficial over conventional robots that lack the second sensor assembly that is positioned in the chin region because said conventional robots must bend and turn their neck more to obtain the data captured from said second sensor assembly. Also, neither sensor assembly is positioned where a human's eyes would typically be located, nor on either side of the robot's head.

The head of the robot also includes antennas designed to allow for data transfer into and out of the robot. Specifically, the robot can include wireless communication modules (e.g., cellular, Wi-Fi, Bluetooth, WiMAX, HomeRF, Z-Wave, Zigbec, THREAD, RFID, NFC, and/or etc.) that are connected to said antennas. For example, said robot may include a 5G cellular radio coupled to one or more of the antennas and a Wi-Fi radio (e.g., 5 GHz or 2.4 GHZ) coupled to another antenna. Although Wi-Fi transmission can be prone to packet loss, a secondary protocol can enhance reliability. In various embodiments, a plurality of 5G cellular radios can be used for wireless communication to maximize bandwidth and help ensure connectivity. The 5G cellular radios can be positioned in the torso and wired via the neck to the antennas within the head.

Finally, the robot head includes indicator lights that are positioned adjacent to a rear edge of the frontal shield. The indicator light enables said robot to communicate with humans without using the screen that is disposed behind said frontal shield. Typically, said indicator lights may be used to communicate the working state (e.g., yellow), idle state (e.g., green), charging state (e.g., blinking), error state (e.g., red), or other general states. This is beneficial because it can limit the information that needs to be displayed on the screen and allows a human, robot, or machine to receive information from the robot, when said human, robot, or machine is directly to one side of the robot (where said human, robot, or machine could not see the screen). Also, the indicator lights use less battery power than the screen and may be able to relay information more quickly to said human, robot, or machine. It should be understood that in other embodiments, indicator lights may be a continuous light that surrounds the frontal shield, may be two lights that surround a substantial extent of both sides of the frontal shield, may be more than two indicators on each side of the shield, may be a single indicator on each side of the shield, may be omitted, replaced with one or more TFT screens, partially replaced by one or more TFT screens, or moved to another location on the robot's head.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: is a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

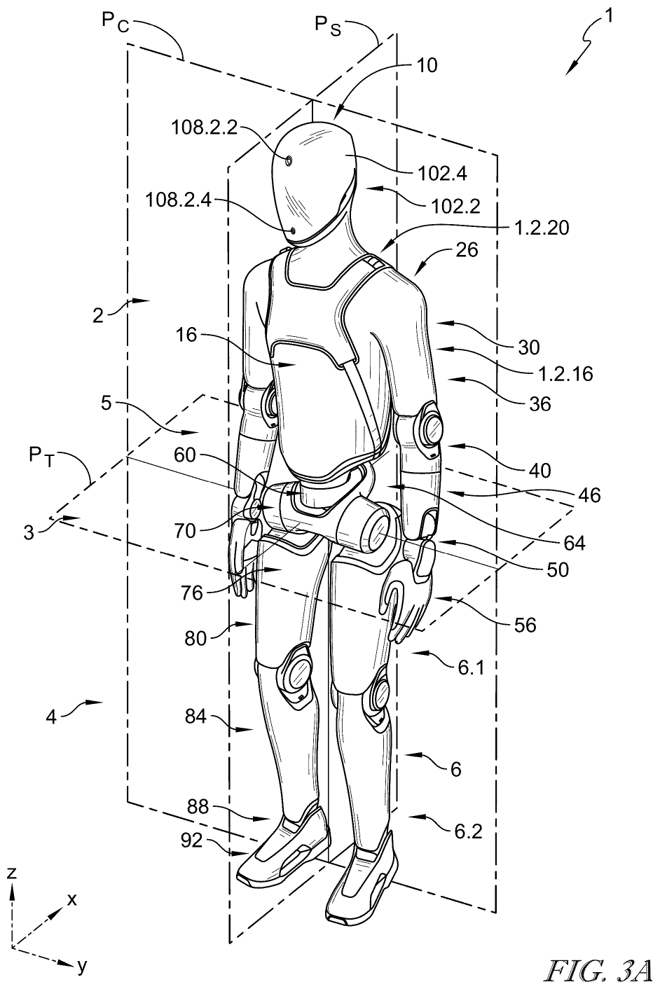

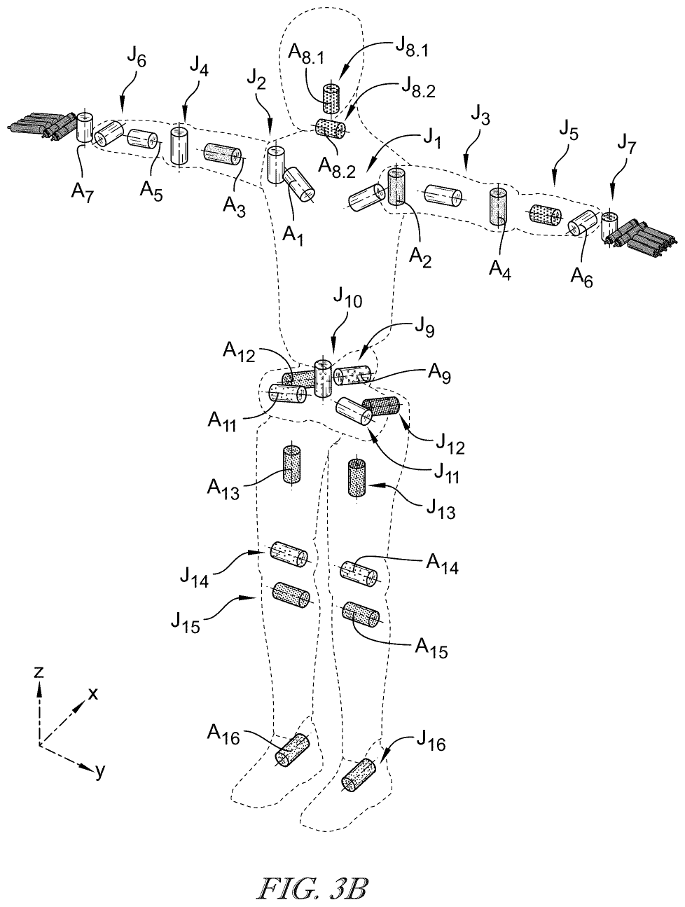

Neutral State: a state where the robot is standing upright on a horizontal support surface and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g. FIGS. 3A and 3B), the coronal plane (P_{C}) is a Vertical Plane that Contains the Rotational Axes A₁₁ of the Hip Flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. In the illustrative embodiment, the coronal plane (P_{C}) is a plane that is colinear with the rotational axes A₁₁ of the hip flex actuators (J11) and rotational axis A₁₀ of torso twist actuator (J10). Also, as shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position expressed in radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

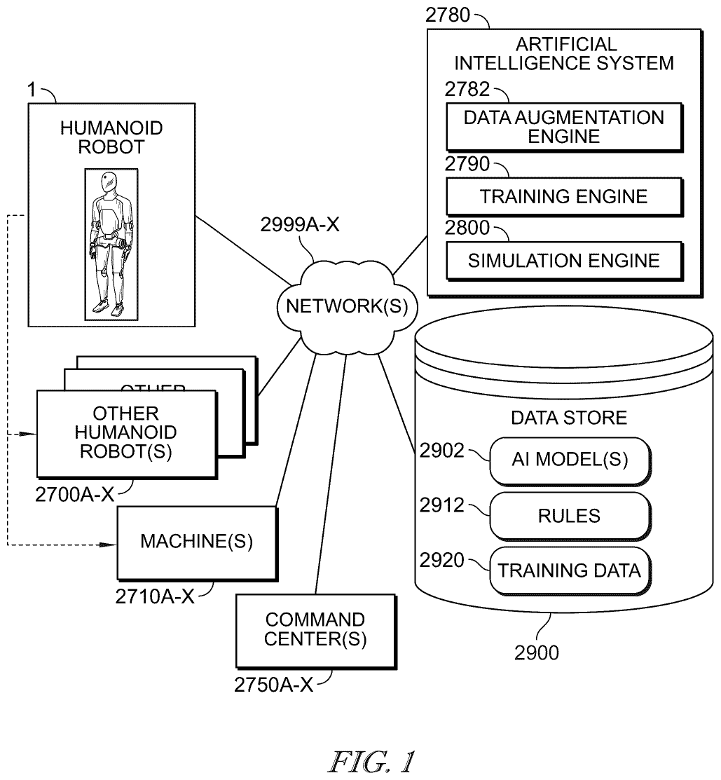

FIG. 1 illustrates an exemplary network and/or operational environment in which a humanoid robot (also referred to as a bipedal robot) 1, which is further detailed in additional FIGs. herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2780 to build, train, alter, fine-tune, or modify a previously generated model, a new model, and/or rules. Advantageously, the simulation engine 2800 may is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

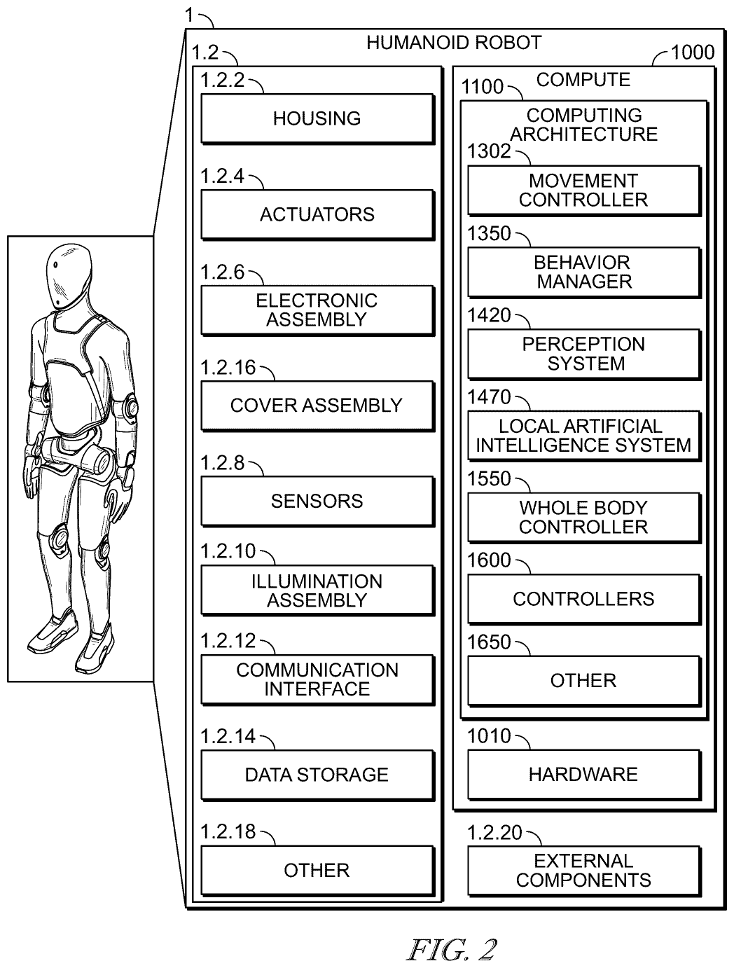

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

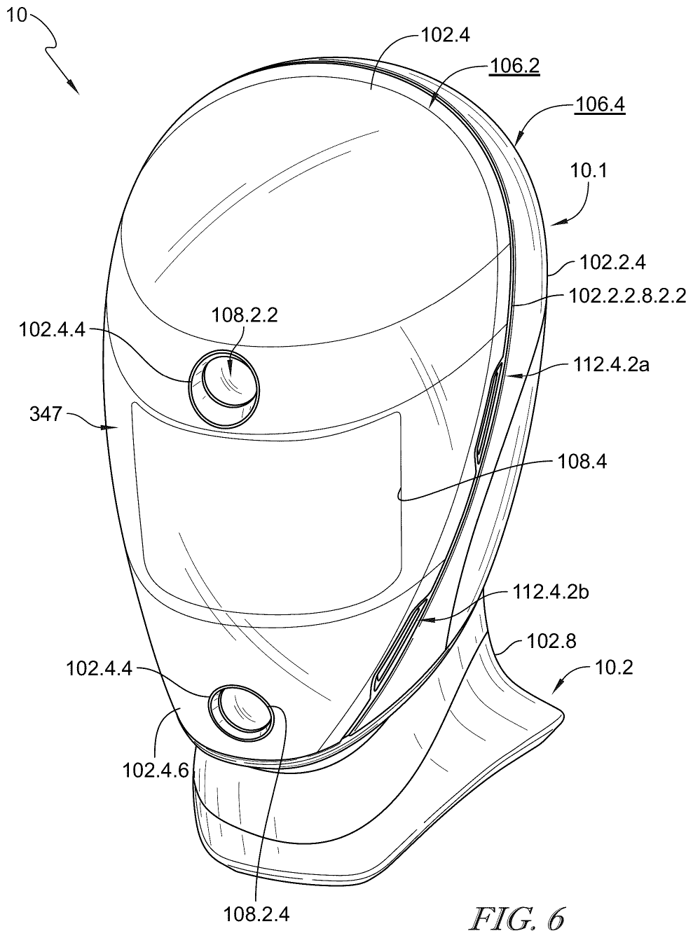

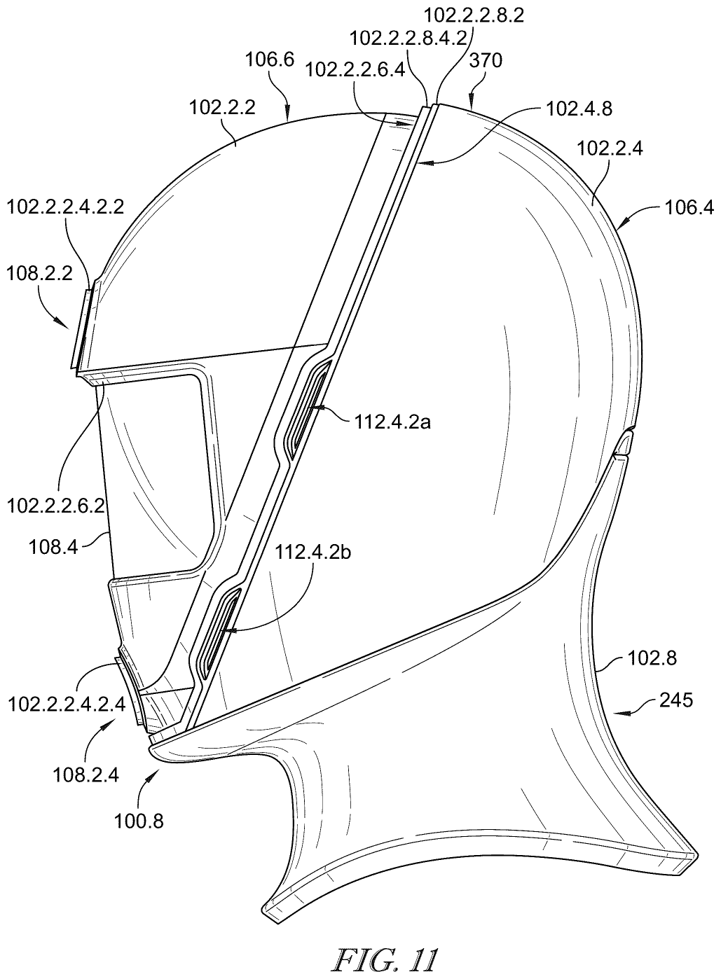

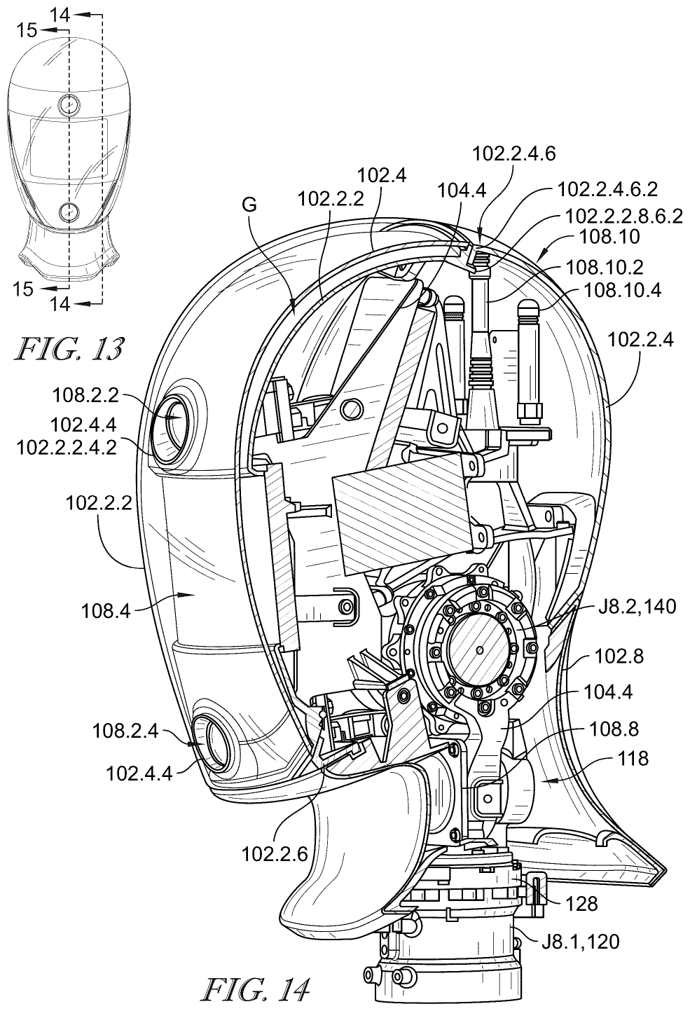

Referring to FIGS. 6-15, the head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles that of a human head. The head and neck assembly 10 is, however, specifically designed to lack pronounced human facial structures, such as cheeks, eye protrusions, a mouth, or other moving parts, to maintain a non-humanlike appearance. The head and neck assembly 10 includes a head 10.1 and a neck 10.2.

The exterior surface 106 of the head 10.1 is characterized by an absence of large flat surfaces, (e.g., the head 10.1 is not a cube or prism), and it is not formed with significant cylindrical features or perfect circles. Instead, almost all exterior surfaces of the head 10.1 are curvilinear or contain substantial curvilinear aspects, which presents a generally egg-shaped appearance when viewed from the front or top. Structurally, the head 10.1 is symmetrical about the sagittal plane (P_{S}) but is asymmetrical about the Z-Y and X-Y planes that intersect the head 10.1 and are parallel to the coronal plane (P_{C}) and transverse plane (P_{T}), respectively. The width (parallel to the y-axis) and depth (parallel to the x-axis) of the head 10.1 change constantly from top to bottom, reaching a maximum dimension in the temple region 350, which is located at approximately 30-50% of the head's height from its top end 100.6.

The head 10.1 itself may house a range of components, such as high-resolution cameras, microphones, and displays, all of which are contained within a housing 102 that includes an impact-resistant polymer shell 102.2. The head housing 102 also includes a large, freeform (i.e., not conforming to a regular or formal structure or shape) frontal shield 102.4 that couples to the shell 102.2 and covers the frontal and crown regions 362, 370 of the head 10.1. The frontal shield 102.4 is formed as a separate and distinct piece from the display(s) 108.4 positioned behind it, thereby protecting the displays 108.4 and internal electronics from damage. This separation provides a significant advantage during the performance of industrial tasks, as a damaged frontal shield 102.4 is substantially cheaper and easier to replace than a damaged display 108.4. The frontal shield 102.4 extends rearward beyond an auricular region into an occipital region and extends down to a chin region, but it does not extend below a jawline.

Cameras embedded within the head 10.1 may include RGB, depth-sensing, thermal imaging capabilities, and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones 108.6 may be arranged in an array to facilitate directional audio input and noise cancellation, which enhances the ability of the humanoid robot 1 to understand and respond to verbal commands.

Displays 108.4 integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane P_{S}. This curved design permits the inclusion of a larger display 108.4 with a greater surface area compared to a flat screen, which increases the amount of information that can be conveyed, such as robot status and sensor data. This information is displayed using generic blocks or shapes rather than anthropomorphic features like eyes or a mouth. In some embodiments, in addition to the main display 108.4, two side-facing displays may be included to show indicia such as the identification number, battery life, or current task of the robot 1.

Further, an extent of the illumination assembly 1.2.10 includes a head illumination assembly 112, which comprises a plurality of light emitters (also referred to as light emitting assemblies herein), is positioned adjacent to an edge (e.g., lower) of the frontal shield 102.4. These light emitters function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main display 108.4. This method of communication may be more power-efficient than displays 108.4 and can relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck 10.2 to the antennas in the head 10.1. The head and neck assembly 10 may also incorporate advanced materials and shock-absorbing structures to protect the sensitive electronic components housed within, which may improve the overall durability and reliability of the humanoid robot 1.

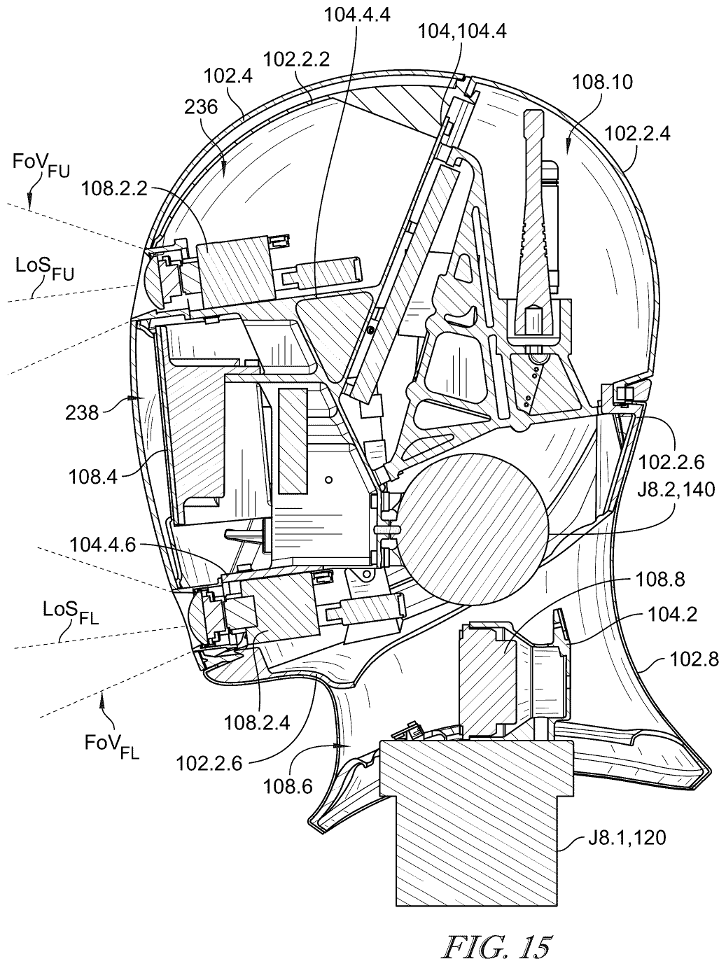

The head and neck assembly 10 may include two primary actuators: a head twist actuator (J8.1) 120, which is responsible for enabling rotational movement of the head 10.1 about axis A8.1, which is a vertical (yaw) axis when the robot 1 is in the neutral state, and a head nod actuator (J8.2) 140, which enables rotation of the head 10.1 about the axis A8.2, which is a horizontal axis when the robot 1 is in the neutral state. Together, these two actuators J8.1, J8.2 may provide two degrees of freedom for the head 10.1, allowing it to perform movements that emulate natural human head motions. In the illustrative embodiment, the head twist actuator (J8.1) 120 may be located at the base of the neck 10.2, where it interfaces with the torso 16, while the head nod actuator (J8.2) 140 may be positioned within the head 10.1, as shown in FIG. 15. In other embodiments, the head twist actuator (J8.1) 120 may be positioned within the head and neck assembly 10, while the head nod actuator (J8.2) 140 may be located at the base of the neck 10.2, as shown in FIG. 3B. The head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators J8.1, J8.2 may be controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications that require higher precision or load capacity, the actuators J8.1, J8.2 may be replaced with compact linear actuators or parallel-link mechanisms.

Additionally, variations of the head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

a. Head Housing Assembly

Referring to FIGS. 6-17, the head housing assembly 102 of the head and neck assembly 10 is configured to contain and protect other assemblies within the head 10.1. As discussed above, the head housing assembly 102 is configured to have a form resembling the general shape of a human head and includes: (i) the frontal shield 102.4 (also referred to as a front shield, front shell, frontal shell, frontal head covering, or frontal cover), (ii) the rear shell 102.2.4 (also referred to as a rear head covering or rear cover), (iii) an intermediate cover 102.2.2 (also referred to as an intermediate support, intermediate shell, or intermediate member), and (iv) an internal support assembly 104. The intermediate cover 102.2.2 and rear shell 102.2.4 couple to an internal mounting frame 104.4 of the internal support assembly 104 and substantially enclose components of an electronics assembly 108 contained in the head 10.1. The frontal shield 102.4 couples to the rear shell 102.2.4, directly or in combination with the intermediate cover 102.2.2, to form the exterior shape of the head 10.1.

In other embodiments, the frontal shield 102.4 and the intermediate cover 102.2.2 may be combined into a single structure. In some embodiments, the intermediate cover 102.2.2 and the internal mounting frame 104.4 may be combined into a single structure. Additionally, in other embodiments, the intermediate cover 102.2.2 may be omitted, and the internal mounting frame 104.4 may be directly coupled to an extent of the rear shell 102.2.4. In further embodiments, the internal mounting frame 104.4 may be omitted, and the intermediate cover 102.2.2 may be retained. Also, the rear shell 102.2.4 may be omitted or substantially omitted and replaced by a substantially larger frontal shield 102.4. Moreover, the frontal shield 102.4 may be omitted or substantially omitted and replaced by a substantially larger rear shell 102.2.4. Finally, the intermediate cover 102.2.2 and internal mounting frame 104.4 may be integrally formed as a single component, or said components may be integrally formed with one or more of the frontal shield 102.4 or the rear shell 102.2.4.

The intermediate cover 102.2.2 and the rear shell 102.2.4 couple to one another to form shell 102.2 that encloses and defines a first head sub-volume 236 within the head housing assembly 102. The first head sub-volume 236 is configured to substantially contain and protect one or more components of the electronics assembly 108 (e.g., cameras 108.2, a display 108.4, computing device 108.14, etc.). The frontal shield 102.4 provides a front end of the head housing assembly 102 and defines a second sub-volume 238 between the intermediate cover 102.2.2 and the frontal shield 102.4 within the head housing assembly 102. The second sub-volume 238 is separated from the first head sub-volume 236 via the intermediate cover 102.2.2, where the frontal shield 102.4 is configured to further protect one or more components positioned in openings of the intermediate cover 102.2.2, such as the display 108.4, and cameras 108.2. For example, the frontal shield 102.4 can be removed and replaced without further exposing other electronic components contained within the head 10.1.

The frontal shield 102.4 and/or the intermediate cover 102.2.2 can be removed from the rest of the head housing assembly 102 to service components within the sub-volumes 236, 238 or to upgrade components in said sub-volumes 236, 238. This modular design allows for individual components to be replaced without requiring replacement of the entire head housing assembly 102. In other embodiments, the frontal shield 102.4 may occupy the entire head 10.1, between 100% and 75% of the head, 75% and 50% of the head, 50% and 25% of the head, or less than 25% of the head. In other words, the frontal shield 102.4 size to head 10.1 ratio may be any value. The frontal shield 102.4 may extend rearward of the car location, and/or the shield 102.4 may extend past the crown region 370 of the head 10.1. The forward angle between the frontal shield's 102.4 horizontal and rear edge may be greater than 140 degrees or less than 90 degrees. The frontal shield 102.4 may be curved in a single direction or may be a freeform design that may include multiple curves. The frontal shield 102.4 may obscure or be positioned in front of the sensor openings, whereby the frontal shield 102.4 extends continuously from the chin region 355 to the crown region 370 of the head 10.1.

i. Exterior Head Shape

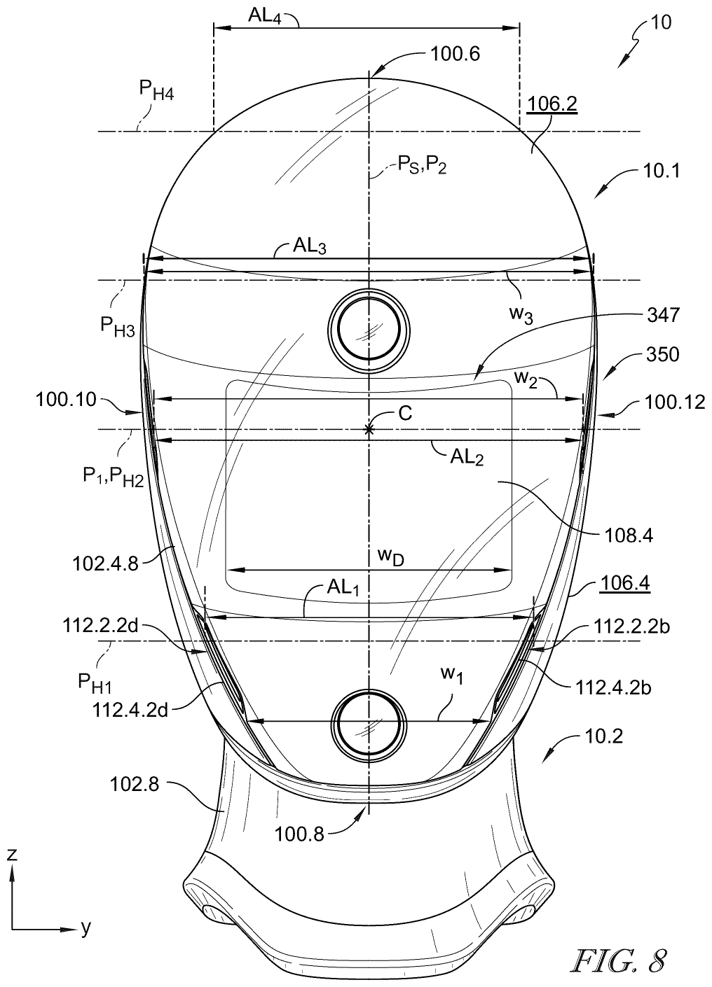

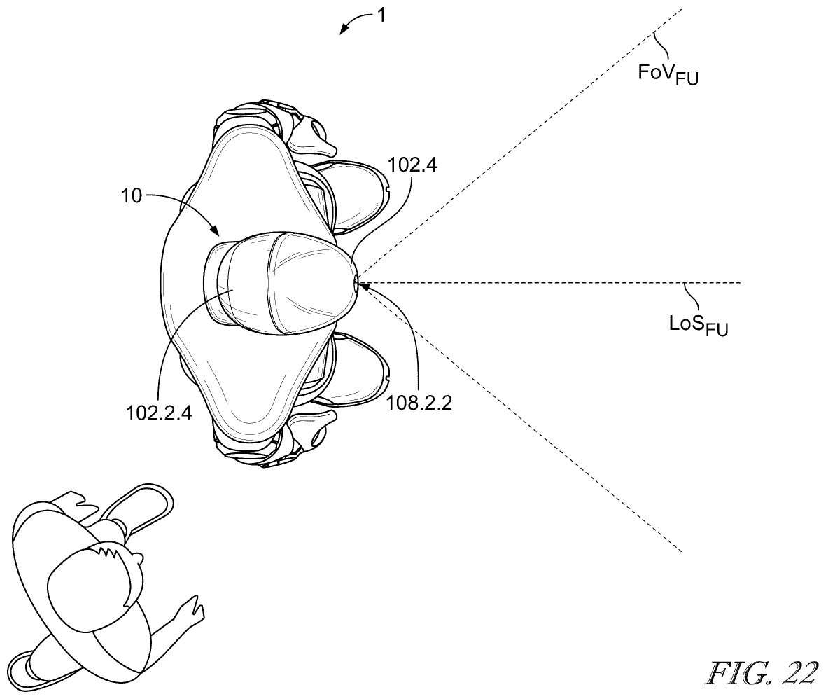

As shown in at least FIGS. 6, 8, 10A-10C, and 22, the head housing assembly 102 is configured to provide the head 10.1 with an overall shape that is similar to that of a human head. The shape of the head 10.1 is substantially defined by a frontal exterior surface 106.2 of the frontal shield 102.4 and a rear exterior surface 106.4 of the rear shell 102.2.4. In the illustrative embodiment, the head 10.1 is formed without flat surfaces and is generally egg-shaped when viewed from the front (FIG. 8) and from the top (FIG. 22).

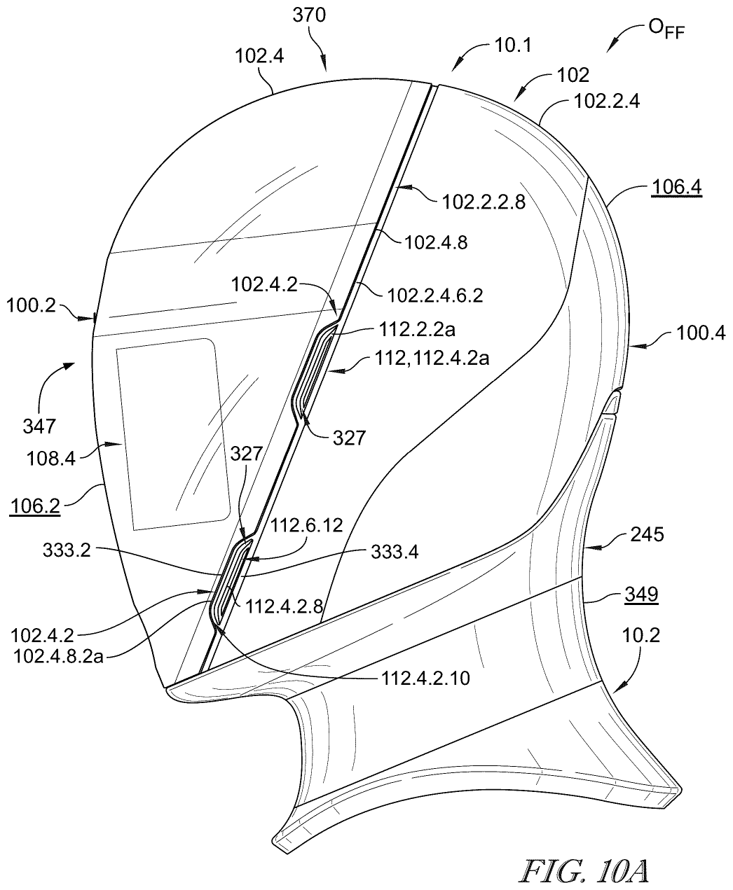

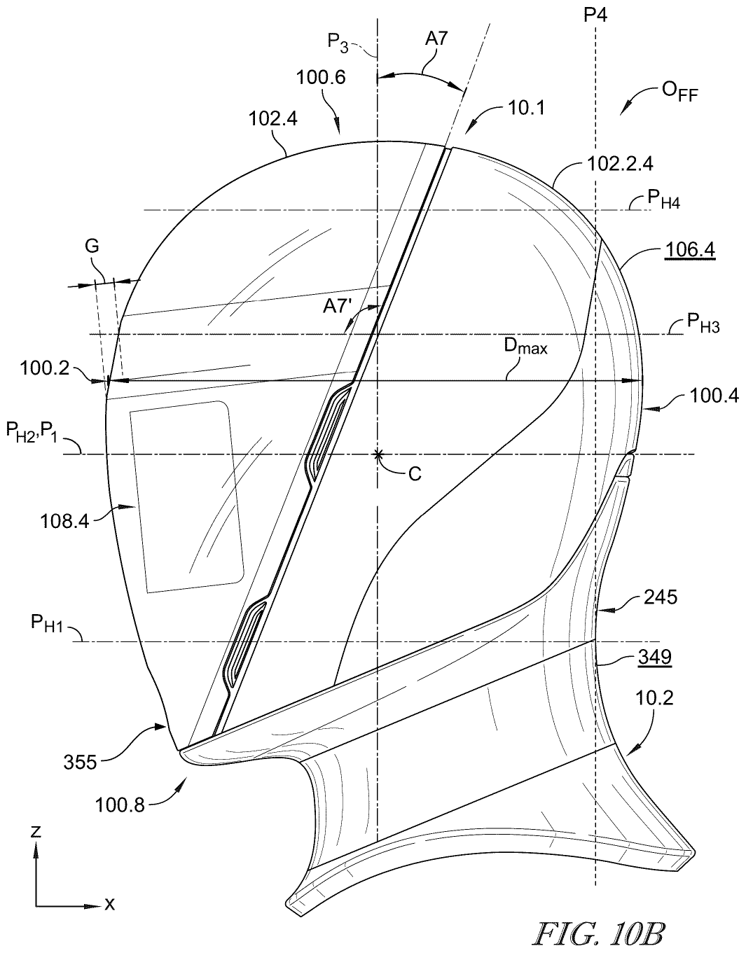

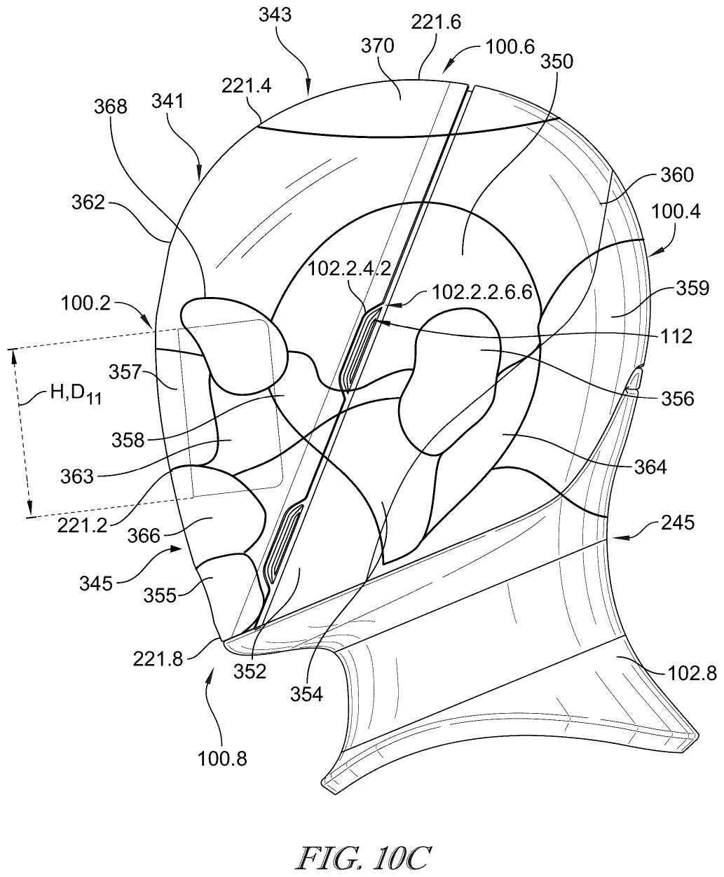

Referring to FIGS. 8 and 10B, the shape of the head 10.1 can be described with respect to reference planes (P₁, P₂, P₃) that intersect at a center C (or centroid C) of the head 10.1 and are parallel to reference planes (P_{T}, P_{S}, P_{C}) of the robot 1. In the illustrative embodiment, the center C is defined as being spaced at equal distances from: (i) the top end 100.6 and the lower end 100.8, (ii) the front end 100.2 and the rear end 100.4, and (iii) the lateral sides 100.10, 100.12 of the head 10.1. As shown in FIG. 8, a first plane P₁ is a horizontal (X-Y) plane that is parallel with the transverse plane (P_{T}) of the robot 1 and equidistant from the top end 100.6 and the lower end 100.8. A second plane P₂ is perpendicular to the first plane P₁ and substantially coplanar with the sagittal plane (P_{S}) of the robot 1, where the external surface 106 of the head 10.1 is substantially symmetrical about the second plane P₂. As shown in FIG. 10B, a third plane P₃ is perpendicular to the second plane P₂, passes through the center C of the head 10.1, and is parallel with the coronal plane (P_{C}) of the robot 1. The head 10.1 of the humanoid robot 1 is symmetrical about the second plane P₂, and asymmetrical about the first plane P₁ and the third plane P₃. In other embodiments, the head 10.1 may be symmetrical about the first plane P₁ and asymmetrical about the second plane P₂. In other embodiments, the head 10.1 may be symmetrical about the first plane P₁ and/or symmetrical about the third plane P₃. Stated another way, other embodiments of the head 10.1 may be symmetrical about: (i) all planes P₁, P₂, and P₃, (ii) two of the three planes P₁, P₂, and P₃, (iii) one of the three planes P₁, P₂, and P₃, or (v) none of the three planes P₁, P₂, and P₃.

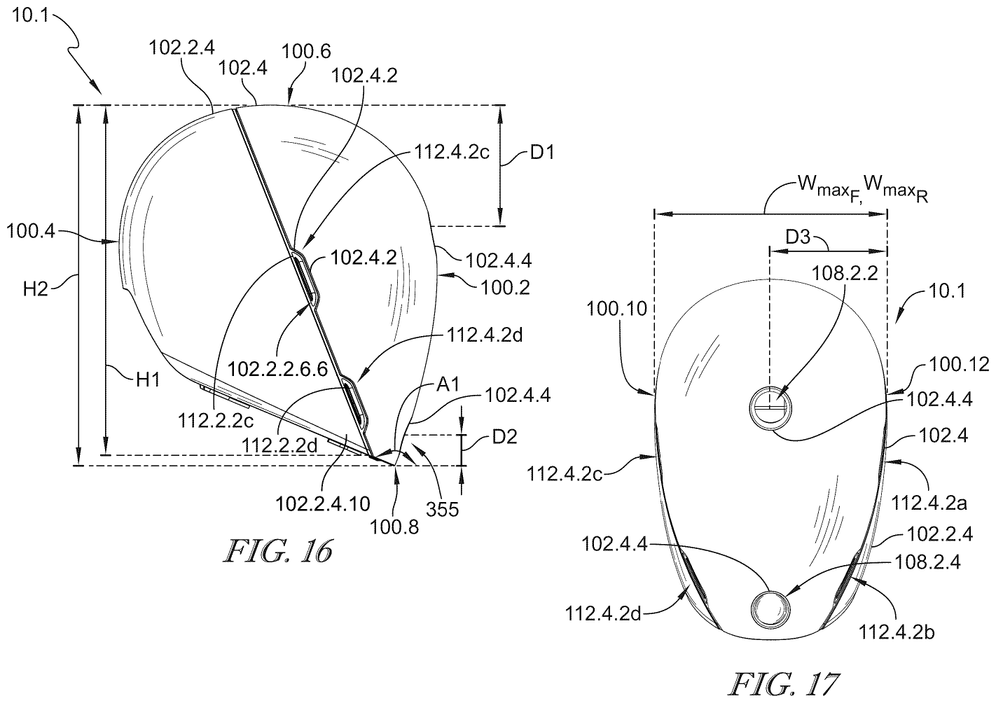

In the illustrative embodiment, the width of the head 10.1 of the humanoid robot 1 changes constantly from a top end 100.6 to a lower end 100.8. The head 10.1 increases in width from the top end 100.6 to a temple region 350, where the head 10.1 is widest. The width of the head 10.1 then decreases from the temple region 350 to the lower end 100.8. Referring to FIGS. 16-17, the frontal shield 102.4 couples to the intermediate cover 102.2.2 of the head housing assembly 102 and includes the lower chin portion 102.4.6, which projects downward and forward of the rear shell 102.2.4 in the chin region 355. As shown in FIG. 16, the rear shell 102.2.4 of the head housing assembly 102 has a first height H1, and the frontal shield 102.4 of the head housing assembly 102 has a maximum height H2 that is greater than the first height H1 of the rear shell 102.2.4. Referring to FIG. 17, the head 10.1 is widest in a temple region 350 that generally corresponds with the location of an upper camera 108.2.2 or at a location that is about 30-50% of a height H2 of the head 10.1 from the top end 100.6. At this location, the maximum width (W_{maxR}) of the rear shell 102.2.4 is substantially similar to the maximum width (W_{maxF}) of the frontal shield 102.4. Although the rear shell 102.2.4 includes a rim 102.2.4.6 configured to interface with the intermediate cover 102.2.2 to couple with the frontal shield 102.4, the frontal shield 102.4 tapers to widths that are less than the rear shell 102.2.4 in the chin region 355. The configuration of the head 10.1 of the humanoid robot 1 causes the maximum height H1 to be greater than the maximum width (W_{maxR}). The maximum height H2 and maximum width (W_{maxF}) of the head 10.1 are both provided by the frontal shield 102.4.

As shown in FIGS. 10A-10C, the depth of the head 10.1 of the humanoid robot 1 is defined by a combination of both the rear shell 102.2.4 and the frontal shield 102.4. The depth includes a maximum depth Dₘₐₓ at a location that is approximately equal to the temple region 350 and that extends between a front end 100.2 in the front or facial region 347 of the head 10.1 to a rear end 100.4 in an occipital region 359 of the head 10.1. The front end 100.2 is provided by the frontal shield 102.4, and a rear end 100.4 is provided by the rear shell 102.2.4. The depth of the head 10.1 changes constantly from the top end 100.6 to the lower end 100.8. The depth increases from the top end 100.6 to the maximum depth Dₘₐₓ and then decreases from the maximum depth Dₘₐₓ to the lower end 100.8.

The exterior surfaces 106.2, 106.4 of both the rear shell 102.2.4 and the frontal shield 102.4 are designed with a concave shape relative to the interior of the head 10.1. This concave configuration contributes to the overall streamlined and ergonomic form of the robot's head 10.1. In contrast, a nape region 245, located at the rear of the head and neck assembly 10 below the occipital region 359 at the neck 10.2, features a unique convex exterior surface 349. This convex surface 349 is oriented outward relative to the center C of the head 10.1, creating a subtle protrusion that may mimic the natural curvature found in human anatomy. Notably, the nape region 245 may be the sole area of the head and neck assembly 10 exhibiting this convex characteristic. This deliberate design choice not only enhances the anthropomorphic appearance of the humanoid robot 1 but also potentially serves functional purposes, such as housing specific components or facilitating the connection between the head 10.1 and neck 10.2. In other embodiments, the exterior surfaces 106.2, 106.4 of both the rear shell 102.2.4 and the frontal shield 102.4 may: (i) include or incorporate ridges, channels, or textured patterns to enhance heat dissipation, improve structural rigidity, or serve as mounting points for additional sensors or components; (ii) include modular component bay that is designed to allow for access to internal components; and/or (iii) have larger flat or substantially flat surfaces. Additionally, the nape region 245 and/or other aspects or regions of the rear shell 102.2.4 may not be convex and instead, it may be linear, substantially linear, concave, curvilinear, straight, angled, arc-shaped, wave-shaped, parabolic, elliptical, cylindrical, tapered, segmented linear, multilinear, undulating, hyperbolic, nonlinear, lobed, irregularly curved, bowed, U-shaped, V-shaped, crescent-shaped, radial, spiral, rectilinear, polygonal, a triangular curve, a circular arc, an inflection curve, an inclined linear segment, a fractal-like curve, a disjointed linear segment, a hyperbolic arc, an S-shaped curve, a compound linear segment, and/or any combination thereof.

When viewed from the side as shown in FIG. 10C, (i) the lateral sides of the head 10.1 may have a first vertical or middle curvature 341 generally extending about the center C and from a third point 221.2 to a second point 221.4, (ii) the top end 100.6 of the head 10.1 may have a second vertical or upper curvature 343 generally extending about the center C and from a second point 221.4 to a first point 221.6, and (iii) the lower end 100.8 may have a third vertical or lower curvature 345 generally extending about the center C and from third point 221.2 to a fourth point 221.8. In some aspects, the second curvature 343 may be less than, or have a lesser degree of curvature than, the first curvature 341. The second curvature 343 may be greater than, or have a greater degree of curvature than, the third curvature 345 in some cases. The first or middle curvature 341 may be defined between the third point 221.2 located at an upper extent of the buccal region 352 and the second point 221.4 located at a lower extent of the crown region 370 of the head 10.1. The second curvature 343 may be primarily defined by the crown region 370, wherein said curvature extends from the second point 221.4 located at a lower extent of the crown region 370 and the first or top point 221.6 located at the apex of the housing assembly 102. The third curvature 345 may be defined between the third point 221.2 at the uppermost extent of the buccal region 352 and the fourth point 221.8 at the lowermost extent of the buccal region 352.

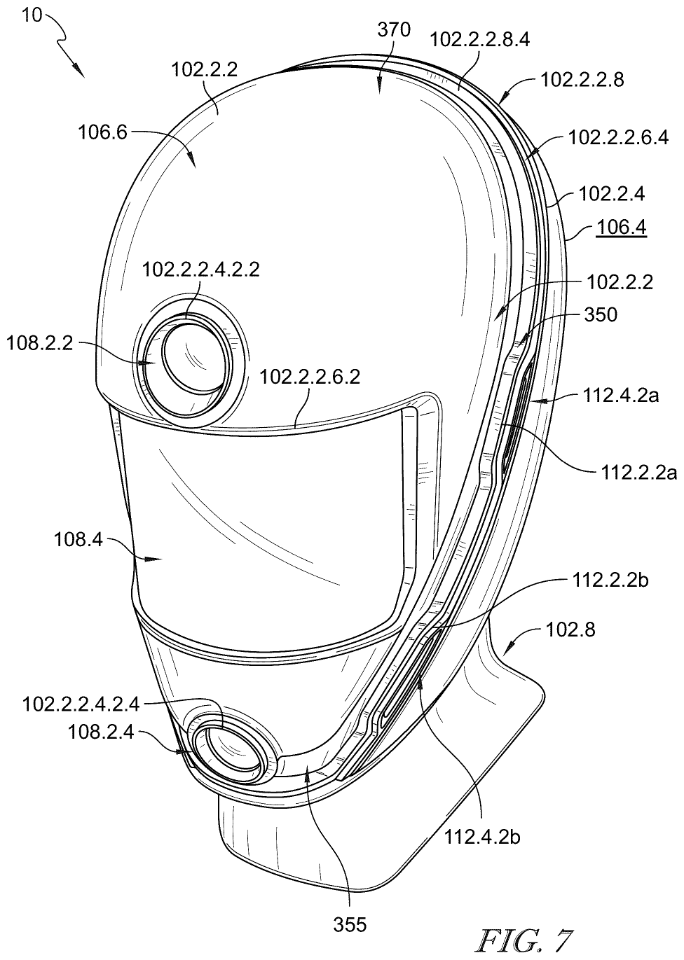

In some implementations, the head 10.1 may have a substantially oval shape when viewed from the front, as shown in FIG. 7, and the frontal shield 102.4 may taper inwardly slightly toward a facial region 347 provided by the frontal shield 102.4 in some cases. This design enables the head 10.1 to have varying degrees of curvature in different regions to optimize visibility, sensor placement, or aesthetics. For example, the curvature of the frontal shield 102.4 could be more pronounced in the facial region 347 to accommodate a larger display 108.4, while tapering to a shallower curve towards a rear edge 102.4.8 of the frontal shield 102.4. In other embodiments, the head 10.1 may have angular geometries like hexagonal, octagonal, pentagonal, triangular, square, rectangular, trapezoidal, rhomboidal, parallelogram-shaped, diamond-shaped, oval, elliptical, circular, semicircular, crescent-shaped, star-shaped, heart-shaped, teardrop-shaped, or may have surfaces/edges that are linear, substantially linear, concave, curvilinear, straight, angled, arc-shaped, wave-shaped, parabolic, elliptical, cylindrical, tapered, segmented linear, multilinear, undulating, hyperbolic, nonlinear, lobed, irregularly curved, bowed, U-shaped, V-shaped, crescent-shaped, radial, spiral, rectilinear, polygonal, triangular curve, circular arc, inflection curve, inclined linear, fractal-like curve, disjointed linear, hyperbolic arc, S-shaped, compound linear, and/or any combination thereof.

ii. Frontal Shield

Referring to FIGS. 6, 8, 10A-10C, and 12-15, the frontal shield 102.4 is configured to cover or overlay the intermediate cover 102.2.2 and the electronics assembly 108 contained in the head 10.1. The frontal shield 102.4 may be made from a transparent material so that the display 108.4 positioned in a screen opening 102.2.2.6.2 of the intermediate cover 102.2.2 may be viewed through the frontal shield 102.4. In other embodiments, the frontal shield 102.4 may be tinted or opaque.

The frontal shield 102.4 may have a different curvature than the display 108.4. As shown in at least FIG. 14, the frontal shield 102.4 may include a curved surface and be configured to cover and couple to the intermediate cover 102.2.2 at a coupling interface 102.2.2.8 that projects from the rim 102.2.2.6.4. The frontal shield 102.4 is shaped to resemble the form of the head 10.1 providing a substantially continuous surface between the crown region 370, the rear shell 102.2.4, and the upper securement member 102.2.6 of the neck 10.2. The curvature of the frontal shield 102.4 may vary and have different curvatures (i.e., radii and arcs) at different positions along its surface 106.2. Thus, the shield 102.4 has an outer surface that has: (a) a first radius of curvature along an extent of a horizontal plane, and (b) a second radius of curvature along an extent of a vertical plane, and wherein the second radius of curvature is less than the first radius of curvature. For example, in a central region of the shield 102.4 that overlaps the display 108.4 (e.g., forward of the centroid C), a radius of curvature along the horizontal plane P₁ may range from about 39 mm to about 202 mm and a vertical radius of curvature along the vertical plane P₃ may range from about 80 mm to about 536 mm.

The frontal shield 102.4 may include light recesses 102.4.2 to conform with the shape of the rim lighting recesses 102.2.2.6.6 positioned at the coupling interface 102.2.2.8 of the intermediate cover 102.2.2. Although the illustrative embodiment shows the frontal shield 102.4 is sized to substantially match the perimeter of the intermediate cover 102.2.2, the frontal shield 102.4 may occupy any portion or ratio of the robot's head 10.1 and may have any configuration. The frontal shield 102.4 may: (i) wrap from the front of the head 10.1 into the side regions of the head 10.1, (ii) extend into the chin area or cover the entire chin area, and (iii) have a non-uniform rear edge, which is formed by a plurality of recesses. As such, the shield 102.4 includes a rear edge 102.4.8 with a recess, whereby the recess causes the rear edge 102.4.8 to be non-linear. The plurality of recesses 102.4.2 may be configured to receive an extent of a light or indicator. Additionally, the shield 102.4 includes a rear edge 102.4.8, and wherein an obtuse angle is formed between an extent of the rear edge 102.4.8 and a horizontal reference plane.

In some embodiments, the frontal shield 102.4 may not extend to the crown region 370 of the head 10.1 and/or may not extend rearward past a location where a human's ears would be located. The disclosed frontal shield 102.4 may occupy between 25% and 50% of the head 10.1 and may be curved in two directions (e.g., vertically and horizontally). In some embodiments, the frontal shield 102.4 and the display 108.4 may be integrated into a single component or may be formed from a plurality of components.

In various embodiments, the frontal shield 102.4 includes sensor apertures 102.4.4 configured to align with the sensor openings 102.2.2.4.2 formed in the intermediate cover 102.2.2. The combination of the sensor apertures 102.4.4 and sensor openings 102.2.2.4.2 enables the lenses of the upper camera 108.2.2 and lower camera 108.2.4 to be unobstructed. This reduces potential distortion of the images captured by the cameras 108.2.2, 108.2.4, which in turn reduces processing requirements, battery usage, and heat generation.

The frontal shield 102.4 forms the forwardmost exterior surface 106.2 of the head 10.1 and cooperates with the intermediate cover 102.2.2 to define the second sub-volume 238 within the head housing assembly 102. The intermediate cover 102.2.2 can be similarly colored (tinted or opaque) so that the frontal shield 102.4 has a similar appearance, ensuring that lights or images on the display 108.4 are the only items conspicuously visible through the frontal shield 102.4. The frontal shield 102.4 may also include micro-optical elements, such as Fresnel lenses or diffractive optical elements, in specific areas to enhance the performance of internal sensors or create novel lighting effects without additional hardware.

The frontal shield 102.4 may be coated, etched, or formed with a plurality of layers (e.g., examples of which are disclosed within U.S. Pat. Nos. 8,770,749, 9,134,547, 9,383,594, 9,575,335, and 9,910,297, all of which are incorporated herein by reference in their entirety) in a manner that improves durability, increases sensor accuracy, filters one or more specific wavelengths of light, reduces glare, enhances appearance, reduces fogging, makes the frontal shield 102.4 easier to clean, or protects it from cleaning products. Examples of such optical coatings include anti-reflection coatings, mirror coatings, hard coatings, anti-static coatings, and anti-fog coatings, some of which are described within U.S. patent application Ser. Nos. 16/896,016, 16/698,775, 16/417,311, 16/126,983, 15/359,317 and, 15/515,966, each of which is incorporated herein by reference. Further, the material composition, shape, number of layers, and composition of said layers of the frontal shield 102.4 may be different from those utilized within other parts of the frontal shield 102.4. In other words, the composition, shape, number of layers, and composition of said layers may vary across the frontal shield 102.4. It should be understood that this disclosure includes any compositions, shapes, layer numbers, and layer compositions that are known in the art.

The frontal shield 102.4, or an extent thereof, may have a substantially uniform thickness, which may be equal to or greater than 1 mm, and preferably greater than 2 mm. Additionally, the frontal shield 102.4 may be optically correct and not a corrective lens. As such, the frontal shield 102.4 has a dioptric power of less than 0.25 diopters, preferably less than 0.12 diopters, and most preferably less than 0.06 diopters. The frontal shield 102.4 may have a reverse or negative pantoscopic tilt, a forward or positive pantoscopic tilt, or no pantoscopic tilt. Accordingly, the frontal shield 102.4 may be made from or may include polycarbonate (PC), acrylic (PMMA), trivex, nylon, gorilla glass (aluminosilicate glass), thermoplastic polyurethane (TPU), high-grade glass, cr-39, polyethylene terephthalate (PET), polystyrene, fused silica (quartz glass), borosilicate glass, polyurethane, cellulose acetate, polyvinyl chloride (PVC), cellulose acetate butyrate (CAB), polyvinyl butyral (PVB), optical-grade resin, sapphire glass, polyetherimide (PEI), lexan, thermoset plastics, other anti-scratch coated plastics, or any other similar material known in the art.

In the illustrative embodiment shown in FIGS. 6-18, the frontal shield 102.4 and the rear shell 102.2.4 are coupled to the intermediate cover 102.2.2 at the coupling interface 102.2.2.8. This coupling interface 102.2.2.8 is configured to receive and couple with (i) a rear perimeter edge 102.4.8 of the frontal shield 102.4 and (ii) a forward facing edge 102.2.4.6.2 of the rear shell 102.2.4 to complete the exterior surface 106 of the head 10.1. Further, the coupling interface 102.2.2.8 is configured to secure the frontal shield 102.4 at a position away from the surface 106.6 of the intermediate cover 102.2.2, forming a gap (G) therebetween (see, e.g., FIGS. 14 and 15).

As shown in this embodiment, the rear perimeter edge 102.4.8 of the frontal shield 102.4 is not flat or planar. Instead, the rear perimeter edge 102.4.8 is irregular to mate with the irregular shape of the coupling interface 102.2.2.8. In particular, the rear perimeter edge 102.4.8 is formed to include a plurality of recesses 102.4.2, where each recess 102.4.2 is sized to receive a respective light emitter housing 112.2 formed in the intermediate cover 102.2.2 that houses a respective light emitting assembly 112.4. In some embodiments, the frontal shield 102.4 itself can include the light emitter housings 112.2.2a, 112.2.2b, 112.2.2c, 112.2.2d, although this may not be desirable as the frontal shield 102.4 is the component that is most likely to be removed from the head housing assembly 102 to service the head 10.1 and the electronics assembly 108.

Except for the recesses 102.4.2, the rear perimeter edge 102.4.8 of the frontal shield 102.4 is substantially planar along the coupling interface 102.2.2.8. The coupling interface 102.2.2.8 between the intermediate cover 102.2.2 and the frontal shield 102.4, and the forward-facing edge 102.2.4.6.2 of the rear shell 102.2.4, extends at an angle A7 to the third plane P₃, as shown in FIG. 10B. In the illustrative embodiment, this angle A7 is within a range of about 15 degrees to about 50 degrees, preferably between 20 and 40 degrees, most preferably between 25 and 35 degrees, and may be approximately 30 degrees. The relationship of the forward-facing edge 102.2.4.6.2 of the rear shell 102.2.4 may also be described as an obtuse angle (A7′) formed with respect to the first plane P₁ (perpendicular to the third plane P₃).

This angular relationship provides the frontal shield 102.4 with a larger depth at its top end, which increases the volume of the second sub-volume 238 and provides more room for components of the electronics assembly 108. Aₙ upper end of the frontal shield 102.4 near an upper extent of the head 10.1 is located rearward of the third plane P₃, while a lower end of the frontal shield 102.4 near a chin region 355 is located forward of the third plane P₃, as shown in FIGS. 10A-10C. There are no recesses formed in the frontal shield 102.4 in an orbital region 368, a nasal region 357, an oral region 366, or a frontal region 362. The frontal shield 102.4 extends upward from an extent of the rear shell 102.2.4 that is positioned in the chin region 355, over a majority of the facial region 347, and into or beyond a frontal edge of a parietal region 360. The frontal shield 102.4 has an outer surface occupying at least the orbital region 368 and the nasal region 357. The orbital region 368 of the frontal shield 102.4 is not recessed in comparison to the nasal region 357 of the frontal shield 102.4. The frontal shield 102.4 lacks an extent that is positioned rearward of a vertical reference plane (P₄) that abuts an extent of a rear surface (e.g., convex surface 349 at the nape region 245) of the neck portion 10.2.

The depth change of the frontal shield 102.4 positions a first light emitting assembly 112.4.2a and a third light emitting assembly 112.4.2c above and rearward of a second light emitting assembly 112.4.2b and a fourth light emitting assembly 112.4.2d. Such an arrangement provides a greater viewing area for users to observe at least one light emitting assembly 112.4 when positioned at different orientations relative to the humanoid robot 1. In other embodiments, the first and third light emitting assemblies 112.4.2a, 112.4.2c may not be positioned rearward of the second and/or fourth light emitting assemblies 112.4.2b, 112.4.2d. Instead, the second and/or fourth light emitting assemblies 112.4.2b, 112.4.2d may be positioned in the same vertical plane, and/or may be positioned rearward of the first and third light emitting assemblies 112.4.2a, 112.4.2c. The frontal shield 102.4 may: (i) wrap from the front of the head 10.1 into the side regions of the head 10.1, (ii) extend into the chin area or cover the entire chin area, and (iii) have a non-uniform rear edge 102.4.8, which may be formed by a plurality of recesses 102.4.2. The plurality of recesses 102.4.2 may be configured to receive an extent of the light emitter housings 112.2.2a, 112.2.2b, 112.2.2c, 112.2.2d. In some aspects, the frontal shield 102.4 may not extend to the crown region 370 of the head 10.1 and/or may not extend rearward past a location where a human's cars would typically be located. The frontal shield 102.4 may occupy between 50% and 25% of the surface area of the head 10.1 and may be curved in at least two directions (e.g., vertically and horizontally).

In some embodiments, the frontal shield 102.4 and the display 108.4 may be integrated into a single component or may be formed from a plurality of components. The frontal shield 102.4 may have a different curvature than the display 108.4. In other embodiments, the frontal shield 102.4 may extend to the crown region 370 or past the typical car locations. The frontal shield 102.4 may occupy more or less of the head 10.1 in some cases. The curvature and integration of the frontal shield 102.4 and display 108.4 may vary in different implementations.

As shown in FIG. 8, in a forward-facing orientation (OFF), the frontal shield 102.4 is substantially symmetrical about the second plane P₂, which is coplanar with the sagittal plane P_{S}. As such, the rear perimeter edge 102.4.8 includes a first edge extent 102.4.8.2a (left) and a second edge extent 102.4.8.2b (right) that meet at the top end 100.6 and bottom end 100.8. The curvature of the frontal shield 102.4 varies from the crown region 370 to the chin region 355. For example, the front surface 106.2 of the frontal shield 102.4 may include, at least: (i) a substantially horizontal first arc length AL₁ (or chin arc length) that extends along the front surface 106.2 from the first edge extent 102.4.8.2a to the second edge extent 102.4.8.2b at a first location or horizontal plane P_{H1}, (ii) a substantially horizontal second arc length AL₂ (or a display arc length) that extends along front surface 106.2 from a first edge extent 102.4.8.2a to a second edge extent 102.4.8.2b at a second location or horizontal plane P_{H2}, (iii) a substantially horizontal third arc length AL₃ (or forehead arc length or above the display arc length) that extends along the surface from a first edge extent 102.4.8.2a to a second edge extent 102.4.8.2b at a third location or horizontal plane P_{H3}, and (iv) a substantially horizontal fourth arc length AL₄ (or crown arc length) that extends along the surface 106.2 from a first edge extent 102.4.8.2a to a second edge extent 102.4.8.2b at a fourth location or horizontal plane P_{H4}. Although the arc lengths AL₁, AL₂, AL₃, AL₄ are shown as straight lines in the front view of FIG. 8, it should be understood that these arc lengths follow the curvature of the frontal shield 102.4 along each respective horizontal plane P_{H1}, P_{H2}, P_{H3}, P_{H4} from the rear edge 102.4.8 on one side of the frontal shield 102.4 to the rear edge 102.4.8 on the other side.

The frontal shield 102.4 is concave relative to the display 108.4 (i.e., it curves around the display 108.4) at each location P_{H1}, P_{H2}, P_{H3}, and P_{H4} such that the frontal shield 102.4 extends at least partially about the display 108.4. The first arc length AL₁ occurs below the display 108.4. The second arc length AL₂ occurs at approximately the center C of the head 10.1, is aligned with or intersects the display 108.4, and is greater than the first arc length AL₁. The third arc length AL₃ occurs above the display 108.4, and is greater than the second arc length AL₂. The fourth arc length AL occurs above the third arc length AL₃ and the display 108.4, and is less than the second and third arc lengths AL₂, AL₃.

Referring to FIG. 8, the frontal shield 102.4 has, at least: (i) a first width W₁ or lower frontal shell width that extends from the first edge extent 102.4.8.2a to a second edge extent 102.4.8.2b of the rear perimeter edge 102.4.8 at a first location below the first plane P₁, (ii) a second width W₂ or frontal shell centroid width that extends from a first edge extent 102.4.8.2a to a second edge extent 102.4.8.2b of the rear edge 102.4.8 at a second location or at the horizontal plane P₁, and (iii) a third width W₃ or upper frontal shell width that extends from a first edge extent 102.4.8.2a to a second edge extent 102.4.8.2b of the rear perimeter edge 102.4.8 at a third location above the first plane P₁. The first width W₁ is less than both the second and third widths W₂, W₃; the second width W₂ is greater than both the first W₁ and third widths W₃, and the third width W₃ is greater than the first width W₁, and less than the second width W₂. The first width W₁ or lower frontal shell width is positioned below a display width WD, wherein the display width Wp is greater than the frontal shell width W₁. The frontal shell centroid width W₂ and the upper frontal shell width W₃ are greater than the display width WD.

In some embodiments, the frontal shield 102.4 may incorporate a variable transparency feature, allowing it to switch between transparent, translucent, and opaque states. This could be achieved through the use of electrochromic materials or liquid crystal layers embedded within the shell structure. Such a feature may enable dynamic control over the visibility of internal components and displays, enhancing both functionality and aesthetics.

The frontal shield 102.4 may also incorporate embedded flexible electronic circuits, displays, and/or conductive pathways. These could serve multiple purposes, such as acting as antennas for improved wireless communication, providing touch-sensitive areas for user interaction, or enabling localized heating to prevent fogging in challenging environments. The frontal shield 102.4 may utilize an advanced multi-layer coating system, combining various functional properties. For example, a hydrophobic outer layer for water repellency, a middle layer with self-healing properties to repair minor scratches, and an inner layer with electromagnetic shielding capabilities to protect sensitive electronics from interference. Further, the frontal shield 102.4 may include integrated micro-lens arrays or diffractive optical elements. These could be used to enhance the performance of internal sensors, create specific lighting effects, or even project information onto nearby surfaces without the need for additional hardware. In some aspects, while the head 10.1 has a modular design, the frontal shield 102.4 could also have a modular design to allow for easy replacement or customization of specific sections. This could include interchangeable panels with different optical properties, sensor arrays, or display technologies, enabling rapid adaptation to various operational requirements or upgrades.

iii. Intermediate Cover

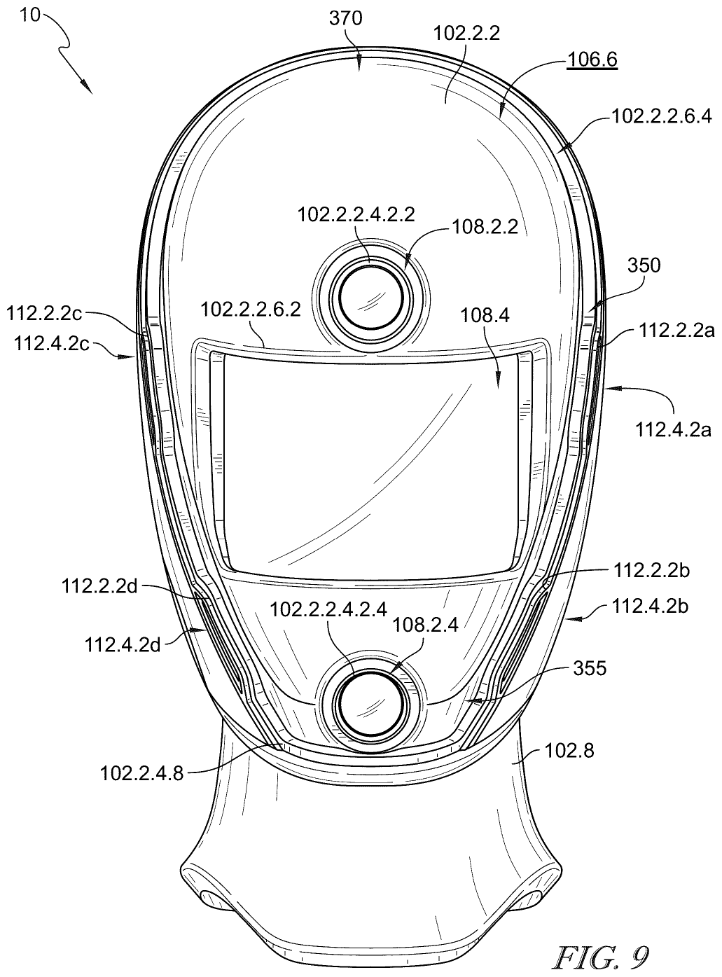

As best shown in FIGS. 7, 9, 11, and 14, the intermediate cover 102.2.2 is configured to cover a majority of the electronics assembly 108 that is coupled to the internal mounting frame 104.4. Shown in FIGS. 7 and 9, the intermediate cover 102.2.2 extends from a crown region 370 of the head 10.1 to the chin region 355 and a temple region 350 near the location where a human's cars would be located. The intermediate cover 102.2.2 is shaped with a curved surface to resemble a human head and has a coupling interface 102.2.2.8 that extends around the perimeter downward from the crown region 370 at an angle forward to a chin region 355. For example, as shown in FIG. 10B, the intermediate cover 102.2.2 may have a rearwardly sloping substantially linear rim 102.2.2.6.4 with a forward angle (e.g., angle A7′, extending rearward from horizontal) between 90 and 140 degrees, preferably 110 degrees from horizontal when the robot 1 is in a neutral state (where planes P₂ and P₃ of the head 10.1 are aligned with the sagittal plane P_{S} and coronal plane P_{C} of the robot 1).

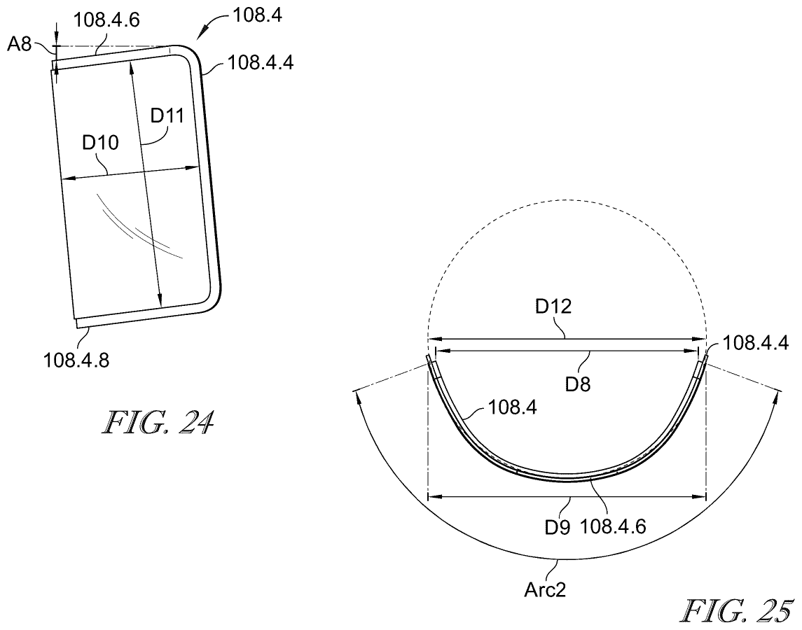

The intermediate cover 102.2.2 is configured to include openings 102.2.2.6.2 and 102.2.2.4.2 to receive: (i) a screen or display 108.4, and (ii) at least one sensor (e.g., upper camera 108.2.2 and lower camera 108.2.4) of the electronics assembly 108 mounted on the internal mounting frame 104.4. As shown in at least FIGS. 7, 9, and 23-25, the display 108.4 may be rectangular with a curvature. The opening 102.2.2.6.2 for the display 108.4 in the intermediate cover 102.2.2 may be shaped with contours around the screen opening 102.2.2.6.2 to receive the curved shape of the display 108.4 without obstructing the view. The intermediate cover 102.2.2 may taper and/or include additional contours between the screen opening 102.2.2.6.2 and the rim 102.2.2.6.4. Further, the intermediate cover 102.2.2 may be configured to obscure from an external viewpoint at least a portion of the first camera 108.2.2 and/or second camera 108.2.4.

The sensor openings 102.2.2.4.2 in the intermediate cover 102.2.2 are vertically aligned in the sagittal plane of the robot 1 (and plane P₂ of the head 10.1) when the robot 1 is in a neutral upright position. In particular, the upper sensor opening 102.2.2.4.2.2 is positioned above the screen opening 102.2.2.6.2 and is substantially centered between its edges. Additionally, the lower sensor opening 102.2.2.4.2.4 is positioned below the screen opening 102.2.2.6.2 and is substantially centered between its edges. The upper and lower sensor openings 102.2.2.4.2.2, 102.2.2.4.2.4 are horizontally centered in the head 10.1, but are not vertically centered in the head 10.1. Instead, said upper and lower sensor openings 102.2.2.4.2.2, 102.2.2.4.2.4 are vertically positioned lower than the center C of the head 10.1 or moved towards the chin region 355.

The sensor openings or apertures 102.2.2.4.2.2, 102.2.2.4.2.4 may by associated with a single sensor. For example, the first sensor opening or aperture 102.2.2.4.2.2 may be aligned with an extent of the first camera 108.2.2, and configured in a manner that does not permit a line of sight of another camera to extend therethrough. Likewise, the second sensor opening or aperture 102.2.2.4.2.4 may be aligned with an extent of the second camera 108.2.4, and configured in a manner that does not permit a line of sight of another camera to extend therethrough. Specifically, the line of sight from the second camera 108.2.4 cannot extend through the first sensor opening or aperture 102.2.2.4.2.2, and the line of sight from the first camera 108.2.2 cannot extend through the second sensor opening or aperture 102.2.2.4.2.4. The first sensor opening or aperture 102.2.2.4.2.2 is configured to allow the first line of sight to extend therethrough, and wherein said aperture 102.2.2.4.2.2 includes at least one substantially semi-circular edge, meanwhile, the second sensor opening or aperture 102.2.2.4.2.4 is configured to allow the second line of sight to extend therethrough, and wherein said aperture 102.2.2.4.2.4 includes at least one substantially semi-circular edge.

The rim 102.2.2.6.4 may include lighting recesses 102.2.2.6.6 which contain light emitter housings 112.2 configured to receive a respective light emitting assembly 112.4 of the illumination assembly 112. The intermediate cover 102.2.2 has a coupling interface 102.2.2.8 configured to mate with the rear shell 102.2.4. The intermediate cover 102.2.2 may also have a lower edge in the chin area configured to interface with the internal support assembly 104 and/or the upper securement member 102.2.6 of the neck 10.2.

The intermediate cover 102.2.2 includes coupling means configured to couple to the internal mounting frame 104.4 and to at least partially enclose components of the electronics assembly 108 contained within the head 10.1. As such, the frontal shield 102.4 and rear shell 102.2.4, when coupled to the intermediate cover 102.2.2, move together as a unit with the internal component, supported by the internal support assembly 104. Further, the intermediate cover 102.2.2 is located between the first and second sub-volumes 236, 238 to separate them. In other words, the intermediate cover 102.2.2 is designed to divide the first sub-volume 236 from the second sub-volume 238. In other embodiments, the intermediate cover 102.2.2 may be omitted, and the first and second sub-volumes 236, 238 may be converted into a single sub-volume. Alternatively, the intermediate cover 102.2.2 may be combined or integrally formed with other structures disclosed herein (e.g., the internal mounting frame 104.4, the rear shell 102.2.4, and/or the frontal shield 102.4), whereby the first and second sub-volumes 236, 238 may remain separated or be combined into a single sub-volume. Further, it should be understood that other mounting structures, dividers, covers, and/or plates may be included within the head 10.1 to further sub-divide the housing 102 into additional sub-volumes (e.g., 3-10 sub-volumes).

The intermediate cover 102.2.2 has an outer perimeter 256 that is sized to couple with the rim 102.2.4.6 of the rear shell 102.2.4. For example, the outer perimeter 256 of the intermediate cover 102.2.2 may be substantially equal to the outer perimeter 259 of the rear shell 102.2.4, wherein the intermediate cover 102.2.2 may be coupled to, positioned adjacent to, and/or abutting the forward facing edge 102.2.4.6.2 of the rear shell 102.2.4. In other words, a rear extent of the intermediate cover 102.2.2 may be configured to abut the forwardmost surface of said forward-facing edge 102.2.4.6.2 of the rear shell 102.2.4. In other embodiments, the outer perimeter 256 of the intermediate cover 102.2.2 may only extend along an extent that is less than substantially all, or even a minority, of the inner perimeter of the rear shell 102.2.4 that is positioned between a rim 102.2.4.6 and the forward-facing edge 102.2.4.6.2 of the outer perimeter 259. In other embodiments, the outer perimeter 256 of the intermediate cover 102.2.2 has a length that is less than the length of the outer perimeter 259 of the rear shell 102.2.4, such that an extent of the intermediate cover 102.2.2 is received into the rear shell 102.2.4.

As best shown in FIGS. 14 and 30, the coupling interface 102.2.2.8 includes a coupling wall 102.2.2.8.2 that projects outward from the rim 102.2.2.6.4 along the perimeter of the intermediate cover 102.2.2, where a forward facing side 102.2.2.8.4 of the coupling wall 102.2.2.8.2 is configured to couple with the rear perimeter edge 102.4.8 of the frontal shield 102.4 and a rearward facing side 102.2.2.8.6 is configured to couple with the forward-facing edge 102.2.4.6.2 of the rim 102.2.4.6 of the rear shell 102.2.4. The coupling wall 102.2.2.8.2 has a border edge 102.2.2.8.2.2 that is substantially flush with the frontal surface 106.2 of the frontal shield 102.4 and the rear surface 106.4 of the rear shell 102.2.4 coupled thereto. The forward-facing side 102.2.2.8.4 of the coupling wall 102.2.2.8.2 includes a ledge 102.2.2.8.4.2 spaced from the border edge 102.2.2.8.2.2, where the ledge 102.2.2.8.4.2 is configured to receive the thickness of the rear perimeter edge 102.4.8 of the frontal shield 102.4. The rearward facing side 102.2.2.8.6 includes a rear facing shelf 102.2.2.8.6.2 that projects rearward from the coupling wall 102.2.2.8.2 and is configured to receive the forward-facing edge 102.2.4.6.2 of the rim 102.2.4.6 of the rear shell 102.2.4, where the forward facing edge 102.2.4.6.2 of the rear shell 102.2.4 abuts the rearward facing side 102.2.2.8.6 of the coupling wall 102.2.2.8.2.

The outer perimeter 256 of the intermediate cover 102.2.2 may be slightly less than an outer perimeter 260 of the frontal shield 102.4. As such, the outer perimeter 256 of the intermediate cover 102.2.2 may have a length that is less than the length of the outer perimeter 260 of the frontal shield 102.4. This difference in length between the two perimeters may facilitate case of assembly by allowing the intermediate cover 102.2.2 to be more easily positioned relative to the frontal shield 102.4 without interference. In some aspects, the difference in perimeter dimensions may account for variations in material expansion, manufacturing tolerances, or specific sealing requirements to ensure a secure fit. In some aspects, the outer perimeter 256 of the intermediate cover 102.2.2 may be substantially equal to the outer perimeter 260 of the frontal shield 102.4.

In other embodiments, the outer perimeter 256 of the intermediate cover 102.2.2 may extend along only a portion of the rear edge 102.4.8 of the frontal shield 102.4, such as less than 75%, less than 50%, or less than 25% of the rear edge 102.4.8. The selective extension of the outer perimeter 256 may be implemented to accommodate specific functional or design considerations, such as providing access to internal components, creating ventilation pathways, or facilitating maintenance. For example, an intermediate cover 102.2.2 that extends along only 50% of the rear edge 102.4.8 may allow for partial disassembly without the need to remove the entire cover, thus enhancing serviceability.

The intermediate cover 102.2.2 may also have an outer perimeter 256 that is larger than the outer perimeter 260 of the frontal shield 102.4 in some implementations. This configuration may be utilized in cases where the intermediate cover 102.2.2 is intended to provide additional protective overhang or includes integrated features such as gaskets, flanges, or attachment points that extend beyond the frontal shield 102.4. For instance, an enlarged intermediate cover 102.2.2 may help prevent the ingress of dust or moisture, especially in harsh environments.

Additionally, the intermediate cover 102.2.2 may have an irregular or non-circular outer perimeter 256 that corresponds to specific internal component layouts or mounting requirements. The shape of the perimeter 256 may be dictated by the need to accommodate uniquely shaped components, such as lights, sensors, wiring harnesses, or power modules. In certain aspects, the intermediate cover 102.2.2 may comprise multiple separate sections with individual outer perimeters that collectively form the overall outer perimeter 256. This modular approach may allow for more flexible assembly and disassembly, where only certain sections of the intermediate cover 102.2.2 need to be removed to access specific internal components. Furthermore, the use of multiple sections may enable customization of the intermediate cover 102.2.2 to suit different use cases or to accommodate future upgrades.

The ledge 102.2.2.8.4.2 of the forward-facing side 102.2.2.8.4 of the coupling wall 102.2.2.8.2 of the intermediate cover 102.2.2 may have corresponding attachment holes that receive fasteners to mount the intermediate cover 102.2.2 to the frontal shield 102.4. Apertures formed in the frontal shield 102.4 may also receive a fastener to mount the frontal shield 102.4 to both the intermediate cover 102.2.2 and the rear shell 102.2.4. Additionally, the interface region between the rear shell 102.2.4 and the frontal shield 102.4 may include an interlocking mechanism, such as a tongue-and-groove design or a series of small tabs and slots, to provide a more secure connection in addition to or instead of fasteners. This could improve the overall structural integrity of the head housing assembly 102. The interface region may also incorporate other types of fasteners or connection mechanisms, such as snap-fit connections, magnetic attachments, bayonet couplers, threaded couplers, friction-fit couplers, quick-release couplers, ball-and-socket joints, twist-lock couplers, dovetail joints, latch mechanisms, spring-loaded couplers, sliding locks, compression couplings, cam-lock couplers, clamp-on attachments, pin-and-hole connections, key-and-slot joints, or any combination thereof. In some aspects, the interface region may utilize multiple types of fasteners or connection mechanisms in different areas to optimize assembly, disassembly, and structural support.

Referring to FIGS. 7 and 9, the intermediate cover 102.2.2 further includes a plurality of light emitter housings 112.2 (individually, 112.2.2a, 112.2.2b, 112.2.2c, 112.2.2d) spaced around the outer perimeter 256 of the intermediate cover 102.2.2. Specifically, each light emitter housing 112.2 may be configured to house a respective light emitting assembly 112.4 of the illumination assembly 112. As best shown in FIG. 30, each light emitter housing 112.2 has five primary walls: (i) two end walls 112.6.2, 112.6.4, which are angled (e.g., at an obtuse angle) relative to a frontal surface 106.6 of the intermediate cover 102.2.2, (ii) a top wall 112.6.6, (iii) a bottom wall 112.6.8, which is angled relative to the frontal surface 106.6, and (iv) an interior wall 112.6.10, which is also angled (e.g., at an obtuse angle) relative to the frontal surface 106.6. This wall assembly primarily forms a trapezoidal body, comprised of opposed end walls 112.6.2, 112.6.4, a top wall 112.6.6 with an exterior edge and an internal edge 112.6.6a, and a sloped interior wall 112.6.10 that extends inward and towards the center C of the head 10.1 from the internal edge 112.6.6a.

The angled configuration of the walls 112.6.2, 112.6.4, 112.6.8, and 112.6.10 is designed to: (i) direct light out of the housing 112.2, and (ii) ensure that the emitted light radiates through a diffuser lens 112.4.2.8 in a manner that does not let the light scatter broadly, nor does it overly restrict the scattering of the light. In other embodiments, the walls 112.6.2, 112.6.4, 112.6.8, 112.6.10 may not be angled relative to the frontal surface 106.6, the top wall 112.6.6 may be angled, and/or the angles between the walls and the frontal surface 106.6 may be acute. In further embodiments, the size and shape of the light emitter housings 112.2.2a-112.2.2d may vary. For example, said housing 112.2 may be in the shape of a cube, cuboid, sphere, cylinder, cone, pyramid, tetrahedron, prism, torus, ellipsoid, octahedron, dodecahedron, icosahedron, hemisphere, triangular prism, pentagonal prism, hexagonal prism, or any combination thereof. The housing 112.2 may be customized to accommodate different types of light emitting assemblies 112.4.2a-112.4.2d or to achieve particular illumination effects. In some cases, each light emitter housing 112.2 may incorporate lenses, or reflective or diffusive surfaces to shape the light output. Each housing 112.2 may also include features to facilitate heat dissipation from the light emitting assemblies 112.4.2a-112.4.2d in certain embodiments. For example, the housings 112.2.2a-112.2.2d could include fins, channels, or other structures to increase surface area for heat transfer. Each housing 112.2 may also be made of thermally conductive materials like aluminum or copper alloys to enhance heat dissipation. Each housing 112.2 may also incorporate electromagnetic shielding materials or structures to prevent interference between the light emitting assemblies 112.4.2a-112.4.2d and other electronic components in the head 10.1. This could include conductive coatings, metal mesh layers, or other EMI shielding techniques integrated into the housing 112.2 design. Further, the housings 112.2 may be omitted, and the illumination assembly 112 may be part of, or integrally formed with, any aspect of the head housing assembly 102.

iv. Rear Shell

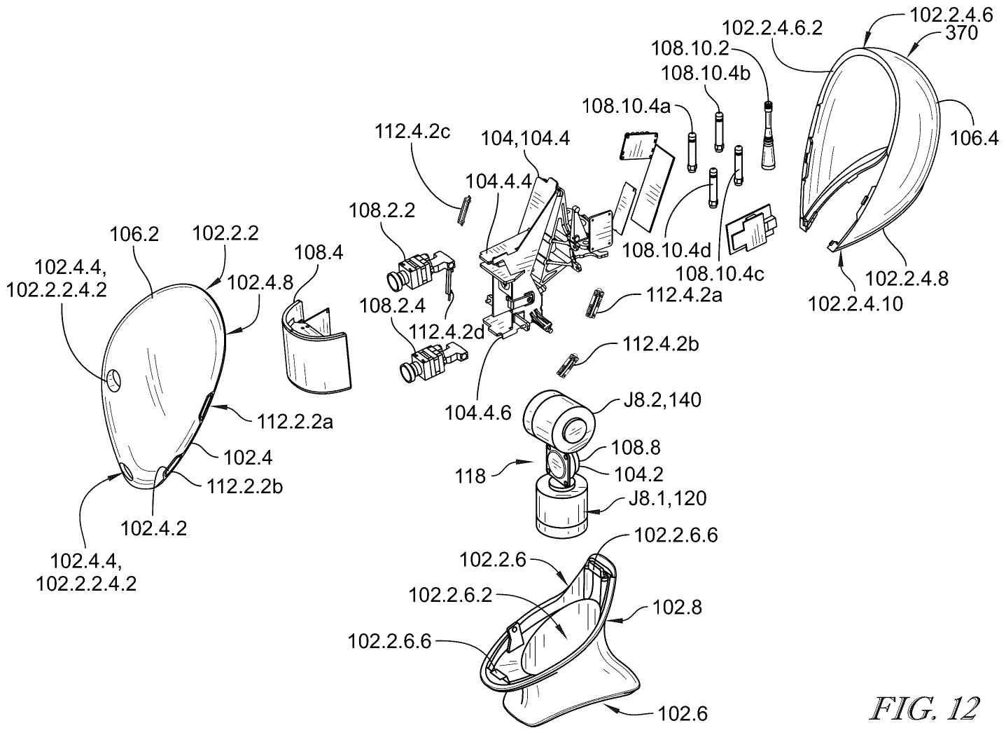

Shown in at least FIGS. 10A-10C and 12, the rear shell 102.2.4 is shaped to resemble the curvature of the rear and sides of a human head, or at least portions of a parietal region 360, an occipital region 359, a temporal region 350, an auricular region 356, a zygomatic region 358, a mastoid region 364, a buccal region 352, and a parotid region 354. The rear shell 102.2.4 covers or overlies a rear portion of the electronics assembly 108 coupled to the internal support frame 104.4. The rear shell 102.2.4 extends downward from the crown region 370 and forward at an angle to a chin projection portion 102.2.4.10. The rear shell 102.2.4 includes a rim 102.2.4.6 with a forward-facing edge 102.2.4.6.2 configured to mate with the rearward facing side 102.2.2.8.6 of the intermediate cover 102.2.2 and a lower edge 102.2.4.8 having a curvilinear shape configured to mate with the upper securement member 102.2.6 of the neck 10.2. In some examples, the rear shell 102.2.4 may include openings for sensors (e.g., cameras or other electronics).

As shown in FIG. 10C, the coupling interface 102.2.2.8 between the rear shell 102.2.4 and the frontal shield 102.4 passes through the buccal region 352, the parotid region 354, the zygomatic region 358, the temporal region 350, the parietal region 360, and the crown region 370. In other words, the rear shell 102.2.4 begins at the parotid region 354, the zygomatic region 358, the temporal region 350, the parietal region 360, and the crown region 370 and forms all portions of the head 10.1 rearward thereof. Likewise, the frontal shield 102.4 begins at these same regions and forms all portions of the head 10.1 forward thereof, except for the chin region 355. In other embodiments, the rear shell 102.2.4 may be further defined in the chin region 355. Also, it should be understood that the frontal shield 102.4 may only be positioned forward of the auricular region 356.

Referring to FIGS. 10B and 12, the rear shell 102.2.4 may be configured to cover a rear portion of the electronics assembly 108 and to form the rear end 100.4 of the head 10.1. The rear shell 102.2.4 may extend downward from a top central position in the crown region 370 and forward at an angle (A7) with respect to the third plane P₃, which is an obtuse angle (A7′) with respect a horizontal reference plane, such as the horizontal plane P_{H3}. The rear shell 102.2.4 is configured to mate with the rearward facing side 102.2.2.8.6 of the coupling interface 102.2.2.8 of the intermediate cover 102.2.2, which extends at a substantially similar angle, to enclose components of the electronics assembly 108.

The rear shell 102.2.4 includes a rim 102.2.4.6 with a forward-facing edge 102.2.4.6.2 configured to mate with the rearward-facing side 102.2.2.8.6 of the coupling interface 102.2.2.8. The frontal shield 102.4 similarly aligns with a forward facing side 102.2.2.8.4 of the coupling interface 102.2.2.8 of the intermediate cover 102.2.2 to complete the shape of the head 10.1. As shown in FIG. 12 the rear shell 102.2.4 has an outer rim 102.2.4.6 and a forward-facing edge 102.2.4.6.2 projecting inwardly from it. The forward-facing edge 102.2.4.6.2 is configured to couple the coupling interface 102.2.2.8 of the intermediate cover 102.2.2. For example, the forward-facing edge 102.2.4.6.2 of the rear shell 102.2.4 abuts the rearward facing side 102.2.2.8.6 of the coupling wall 102.2.2.8.2 and the rear facing shelf 102.2.2.8.6.2 such that it projects rearward. The rim 102.2.4.6 is configured to fit upon the perimeter of the rear facing shelf 102.2.2.8.6.2 such that the forward facing edge 102.2.4.6.2 substantially matches the dimensions of the coupling wall 102.2.2.8.2, and the rear surface 106.4 of the rear shell 102.2.4 is substantially flush with the border edge 102.2.2.8.2.2 of said coupling wall 102.2.2.8.2.

Apertures formed in the frontal shield 102.4 may also receive a fastener to mount the frontal shield 102.4 to both the intermediate cover 102.2.2 and the rear shell 102.2.4. Alternatively, the apertures and fasteners may be replaced using snap-fit connections, magnetic attachments, interlocking geometries, bayonet couplers, threaded couplers, friction-fit couplers, quick-release couplers, ball-and-socket joints, twist-lock couplers, dovetail joints, latch mechanisms, spring-loaded couplers, sliding locks, compression couplings, cam-lock couplers, clamp-on attachments, pin-and-hole connections, key-and-slot joints, other similar couplers, or other known coupling mechanisms. In other embodiments, the chin projection portion 102.2.4.10 could be designed as a separate, detachable component that can be swapped out for different shapes or sizes.

The rear shell 102.2.4 may incorporate a multi-layered structure with varying properties to optimize functionality and performance. The outer layer can provide protection against impacts and environmental exposure, while inner layers may help absorb shocks and vibrations to safeguard internal components. The composition of the rear shell 102.2.4 may vary across different regions to balance structural support and flexibility, accommodating movement or internal component adjustments. Integrated cable management channels or conduits can improve the routing of wires and connectors, enhancing both aesthetics and ease of maintenance. These channels may include secure covers to prevent accidental damage. The rear shell 102.2.4 may also feature modular sections that are removable or adjustable for customization and upgrades, such as access panels for frequently serviced components. Magnetic attachments can be used to secure external accessories, enabling quick reconfiguration without mechanical fasteners. Additionally, interlocking geometries along edges or connection points can improve assembly precision and distribute mechanical loads more evenly, enhancing the structural integrity of the device. Advanced designs may embed sensors or connectors within the shell 102.2.4 to detect impacts, provide real-time feedback on structural integrity, or facilitate internal power and data transfer without visible wiring, contributing to a cleaner, streamlined design.

The rear shell 102.2.4 may be formed from or include materials such as silicone elastomers, thermoplastic polyurethane (TPU), shape-memory polymers (SMPS), polydimethylsiloxane (PDMS), polyurethane, liquid silicone rubber (LSR), urethane rubber, a vinyl (PVC) skin, soft thermoplastic elastomers (TPE), elastomeric alloys, acrylonitrile butadiene styrene (ABS) blends, high-density polyethylene (HDPE) blends, conductive polymers, carbon nanotube-infused elastomers, magnetic shape-memory alloys, electroactive polymers (EAPS), styrene-butadiene rubber (SBR), thermoplastic vulcanizates (TPV), polyurea elastomers, medical-grade synthetic skin materials, thermoplastic olefins (TPO), fluoroelastomers, chloroprene rubber, ethylene propylene diene monomer (EPDM) rubber, polyacrylamide hydrogels, polycaprolactone (PCL), photocurable resins, elastomeric composites, phosphorescent elastomers, thermochromic materials, electrostrictive polymers, piezoelectric polymers, superelastic alloys, microcellular foams, hyperelastic materials, viscoelastic gels, nanocomposite elastomers, fabrics, metal, other similar plastics or polymers, or any combination thereof.

The rear shell 102.2.4 may be fabricated using various manufacturing techniques, each offering unique benefits based on design requirements, material properties, and production efficiency. These methods include injection molding, dip molding, casting, additive manufacturing (e.g., stereolithography, fused deposition modeling (FDM), and selective laser sintering (SLS)), spray coating, lamination or layering, electrospinning, sculpting, precision machining, thermoforming, or other similar methods or combinations thereof. In one exemplary hybrid approach, the primary structure of the rear shell 102.2.4 could be 3D printed using a high-strength polymer, such as nylon or polycarbonate, to achieve both durability and complex geometries. Overmolding certain regions with softer elastomeric materials, like thermoplastic elastomers (TPE) or silicone rubber, can enhance flexibility, shock absorption, and user comfort in areas subject to impact or repeated stress. This combination ensures a balance between rigidity and pliability, improving both mechanical performance and ergonomic benefits. Furthermore, additional post-processing steps can be incorporated to tailor the rear shell 102.2.4 for specific applications. In some cases, conductive coatings may be applied to enable electromagnetic shielding or to support smart functionalities, such as integrating sensors or antennas directly into the shell's surface. Additionally, certain regions of the rear shell 102.2.4, particularly around joints or flex points, could incorporate shape-memory alloys or polymers. These materials could allow for controlled deformation and return to an original shape, accommodating movement while maintaining overall structural integrity. Further, the rear shell 102.2.4 could feature integrated cable management channels or conduits, integrated cooling channels or heat sinks, or separate, detachable components.

b. Neck Portion

As shown in at least FIGS. 6 and 12-15, the neck 10.2 of the head and neck assembly 10 includes an upper securement member 102.2.6, a lower securement member 102.6, and a deformable neck cover 102.8. In various examples, at least an extent of head actuator assembly 118, including one or more head actuators J8.1, J8.2, is positioned within the neck 10.2 and enclosed by the neck cover 102.8. The upper securement member 102.2.6 completes the shape of the head 10.1 and provides a coupling structure for the deformable neck cover 102.8.

The deformable neck cover 102.8 is designed to extend from an upper portion of the torso 16 to a lower portion of the head 10.1 (specifically covering a majority of the neck 10.2, but not the entire head 10.1) and allow the head 10.1 to move with respect to the torso 16. The lower securement member 102.6 is configured to couple the neck cover 102.8 to an upper portion of the torso 16. The neck cover 102.8 may be part of the exterior covering assembly 1.2.16 and includes a textile exterior layer that can be easily swapped if damaged, serves to protect internal components from dust and debris, fits the form of the robot 1 without substantial wrinkling, and allows for venting to address thermal considerations at specified locations. The material is configured to deform with the movement of the head 10.1 with respect to the torso 16 and return to its initial form when the head 10.1 is in a neutral position. One or more components of the electronics assembly 108 may be positioned in the neck 10.2, wherein the neck cover 102.8 does not interfere with the transmission of a signal (e.g., audio signal, wireless transmission, etc.).

i. Upper Securement Member

Referring to FIG. 12, the upper securement member 102.2.6 has a central opening 102.2.6.2 and support mounts 102.2.6.6. The upper securement member 102.2.6 is shaped to couple with the internal support frame 104.4 in a position such that at least a portion of the actuator assembly 118 extends through the central opening 102.2.6.2. Front and rear support mounts 102.2.6.6 may extend from an interior surface of the upper securement member 102.2.6 into which fasteners may be received to couple the upper securement member 102.2.6 to the rear shell 102.2.4 and/or at least one surface of the internal support frame 104.4 (e.g., at the lower sensor mount 104.4.6). The upper securement member 102.2.6 is shaped to complete a form that resembles a head and to mate with the lower edges of the intermediate cover 102.2.2 and the rear shell 102.2.4 to enclose a substantial portion of the electronics assembly 108 coupled to the internal support frame 104.4. The upper securement member 102.2.6, the head nod actuator (J8.2) 140, and the actuator coupler 104.2 may be enclosed by the neck cover 102.8 which will be described in further detail below.

ii. Neck Cover

As shown in FIGS. 12-15, the neck cover 102.8 is configured to wrap around at least an edge portion of the upper securement member 102.2.6 at the head housing assembly 102 and couple to an upper portion of the torso 16. For example, the neck cover 102.8 may couple to a structure configured to mount in the collar region of the torso 16. In doing so, the neck cover 102.8 obscures the head actuators J8.1 and J8.2, the actuator coupler 104.2, and other electronics contained therein. For example, in the illustrative embodiment, a microphone 108.6 and speaker 108.8 may be coupled to the actuator coupler 104.2 or the upper securement member 102.2.6, or positioned elsewhere in the head and neck assembly 10.

The neck cover 102.8 may be made of a textile or other material configured to allow the transmission of sound. The neck cover 102.8 is designed to return to its original state when the head 10.1 returns to its normal state (e.g., forward-facing). The textile neck cover 102.8 may be made from a deformable material that allows the head 10.1 to twist in both directions and pitch forward and back without bunching or pulling. The deformable material can be the same textile that is used throughout the exterior covering assembly 1.2.16 to provide a uniform exterior appearance. The neck cover 102.8 may be a cover member of the exterior covering assembly 1.2.16.

c. Internal Support Assembly

Referring to FIGS. 12-15, the internal support assembly 104 includes an actuator coupler 104.2 and an internal mounting frame 104.4. The actuator coupler 104.2 resides substantially in the neck 10.2 and the internal mounting frame 104.4 resides substantially in the head 10.1. Various components of the electronics assembly 108 may be coupled directly or indirectly to the internal support assembly 104. Further, the head housing assembly 102 may be coupled to the internal mounting frame 104.4 to surround various components of the electronics assembly 108.

The actuator coupler 104.2 provides structural support within the neck 10.2 for connecting the head 10.1 to the torso 16. The actuator coupler 104.2 is configured to couple the head twist actuator (J8.1) 120 and the head nod actuator (J8.2) 140 in an orientation such that their axes A8.1, A8.2 are perpendicular to each other, providing the head 10.1 with two degrees of freedom. In the illustrative embodiment, the head twist actuator (J8.1) 120 is housed substantially in the torso 16 and the actuator coupler 104.2 extends vertically to couple the head nod actuator (J8.2) 140 within the head 10.1. In other embodiments, the positions of the head actuators J8.1, J8.2 are reversed, where the head nod actuator (J8.2) 140 is housed substantially in the torso 16 and the actuator coupler 104.2 extends vertically to couple the head twist actuator (J8.1) 120 within the head 10.1. The actuator coupler 104.2 provides a separation between the head actuators J8.1, J8.2 to facilitate movement of the head 10.1. As shown in FIG. 14, the actuator coupler 104.2 may also be configured to couple one or more components of the electronics assembly 108, such as a speaker 108.8 and/or microphone 108.6. In the illustrative embodiment, speaker 108.8 is mounted between the head twist actuator (J8.1) 120 and head nod actuator (J8.2) 140, where the neck cover 102.8 is made of a material that allows the transmission of sound.

In the illustrative embodiment, the internal mounting frame 104.4 is coupled to the actuator housing of the head nod actuator (J8.2) 140. The internal mounting frame 104.4 includes a plurality of mounting surfaces and coupling features configured to couple the components of the electronics assembly 108 and the head housing assembly 102. The internal mounting frame 104.4 includes at least an actuator mount 104.4.2, an upper sensor mount 104.4.4, and a lower sensor mount 104.4.6. The electronics assembly 108 contained in the head 10.1 may include a sensor assembly 108.2, a screen or display 108.4, a head illumination assembly 112, and other components. The internal mounting frame 104.4 and the components coupled thereto reside substantially in the head 10.1 and are configured to move as a unit, including twist movements driven by the head twist actuator (J8.1) 120. In some embodiments, the head twist actuator (J8.1) 120 may be positioned above the head nod actuator (J8.2) 140, as shown in FIG. 3B, such that the head twist actuator (J8.1) 120 is coupled to the internal mounting frame 104.4 or other electronics support.

d. Electronics Assembly

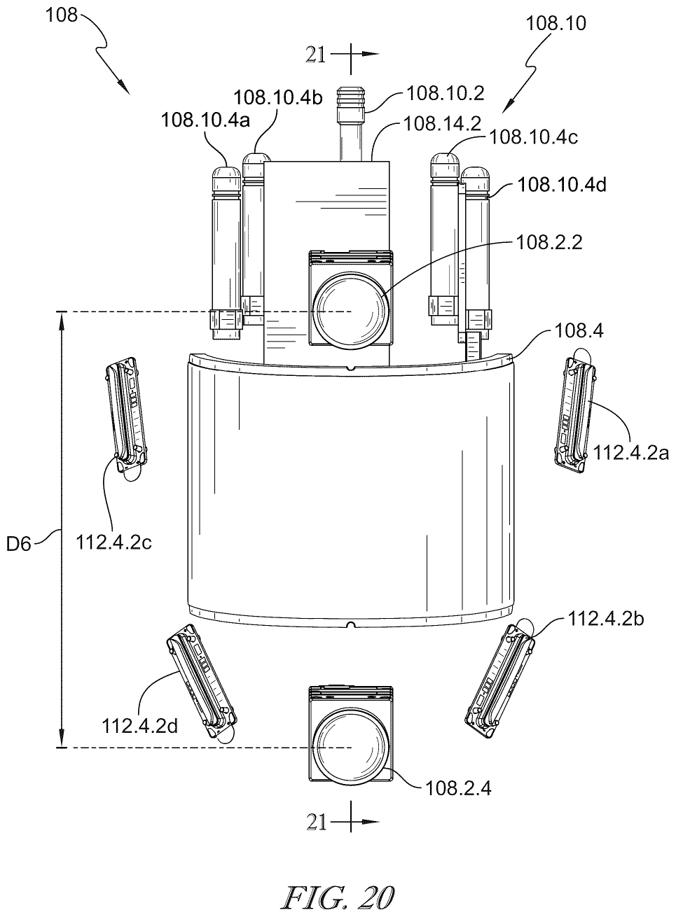

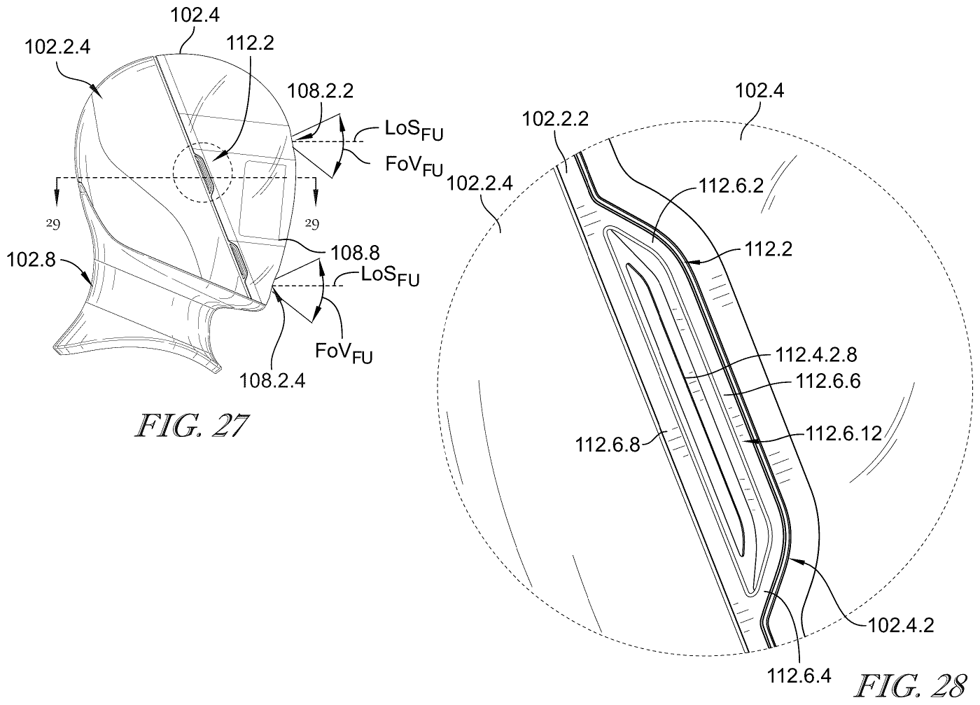

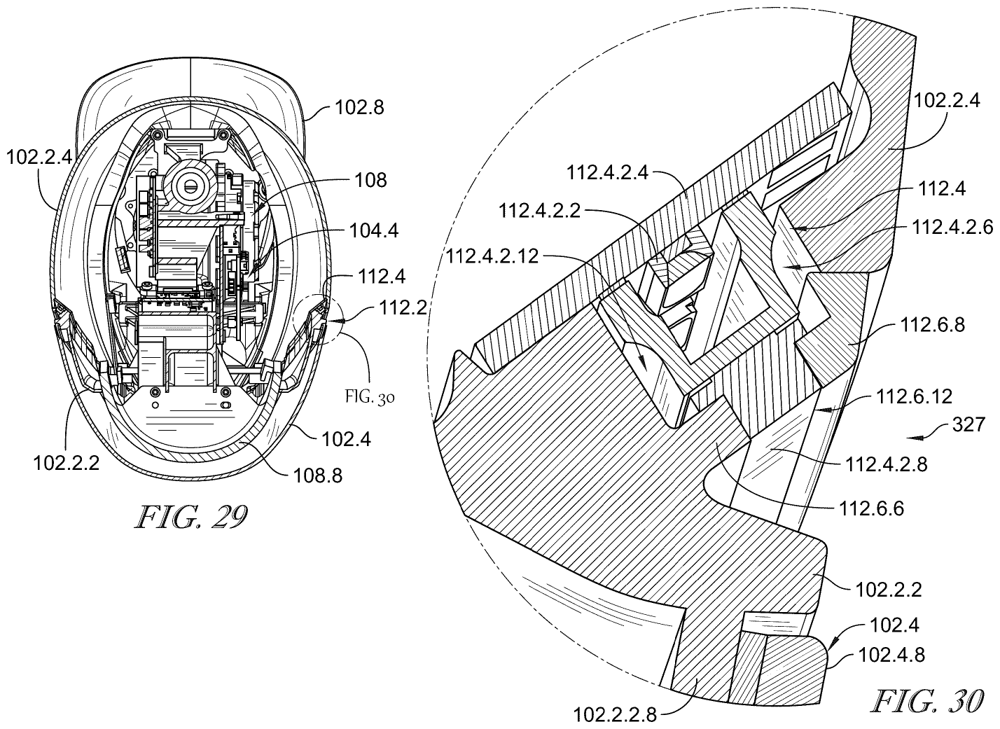

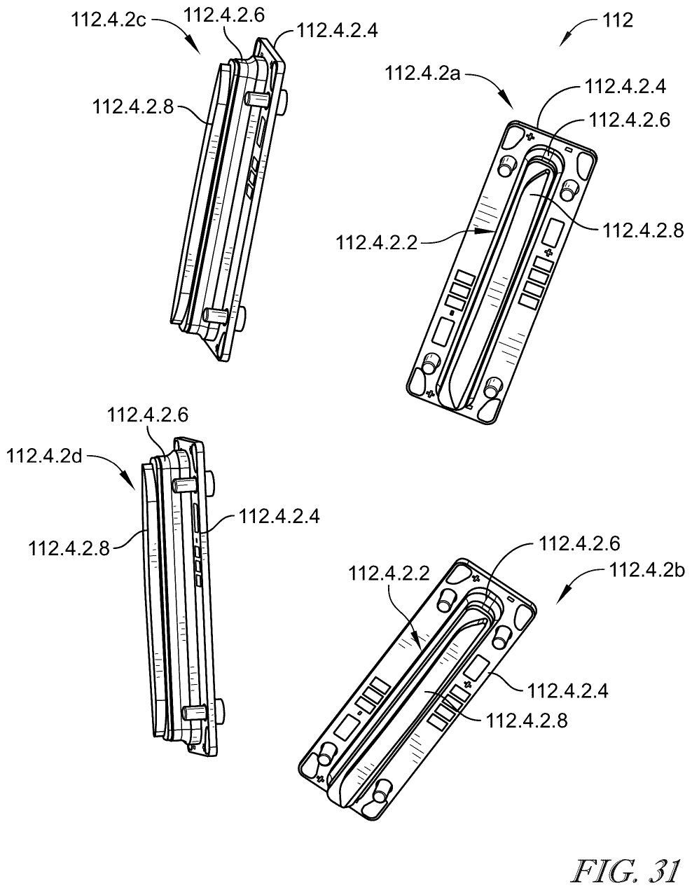

Referring to FIGS. 12-15 and 18-33, the electronics assembly 108 contained in the head and neck assembly 10 may include: (i) a sensor assembly 108.2, (ii) a screen or display 108.4, (iii) an illumination assembly 112 that includes at least one, and preferably a plurality of, light emitting assemblies 112.4.2a-112.4.2d, (iv) other electronics 108.16 (e.g., an Inertial Measurement Unit (IMU), an RFID reader, location sensors (e.g., Global Positioning System (“GPS”), GLONASS, Galileo, QZSS, and/or iBeacon), etc.), and/or (v) one or more computing devices 108.14, for example including Printed Circuit Boards (PCBs) for connecting the electronics. For example, the electronics assembly 108 may also include one or more microphones 108.6, one or more speakers 108.8, and antennas 108.10. In the illustrative embodiment, the microphone 108.6 and speaker 108.8 are positioned in the neck 10.2.

The electronics assembly 108 further includes one or more computing devices 108.14, such as PCBs. A data storage device may be a removable memory device or integrated into a computing device 108.14 that comprises a processor and a memory. In some examples, the data storage device may be housed in another portion of the robot 1, such as the torso 16. In some examples, the data storage device may be configured to store data collected from other components of the robot 1. The head electronics assembly 108 may be a portion of the electronic assembly 1.2.6 of the robot 1 and/or communicatively coupled to computing architecture 1100 located in the torso 16 or elsewhere in the robot 1.

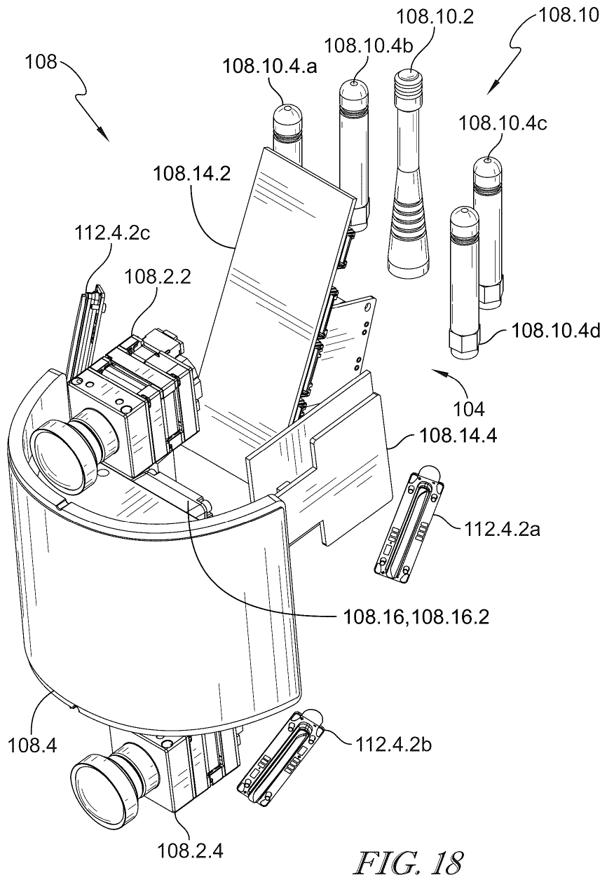

As shown in at least FIGS. 18-22, the components of the electronics assembly 108 may be mounted to the internal mounting frame 104.4 configured to arrange the individual items in a space-saving manner. The internal mounting frame 104.4 includes at least an actuator mount 104.4.2, an upper sensor mount 104.4.4, and a lower sensor mount 104.4.6. The actuator mount 104.4.2 couples to the housing of the head nod actuator (J8.2) 140 and is configured such that the entire internal mounting frame 104.4 and attached components move correspondingly with the position of the actuator (J8.2) 140. In various embodiments, some components of the electronics assembly 108 may be coupled to the actuator coupler 104.2 or to any other structure of the head and neck assembly 10 as an alternative to the internal mounting frame 104.4.

As noted above, the head housing assembly 102 is configured to enclose a substantial portion of the electronics assembly 108 without interfering with the transmission or reception of signals. For example, the housing 102 does not obscure the line of sight of the cameras 108.2.2, 108.2.4 of the sensor assembly 108.2. Although the illustrative embodiment shows one configuration of the components of the electronics assembly 108, the individual components may be arranged in another manner. For example, one or more of the components shown in the illustrative embodiment may be positioned in the neck 10.2 and coupled to the actuator coupler 104.2 or an alternative structure.

i. Sensor Assembly

Referring to FIG. 12, the sensor assembly 108.2 may include a variety of sensing devices and systems to enhance the humanoid robot's 1 perception capabilities and adaptability in various environments. The sensor assembly 108.2 may include: (i) one or more cameras 108.2.2, 108.2.4, (ii) temperature sensors to detect ambient or object temperatures for safety and operational adjustments, (iii) pressure sensors to measure contact or surface pressures, (iv) force sensors for detecting applied forces during interactions, (v) inductive sensors for proximity and metal object detection, (vi) capacitive sensors to sense touch or proximity, (vii) any combination of these sensors, or (viii) other known sensors including ultrasonic, acoustic, or gas sensors for additional environmental monitoring.

Referring to FIG. 15, in the illustrative example, the one or more cameras of the sensor assembly 108.2 include an upper or first camera 108.2.2 and a lower or second camera 108.2.4 coupled to the internal mounting frame 104.4 at respective mounting positions 104.4.4 and 104.4.6. As shown in the Figures, the upper or first camera 108.2.2 is separate and distinct from the lower or second camera 108.2.4. As such, the upper or first camera 108.2.2 and a lower or second camera 108.2.4 are not coupled to a single printed circuit board (PCB). As shown in the Figures, the upper or first camera 108.2.2 includes a first lens, and the lower or second camera 108.2.4 includes a second lens. The first and second lens may be visible through the frontal shield 102.4, where the bodies of the first and second cameras 108.2.2, 108.2.4 are not visible. As such, (i) at least a portion of the first and second cameras 108.2.2, 108.2.4 is visible through the frontal shield 102.4, and (ii) at least a portion of the first and second cameras 108.2.2, 108.2.4 is obscured by the intermediate cover 102.2.2.

Additionally, the upper camera 108.2.2 may be positioned above the display 108.4 and the lower camera 108.2.4 may be positioned below the display 108.4, both directed in a substantially forward direction. As shown in at least FIGS. 15, 21, 27, and 32, the upper camera 108.2.2 and the lower camera 108.2.4 may be arranged in a vertical orientation and may be placed at the same angle relative to the horizontal or transverse plane P_{T}. For example, the cameras 108.2.2, 108.2.4 may be positioned at a slight downward angle of about 6.0 to about 9.0 degrees, or about 6.7 to about 8.2 degrees with respect to a horizontal plane (e.g., plane P₁). The lens of each of the upper and lower cameras 108.2.2, 108.2.4 can be received within the respective upper and lower sensor openings 102.2.2.4.2.2, 102.2.2.4.2.4 of the intermediate cover 102.2.2. It should be understood that in other embodiments, the lower camera 108.2.4 may be referred to as the first camera and the upper camera 108.2.2 may be referred to as the second camera.

### 1. Field of View

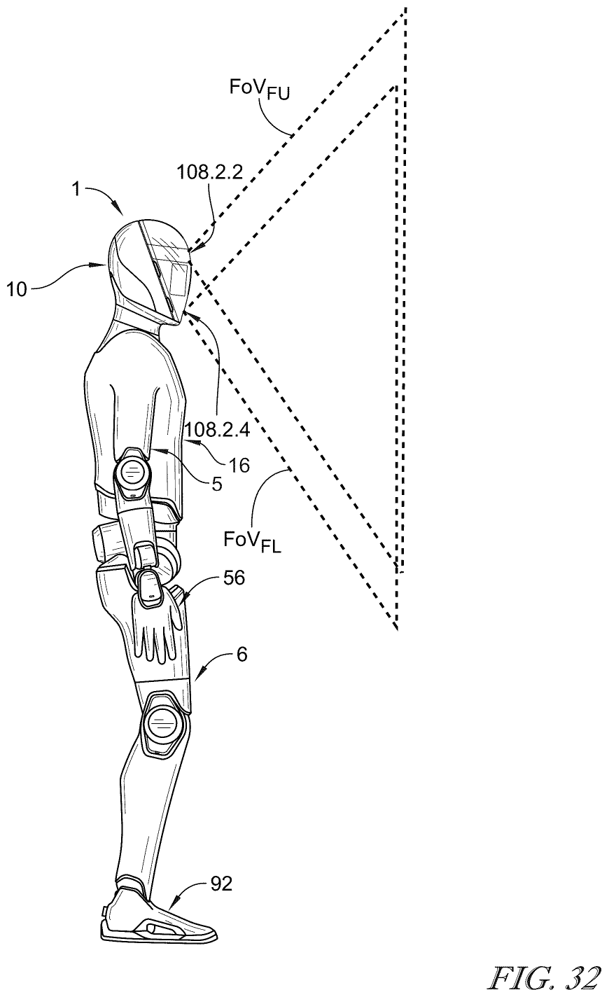

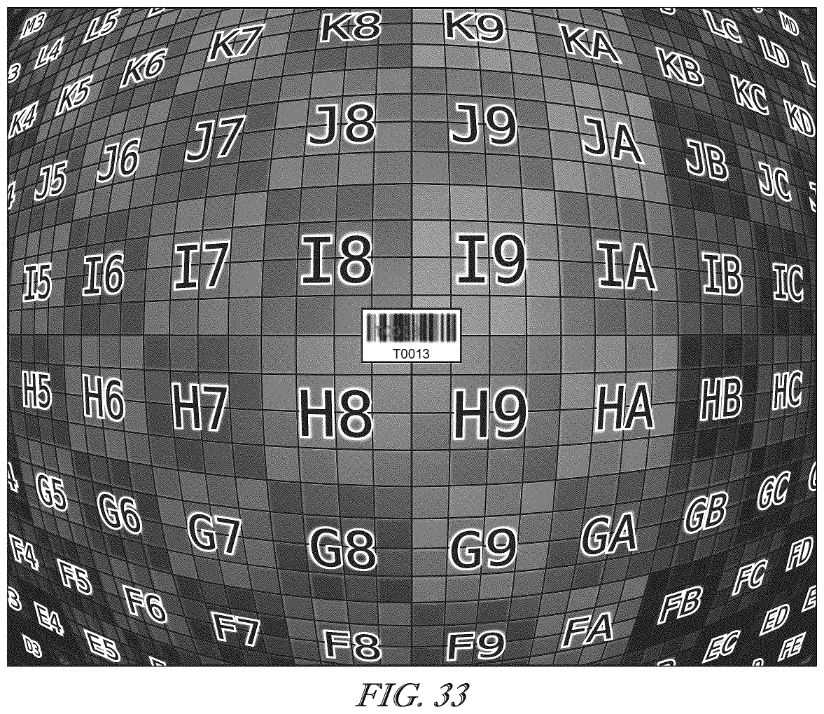

FIG. 33 shows an image from a video generated by the custom-built algorithm that integrates data from the vertically arranged upper and lower cameras 108.2.2, 108.2.4 shown in FIG. 32. This image shows that the robot 1 has stereo vision along with the ability to identify and read barcodes. Due to the fisheye lenses installed with the upper and lower cameras 108.2.2, 108.2.4, the robot's 1 field of view is increased over conventional lenses. Aₙ example of this field of view, is shown in FIG. 33. However, the use of fisheye lenses causes the image to be warped or distorted near its periphery. This distortion can be corrected or partially corrected by the custom-built algorithm to help increase data extraction in these regions. In other embodiments, the fisheye lenses that are currently shown in the figures and used to generate the image shown in FIG. 33 may be replaced with other lens types (e.g., standard or non-fisheye lenses).

By using two sensor assemblies 108.2, the robot 1 can see in stereo vision. This stereo vision is provided by the combination of the vertically arranged sensor assemblies 108.2, not horizontal, triangular, or other geometric arrangements. The vertical arrangement of two sensor assemblies 108.2 (i.e. cameras) reduces the number of sensors for frontal data collection to two cameras positioned vertically, instead of three or more cameras. This reduction is beneficial because it reduces the heat generated within the head 10.1 and creates additional free space within said head 10.1.

Although the upper and lower cameras 108.2.2, 108.2.4 are shown as illustrative examples, other sensors may be used and coupled to the internal mounting frame 104.4 in a similar manner to ensure proper directional positioning for respective detection, sensing, or signal reception. Additionally or alternatively, the sensor assembly 108.2 may include: (i) scan camera(s) for detailed inspection, (ii) monochrome camera(s) for improved low-light performance, (iii) color camera(s) for standard imaging, (iv) CMOS camera(s) for high-speed imaging, (v) CCD sensor(s) or camera(s) that include CCD sensor(s) for high-quality imaging, (vi) camera(s) or sensor(s) that have a rolling shutter or global shutter for various imaging requirements, (vii) other types of 2D digital camera(s) for traditional imaging, (viii) other types of 3D digital camera(s) for depth mapping, (ix) camera(s) or sensor(s) that are capable of stereo vision, structured light projection, and laser triangulation for enhanced 3D imaging, (x) sonar camera(s) or ultrasonic camera(s) for proximity sensing, (xi) infrared sensor(s) and/or infrared camera(s) for low-light and heat detection, (xii) radar sensor(s) for distance measurement, (xiii) LiDAR for precise mapping, (xiv) other structured light sensors, camera(s), or technologies for advanced imaging, (xv) dot projecting camera(s) or sensor(s) for depth sensing, or (xvi) any combination of the above or any other known camera or sensor. In one embodiment, a camera 108.2.2, 108.2.4 may have a megapixel resolution of between 0.4 MP to 20 MP, may record video at frame rates from 5.6 FPS to 286 FPS, may have a CMOS sensor, its pixel size may range from 2.4 μm to 6.9 μm, may utilize Starvis rolling shutter technology, can operate in 55-degree Celsius ambient air temperatures, and may have any other properties, technologies, or features that are discussed within U.S. Pat. Nos. 11,402,726, 11,599,009, 11,333,954, or 11,600,010, all of which are incorporated herein by reference in their entirety. It should be understood that the cameras 108.2.2, 108.2.4 are typically configured as video cameras but may have an alternative configuration, such as an image camera or a multi-functional camera capable of capturing both still images and video footage.

In the illustrative embodiment, cameras 108.2.2 and 108.2.4 are positioned in the head 10.1, in a forward facing orientation OFF, and centered on the second plane P₂ of the head 10.1 or sagittal plane P_{S} of the robot 1. The upper camera 108.2.2 may be positioned in the frontal region 362 above the display 108.4 and the lower camera 108.2.4 positioned in the chin or mental region 355. In the illustrative embodiment, the upper and lower cameras 108.2.2, 108.2.4 may be configured with line of sights (LoS_{HU}, LoS_{FL}) that are substantially parallel to each other and directed forward at a slight angle with respect to the first plane P₁ of the head 10.1. Each camera 108.2.2, 108.2.4 may have a forward field of view (FoV_{FU}, FoV_{FL}) or cone of vision, of about 57.6 degrees to about 86.4 degrees, or about 71.1 degrees to about 79.2 degrees. For example, the field of view FoV_{FU} or cone of vision of the upper camera 108.2.2 may be about 72 degrees. As shown in FIG. 15, the field of view of the cameras 108.2.2, 108.2.4 may have a minor or substantial overlap to improve depth perception and eliminate blind spots. In other embodiments, the line of sights (LoS_{FU}, LoS_{FL}) of the first camera 108.2.2 and second camera 108.2.4 may be arranged in a reference plane that is parallel to either: (i) the sagittal plane P_{S}, or (ii) the transverse plane P_{T}.

In some embodiments, to further enhance the versatility of the vision system, the cameras contained in the set of cameras 108.2 may feature adjustable fields of view achieved through various mechanisms. These mechanisms may include motorized zoom lenses capable of dynamically adjusting the focal length to focus on distant or close objects as needed, and wide-angle lenses combined with software-based digital zoom and cropping to provide both broad coverage and detailed inspection capabilities. In scenarios where extreme wide-angle views are required, fisheye lenses with integrated distortion correction algorithms may be employed to deliver a seamless image output.

In other embodiments, the humanoid robot 1 may include additional or different cameras. For example, said set of cameras 108.2 may alternatively or additionally include a plurality of lower cameras positioned below the display 108.4, oriented downward to monitor the area in front of the robot's feet 92. Said plurality of lower cameras may be beneficial for obstacle detection in close proximity to the humanoid robot 1, enabling it to navigate uneven terrain or avoid small objects on the ground. In other embodiments, the set of cameras 108.2 may include rear-facing camera(s) to monitor the area behind the humanoid robot 1, which may improve safety during backward movements or when the humanoid robot 1 operates in dynamic environments with multiple moving objects. In some aspects, the set of cameras 108.2 may include side-mounted cameras on each side of the head 10.1 may provide a full 360-degree field of vision, ensuring the humanoid robot 1 can detect lateral movements and peripheral activities. In certain implementations, the set of cameras 108.2 may include cameras be mounted on adjustable or retractable arms, or may be detachable to enable them to be reconfigured or repositioned based on specific operational requirements. These adjustable mounts may include motorized mechanisms to dynamically adjust the angle and position of each camera contained in the set of cameras 108.2, allowing for on-the-fly adaptation to different tasks and environments. For example, during inspection tasks, the cameras may be reoriented to focus on specific areas of interest, while during navigation, they may return to a default position to maximize the robot's field of vision.

Additionally, the vision system may incorporate advanced imaging techniques, such as multi-frame noise reduction algorithms, to improve image clarity in low-light conditions. Advanced autofocus systems, including phase-detection and contrast-detection autofocus, may be integrated to provide rapid and precise focus adjustments. For enhanced environmental adaptability, the vision system may be equipped with polarization filters to reduce glare and improve visibility in reflective or water-covered environments. For reliability and redundancy, the vision system may feature modular cameras that can be hot-swapped, allowing for seamless replacement without disrupting the robot's operations. These camera units may also include self-cleaning mechanisms like hydrophobic coatings, ultrasonic vibration systems to dislodge dust, or small wipers to maintain lens clarity. Additionally, automated diagnostics systems could be integrated to monitor the health and performance of each camera, alerting the humanoid robot 1 to potential issues and enabling proactive maintenance. To enhance resilience in harsh environments, the cameras may be housed in rugged enclosures with shock-absorbing mounts, protecting them from physical impacts and vibrations.

Although cameras 108.2.2, 108.2.4 are shown as illustrative examples, other types of sensors may be utilized and mounted to an internal frame or support in a similar manner to achieve optimal directional alignment for various detection, sensing, or signal reception tasks. For example, the sensor assembly 108.2 or the vision system may incorporate time-of-flight (ToF) sensors, structured light projectors paired with infrared cameras, or stereo cameras with variable baselines to enhance depth perception and generate accurate three-dimensional spatial maps. Additionally, radar and ultrasonic sensors may be integrated to provide redundant distance measurements, which can be particularly valuable in low-visibility conditions or dynamic environments. In certain embodiments, lidar sensors may be employed for precise long-range distance measurements, while thermal imaging cameras can detect heat signatures and monitor temperature variations. Multi-spectral or hyperspectral imaging systems may further improve object recognition by identifying materials based on their unique spectral characteristics, thereby enhancing the robot's ability to navigate and interpret complex environments.

ii. Head Illumination Assembly

The head illumination assembly 112 includes at least one, and preferably a plurality of, light emitting assemblies 112.4.2a-112.4.2d located on lateral sides of the head 10.1. In certain configurations, the illumination assembly 112 may be designed to visually indicate robot statuses to users viewing the humanoid robot 1 from the side.

As shown in FIGS. 8-10C, on the left side, a first light emitting assembly 112.4.2a is located in a temporal region 350 of the robot's head 10.1, and a second light emitting assembly 112.4.2b is located in a buccal region 352. Third and fourth light emitting assemblies 112.4.2c and 112.4.2d are located symmetrically on the opposite right side of the robot's head 10.1, in the temporal region 350 and the buccal region 352 respectively.

In some embodiments, the light emitting assemblies 112.4.2a-112.4.2d can be located all or partially in a parotid region 354, an auricular region 356, a zygomatic region 358, a parietal region 360, a frontal region 362, or a mastoid region 364, so long as the light emitters 112.4.2.2 comprised in the light emitting assemblies 112.4.2a-112.4.2d are positioned on a lateral side of the robot's head 10.1 so as to be visible to a person standing next to the humanoid robot 1. These positions of the light emitting assemblies 112.4.2a-112.4.2d allow users to view the light emitted from said light emitting assemblies 112.4.2a-112.4.2d from the side while the humanoid robot 1 is working on a task in an assembly line, for example, and while the display 108.4 is facing the assembly line and may not be entirely visible by the user. Further, the light emitting assemblies 112.4.2a-112.4.2d may face away from the display 108.4 so as not to obstruct the information displayed by the display 108.4, and may face away from other sensors so as not to interfere with said sensors. Other regions of the head 10.1 where the light emitting assemblies 112.4.2a-112.4.2d are not typically found include a chin or mental region 355, an orbital region 368, a nasal region 357, a crown region 370, and an occipital region 359.

The light emitting assemblies 112.4.2a-112.4.2d in the head 10.1 may be configured to display a status of the humanoid robot 1, or a part thereof, to users. As such, the light emitting assemblies 112.4 may be able to alter their color (e.g., visible and non-visible light), intensity, and duration. In one embodiment, the light emitting assemblies 112.4.2a-112.4.2d may display a first color (i.e., green—550 nm) when the robot 1 is engaged in a task, such as assembling a part on an assembly line. The light emitting assemblies 112.4.2a-112.4.2d can display a second color (i.e., yellow—600 nm) when the humanoid robot 1 is not assigned to a task, to indicate to users that the humanoid robot 1 is available for a task. The light emitting assemblies 112.4.2a-112.4.2d can display a third color (i.e., red—665 nm) when the robot's battery life is low and it should be recharged.

Additionally, the light emitting assemblies 112.4.2a-112.4.2d may display a variety of other colors, patterns, or sequences to convey different statuses or alerts. For example, the light emitting assemblies 112.4.2a-112.4.2d can display a flashing blue light—470 nm to indicate that the humanoid robot 1 is in a standby mode and awaiting further instructions. A pulsing white light can be used to indicate that the humanoid robot 1 is undergoing a system update or performing a self-diagnostic check. Alternatively, the light emitting assemblies 112.4.2a-112.4.2d can display a purple light to indicate that the humanoid robot 1 is in a training mode, learning a new task or recalibrating its sensors. Further, the light emitting assemblies 112.4.2a-112.4.2d can blink repeatedly to indicate that the humanoid robot 1 has lost communication with a host server or external device, or is attempting to pair or searching for a device or server to connect to. Finally, the light emitting assemblies 112.4.2a-112.4.2d may emit non-visible light (e.g., infrared, ultraviolet) that enables the humanoid robot 1 to communicate with other robots or systems equipped with appropriate sensors.

In some embodiments, the light emitting assemblies 112.4.2a-112.4.2d may also use dynamic lighting patterns, such as slow pulses, fast blinks, or color gradients, to communicate additional information. For instance, a gradual transition from green to yellow may indicate that the humanoid robot 1 is completing a task and will soon be available. A rapidly blinking red light may signal a critical error or an emergency stop condition, prompting immediate attention. The light emitting assemblies 112.4.2a-112.4.2d and/or the display 108.4 can also be used to indicate when a component in the head 10.1 and/or neck 10.2, such as an actuator or sensor, is malfunctioning and should be serviced. For example, a specific color or pattern may correspond to different types of malfunctions. A steady orange light could indicate a minor issue that requires maintenance but does not immediately impact the robot's performance, while a flashing red-and-white pattern could signal a major fault that requires immediate servicing. In another example, the light emitting assemblies 112.4.2a-112.4.2d can display a particular color that corresponds with the information displayed on the display 108.4. If the humanoid robot 1 is running low on battery life, the light emitting assemblies 112.4.2a-112.4.2d can display a red color while the display 108.4 displays a message and/or icon that indicates that the battery is low.

The light emitting assemblies 112.4.2a-112.4.2d may also be synchronized with audible alerts or haptic feedback mechanisms to ensure that users are promptly notified of the robot's status, even in environments where visual indicators may be less noticeable. For instance, a flashing light paired with a beeping sound can signal an urgent issue, while a soft chime can accompany a color change indicating that the humanoid robot 1 has completed its task and is ready for the next assignment. Light emitting assemblies 112.4.2b, 112.4.2d are positioned adjacent to an oral region 366 of the head 10.1 and can be operated independently of the light emitting assemblies 112.4.2a, 112.4.2c, which are located above light emitting assemblies 112.4.2b, 112.4.2d and adjacent to an orbital region 368 of the head 10.1. Alternatively or additionally, said light emitting assemblies 112.4.2a-112.4.2d may be able to project patterns or simple icons onto nearby surfaces.

Each of the light emitting assemblies 112.4.2a-112.4.2d in the head 10.1 includes: (i) a light source or light emitter 112.4.2.2, and (ii) a diffuser lens 112.4.2.8 extending between end walls 112.6.2, 112.6.4, a top wall 112.6.6, a bottom wall 112.6.8, and an interior wall 112.6.10 of a respective light emitter housing 112.2. The light source 112.4.2.2 and the diffuser lens 112.4.2.8 form the light emitting assembly 112.4 that is inserted together into each respective light emitter housing 112.2. The light source or emitter 112.4.2.2 can include any known light emitter, including any one or more of the following: a laser, an LCD, an LED (e.g., a Chip-on-Board LED), an OLED, an LPD, an IMOD, a QDLED, an mLED, an AMOLED, an SED, an FED, a plasma source, electronic paper or EPD, MicroLED, a quantum dot display, a LED backlit LED, a WLCD, a OLCD, a transparent OLED, a PMOLED, a capacitive touchdisplay, a resistive touchdisplay, fiber optic light guides that distribute light from a central source to multiple output points on the head surface, a monochrome emitter, a color emitter, or any combination of the above, or any other known technology or light emitting feature. It should be understood that in other embodiments, the above disclosed light sources or emitters 112.4.2.2 and/or additional light emitters 112.4.2.2 may be formed in any desirable configuration or used with any other material, structure, or component to form the desirable light emitting assemblies 112.4.2a-112.4.2d. Examples of said light emitting assemblies 112.4.2a-112.4.2d that may be formed include those utilizing fiber optic cables, electroluminescent (EL) wire, laser diodes, neon tubes, cold cathode fluorescent lamps (CCFL), plasma tubes, phosphorescent strips, UV LED strips, infrared LED arrays, light guide panels (LGP), or edge-lit light panels. The light source or light emitter 112.4.2.2 may be made from a single emitter or a plurality of emitters (e.g., between 2 and 1000). Said light source or light emitter 112.4.2.2 may be driven by an internal or external driver within another aspect of the electronics assembly 108.

Each of the light emitters 112.4.2.2 is positioned in a void 112.4.2.10 of each respective light emitter housing 112.2 (i.e., positioned toward the display 108.4 from an outer perspective) and the diffuser lens 112.4.2.8 is positioned in front of the light emitter 112.4.2.2 to reside between a frontal extent of the light emitter 112.4.2.2 and an outermost edge of each respective light emitter housing 112.2 and/or an outermost edge surface 106.2 of the head 10.1 or frontal shield 102.4. In some embodiments, the diffuser lens 112.4.2.8 can be omitted from the assemblies 112.4.2a-112.4.2d. Each light emitter 112.4.2.2 is located forward of and adjacent to the forward facing edge 102.2.4.6.2 of the rear shell 102.2.4, and rearward of and adjacent to a portion of the rear perimeter edge 102.4.8 of the frontal shield 102.4 defining each recess 102.4.2. A rearmost edge of each light emitter 112.4.2.2 is located rearward of the entire rear perimeter edge 102.4.8 of the frontal shield 102.4. The voids 112.4.2.10 are located between the frontal shield 102.4 and the rear shell 102.2.4. In other embodiments, the light emitters 112.4.2.2 may not be formed in the voids 112.4.2.10; instead, said voids 112.4.2.10 may act as a reflector for light that is emitted from said light emitter or source 112.4.2.2. In other words, the light emitter 112.4.2.2 may be positioned in the first head sub-volume 236.

The recesses 102.4.2 positioned between the frontal shield 102.4 and the rear shell 102.2.4 define a gap, region, or channel 327. Light emitted from the illumination assembly 112 is configured to be visible in each said gap, region, or channel 327. In other words, the region or the gap 327 may be: (i) positioned adjacent to both the rear edge 102.4.8 of the frontal shield 102.4 and the forward facing edge 102.2.4.6.2 of the rear shell 102.2.4, and (ii) illuminated by light emitted from at least one of the light emitters 112.4.2.2. As shown in the Figures, the gaps 327 that are illuminated by the illumination assembly 112 at least span between the end walls 112.6.2, 112.6.4.

Aₙ extent of the head 10.1 is provided by peripheral projections associated with the light emitter housings 112.2. This extent is recessed relative to both: (i) a first location 333.2 on the outer surface 106.2 of the frontal shield 102.4 that is adjacent to the gap 327, and (ii) a second location 333.4 on the outer surface 106.4 of the rear shell 102.2.4 that is adjacent to the gap 327. The rear edge 102.4.8 of the frontal shield 102.4 does not abut the forward facing edge 102.2.4.6.2 of the rear shell 102.2.4 at a location corresponding to the gaps 327. In other words, an extent of the portion of the light emitter housing 112.2 may be recessed relative to the outer surfaces 106.2, 106.4 of the frontal shield 102.4 and rear shell 102.2.4. This positional relationship may cause an extent of the head 10.1 to be positioned: (i) between the frontal shield 102.4 and/or the rear shell 102.2.4, and (ii) at said location to connect the frontal shield 102.4 to the rear shell 102.2.4 indirectly via the intermediate cover 102.2.2 housing the light emitting assemblies 112.4.2a-112.4.2d. As such, the light emitting assemblies 112.4.2a-112.4.2d may have an arc or curvilinear configuration conforming to the head shape. Light emitted from the illumination assembly 112 (via assemblies 112.4.2a-112.4.2d) may obscure an extent of the head 10.1, and may specifically obscure an extent (e.g., an extent of the region 327) of the head 10.1 that has an outer surface 106 (of the diffuser lens 112.4.2.8 or housing 112.2) that is recessed relative to the outer surfaces 106.2, 106.4 of the frontal shield 102.4 and rear shell 102.2.4.

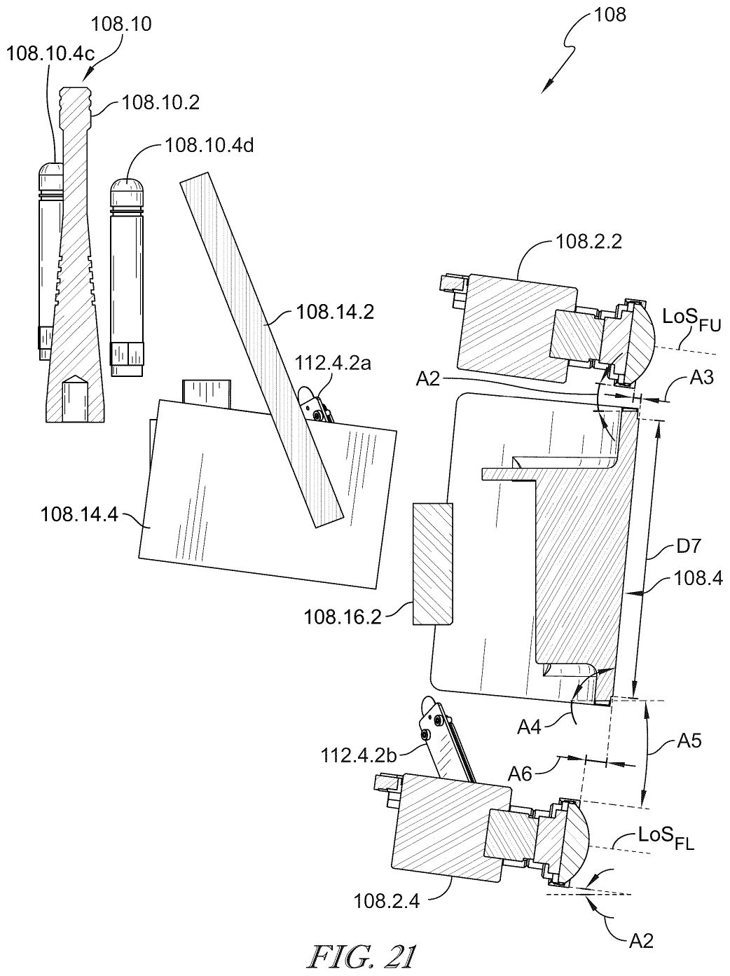

When viewing the head 10.1 from the front as shown in FIGS. 8 and 21, the light emitting assemblies 112.4.2a-112.4.2d (and their emitters 112.4.2.2) are spaced apart from the display 108.4 and the internal mounting frame 104.4. In some aspects, the light emitting assemblies 112.4.2a-112.4.2d do not reside behind or overlap with the display 108.4 or the internal mounting frame 104.4, although in some embodiments this may occur. The lower light emitting assemblies 112.4.2b, 112.4.2d may be positioned below the display 108.4 and the internal mounting frame 104.4. The upper light emitting assemblies 112.4.2a, 112.4.2c may flank the display 108.4 and the internal mounting frame 104.4 such that a horizontal plane (i.e., plane P_{H2} as shown in FIG. 8) extending through the upper light emitting assemblies 112.4.2a, 112.4.2c also passes through the display 108.4. The plane P_{H2} may also pass through the center C of the head 10.1, but the upper light emitting assemblies 112.4.2a, 112.4.2c may be slightly offset upward relative to the plane P_{H2}. In some cases, the upper light emitting assemblies 112.4.2a, 112.4.2c may be located below a top end of the display 108.4 so as to be positioned below any cameras or sensors mounted to the internal mounting frame 104.4 above the display 108.4.

### 1. Illumination Assemblies

As best shown in FIGS. 25-30, the head 10.1 includes an illumination assembly 112 that is a portion of the illumination assembly 1.2.10 of the robot 1. In the illustrative head 10.1, light emitter housings 112.2 are formed in the intermediate cover 102.2.2 and are configured to receive and couple with individual light emitting assemblies 112.4. Each of the light emitter housings 112.2 of the illumination assembly 112 has a generally trapezoidal shape when viewed from the side. Each of the diffuser lenses 112.4.2.8 has a corresponding shape and is configured to reside within a slot 112.6.12 formed in each respective light emitter housing 112.2 between the top wall 112.6.6 and the bottom wall 112.6.8. Each of the light emitting assemblies 112.4 includes a cover 112.4.2.6 coupled to the diffuser lens 112.4.2.8, a light source 112.4.2.2 oriented to face toward the cover 112.4.2.6 and the diffuser lens 112.4.2.8, and a back wall 112.4.2.4 coupled to the light source 112.4.2.2 and mounted with the light emitter housing 112.2. The cover 112.4.2.6 and the back wall 112.4.2.4 form a protective covering for the light source 112.4.2.2 to protect said light source 112.4.2.2 from debris and other foreign objects. The light source 112.4.2.2 is illustratively a light-emitting diode but can include any suitable light source such as an incandescent source, a fluorescent source, a halogen source, etc. The back wall 112.4.2.4 has a greater width than the cover 112.4.2.6 to project outwardly beyond the cover 112.4.2.6 and the light source 112.4.2.2 for attachment to the light emitting housing 112.2.

iii. Display

As best shown in FIGS. 18-22, the display 108.4 of the electronics assembly 108 may be mounted to the internal mounting frame 104.4 and positioned such that a screen opening 102.2.2.6.2 of the intermediate cover 102.2.2 surrounds the display 108.4. The display 108.4 is operatively connected to at least one processor and is designed to display status messages and other information. For example, the display 108.4 may display information: (i) related to the robot's state (e.g., working, error, moving, etc.), (ii) obtained from sensors contained within the head and neck assembly 10, including but not limited to cameras (e.g., cameras 108.2.2, 108.2.4), proximity sensors, temperature sensors, and accelerometers, or (iii) received from other processors in communication with the display 108.4 (e.g., other internal processors housed within the robot 1 or external information transmitted and received by the robot 1). Said information may be displayed in the format of blocks, well-known shapes, logos, or other moving items (e.g., thought bubbles). However, said information may not be displayed in connection with human facial features (e.g., eyes, mouth, nose).

In various embodiments, the display 108.4 may be a plurality of screens and the intermediate cover 102.2.2 may include additional screen openings. The frontal shield 102.4 is configured to cover and protect both the display 108.4 and the intermediate cover 102.2.2 and composed of translucent or transparent material for viewing of the display 108.4. The display 108.4 may have a substantially rectangular display surface that has a convex curvature that conforms with the curvature of intermediate cover 102.2.2 of the housing 102. The display 108.4 may be slightly tilted downward. For example, the display 108.4 may be tilted from a horizontal plane at an angle of about 5.7 to about 8.6 degrees, or about 6.4 to about 7.9 degrees. The tilted screen increases viewability and helps eliminate reflections. The screen may use any known technology or feature including, but not limited to: LCD, LED, OLED, LPD, IMOD, QDLED, mLED, AMOLED, SED, FED, plasma, electronic paper or EPD, MicroLED, quantum dot display, LED backlit LCD, WLCD, OLCD, transparent OLED, PMOLED, capacitive touchscreen, resistive touchscreen, monochrome, color, or any combination of the above, or any other known technology or screen feature.

It should be understood that this application contemplates the use of screens that have different sizes. Alternative screen sizes may be used to: (i) reduce the surface area of fragile elements within the robot 1, (ii) because said robot 1 is not designed to work near humans, (iii) additional area within the head 10.1 is needed for sensors or other electronics, or (iv) any other reason known by one of skill in the art. The disclosed screen may occupy the entire frontal shield 102.4, between 100% and 75% of the frontal shield, between 75% and 50% of the frontal shield, between 50% and 25% of the frontal shield, or less than 25% of the frontal shield. In some examples, the screen may utilize the full frontal shield 102.4. The screen may be curved in a single direction, in two directions (e.g., vertically and horizontally), or a freeform design that may include multiple curves. In certain embodiments, the frontal shield 102.4 and the display 108.4 may be integrated into a single unit.

The display 108.4 may also be configured to display alerts or warnings, such as low battery notifications, obstacle detection alerts, or maintenance reminders. The information displayed on the display 108.4 may be presented in various formats, including text-based messages, graphical icons, animations, and dynamic visual indicators. These visual indicators may take the form of color-coded blocks, well-known shapes, logos, or other moving items (e.g., thought bubbles, arrows indicating direction of movement, or animated progress bars). The display 108.4 may further support interactive features, allowing users to provide inputs via touch or proximity gestures, depending on the implementation. However, the information displayed on the display 108.4 may be restricted from showing human facial features (e.g., eyes, mouth, nose) to avoid any anthropomorphic representations that might be confusing or misleading to users. Instead, the display 108.4 is designed to convey functional and operational information in a clear and efficient manner that enhances user interaction without mimicking human expressions.

As shown in at least FIGS. 6-9, and 23 the display 108.4 may have a substantially rectangular display surface that has a convex curvature conforming to the curvature of the frontal shield 102.4 of the head housing assembly 102. The curvature of the display 108.4 provides an aesthetically pleasing integration with the overall design of the device and enhances the seamless appearance of the frontal surface. The display 108.4 may be slightly tilted downward to improve visibility and user interaction. For example, the display 108.4 may be tilted from a horizontal plane at an angle of about 5.7 degrees to about 8.6 degrees, or about 6.4 degrees to about 7.9 degrees. This tilt configuration improves ergonomic usability by aligning the display 108.4 with a typical user's line of sight, reducing the need for head or neck adjustment during prolonged use. The downward tilt also helps to mitigate unwanted glare and reflections from ambient light sources, thereby enhancing the clarity and readability of the display content under various lighting conditions. As best shown in FIG. 10B, a gap (G) is formed between the outer surface of the display 108.4 and the inner surface of the frontal shield 102.4. The display 108.4 also has a first or left substantially vertical edge 108.4.2 and a second or right substantially vertical edge 108.4.4 when the head 10.1 is in the forward facing orientation Orr, and wherein said display 108.4 also includes a display width W_{D} that extends between the first or left substantially vertical edge 108.4.2 and the second or right substantially vertical edge 108.4.4. The display width W_{D} is greater than the first width W₁ or lower frontal shell width, but is less than the frontal shell centroid width W₂ and the upper frontal shell width W₃. The display 108.4 also includes an upper edge 108.4.6 and a lower edge 108.4.8, wherein the display 108.4 has a constant: (i) height H between the upper edge 108.4.6 and the lower edge 108.4.8 across the display width W_{D}, and (ii) a constant arc length between the upper edge 108.4.6 and the lower edge 108.4.8.

The display 108.4 may incorporate any known technology or feature to achieve optimal performance and energy efficiency, including but not limited to: liquid crystal display (LCD), light-emitting diode (LED), organic light-emitting diode (OLED), laser phosphor display (LPD), interferometric modulator display (IMOD), quantum dot light-emitting diode (QDLED), micro-light-emitting diode (mLED), active-matrix organic light-emitting diode (AMOLED), surface-conduction electron-emitter display (SED), field emission display (FED), plasma display, electronic paper or electrophoretic display (EPD), MicroLED, quantum dot display, LED-backlit liquid crystal display (LCD), white liquid crystal display (WLCD), organic liquid crystal display (OLCD), transparent OLED, passive-matrix OLED (PMOLED), capacitive touch display, resistive touch display, e-ink display, other bistable display technologies, monochrome displays, color displays, or any combination thereof. The display 108.4 may also include advanced features such as high dynamic range (HDR), anti-reflective coatings, wide color gamut (WCG), variable refresh rates, adaptive brightness control, and touch sensitivity enhancements. The selection of display technology can be tailored to specific use cases, such as low-power consumption for battery-operated devices or high-resolution imaging for applications requiring detailed visual output. Furthermore, the display 108.4 may support additional functionalities, such as multi-touch input, gesture recognition, and/or haptic feedback. The display 108.4 may be configured to operate in different modes, including a low-power mode for extended battery life or a high-brightness mode for outdoor visibility.

In addition, the display 108.4 may be segmented into multiple independently controllable zones. This would allow for selective activation of display areas, potentially conserving power or enabling more complex information presentation strategies. For example, only the relevant portions of the display 108.4 could be activated based on the robot's current task or status. Further, the display 108.4 could utilize adaptive brightness and contrast adjustment based on ambient lighting conditions, ensuring optimal visibility across a wide range of environments. This feature could be particularly useful for robots operating in variable lighting conditions. Additionally or alternatively, the display 108.4 may incorporate augmented reality (AR) elements, overlaying digital information onto the real-world view seen through transparent portions of the display 108.4. This could enhance the robot's ability to provide context-aware information or instructions. The display 108.4 disclosed herein meets the standards described in FDA CFR Title 21 part 1040.10, titled Performance standards for Light-Emitting Products, and ANSI LIA Z136.1, titled Safe Use of Lasers, at the time of filing this application, both of which are incorporated herein by reference. In other embodiments, the humanoid robot 1 may include a projection system in addition to, or instead of, the integrated display. This could allow for displaying information on nearby surfaces or creating holographic-like interfaces in the space in front of the humanoid robot 1.

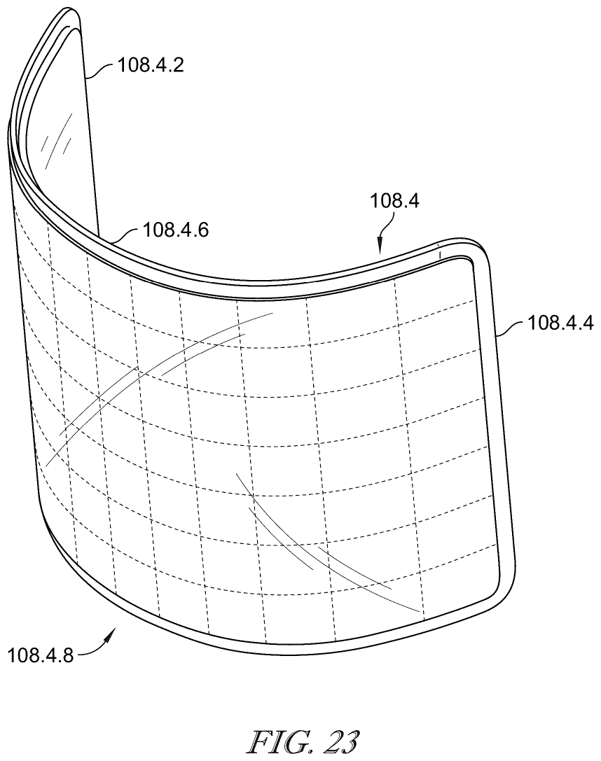

It should be understood that this application contemplates the use of at least one display 108.4 and potentially a plurality of displays (e.g., between 2 and 5). Additionally, this Application also contemplates utilizing displays that have different sizes. To this end, the display 108.4 may extend between any of the lines shown in FIG. 23. For example, the display 108.4 may extend between the third line from the bottom to the third line from the top as notionally indicated in FIG. 23. Additionally, each of the lines on the display 108.4 in FIG. 23 can represent different zones included in the display 108.4 and used to convey different images or other visual representations across said display 108.4. As an example, sides of the display 108.4 can be used to display a different image or visual representation compared to a front of the display 108.4. Alternative display sizes may be used to: (i) reduce the surface area of fragile elements within the humanoid robot 1, (ii) because the humanoid robot 1 is not designed to work near humans, (iii) additional area within the head 10.1 is needed for sensors or other electronics, or (iv) for any other reason known by one of skill in the art. The disclosed display 108.4 may be embedded in or occupy the entire frontal shield 102.4, between 100% and 75% of the frontal shield 102.4, between 75% and 50% of the frontal shield 102.4, between 50% and 25% of the frontal shield 102.4, or less than 25% of the frontal shield 102.4. In some examples, the display 108.4 may utilize the full frontal shield 102.4.

As illustrated in FIGS. 10A-10C, 14, and 19, the display 108.4 is designed to curve along the contours of the humanoid robot's facial structure, aligning with various regions of the face to provide a seamless visual interface. Specifically, the display 108.4 conforms to and presents information through all or portions of key or important facial regions, including the orbital region 368, which surrounds the eyes, the frontal region 362 (encompassing the forehead area), the temporal region 350 (located near the temples), the zygomatic region 358 (corresponding to the cheekbones), the nasal region 357 (covering the nose area), the infraorbital region 363 beneath the eyes, the buccal region 352 (associated with the checks), and the oral region 366 (surrounding the mouth area). This curvature enhances the robot's ability to display expressive content or important visual cues directly on its face, potentially improving user interaction and engagement. Conversely, in the depicted embodiment, the display 108.4 does not extend to any regions located rearward of the coupling interface 102.2.2.8. These excluded regions include the mental region 355 (corresponding to the chin), the auricular region 356 (encompassing the cars), the crown region 370 (at the top of the head), the parietal region 360 (located on the sides and upper back of the head), the occipital region 359 (at the lower back of the head), and the mastoid region 364 (behind the cars). By limiting the display 108.4 to the frontal facial areas, the design ensures that visual outputs remain within the primary field of view of human observers, optimizing the robot's communicative abilities. In some embodiments, the display 108.4 may be configured to present information, indications, or dynamic visual representations across a broader surface area. For example, the display 108.4 may cover: (i) the entire frontal shield 102.4 of the robot's head 10.1, providing a comprehensive visual interface; (ii) a majority of the frontal shield 102.4, focusing on the most expressive regions; (iii) the entire facial region 347, ensuring full-face display coverage; or (iv) a majority of the facial region 347, balancing display utility with structural design considerations. Alternatively, in certain embodiments, the display 108.4 may be entirely omitted from the facial region 347 or repositioned to other parts of the robot's body. For instance, the display 108.4 could be integrated into the robot's torso 16 or another suitable location, depending on the specific application requirements or design preferences. This flexibility in display placement allows for customization based on the intended use case, whether it be for humanoid interaction, information dissemination, or other functionalities. It should be understood that the illumination assembly 112 is distinct from the display 108.4, wherein the illumination assembly 112 is configured to illuminate a region on the side of the head 10.1 at a location between the frontal shield 102.4 and the rear shell 102.2.4. Additionally, the illuminated region may be visible from a position away from the humanoid robot 1 where at least a portion of the display 108.4 is not visible.

### 1. Alert Notification

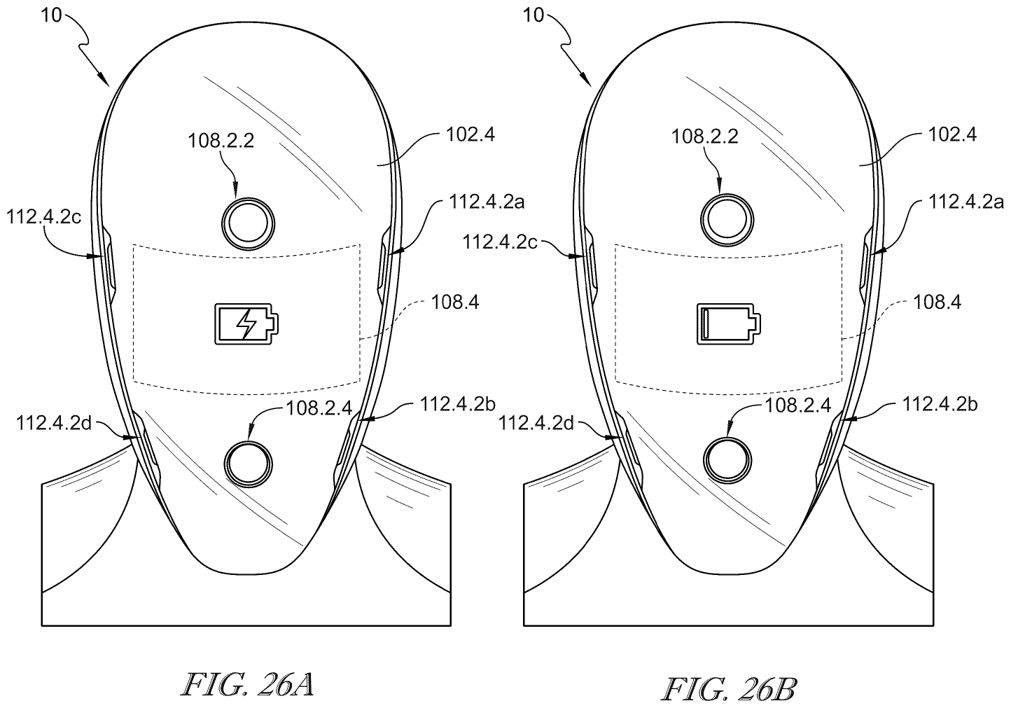

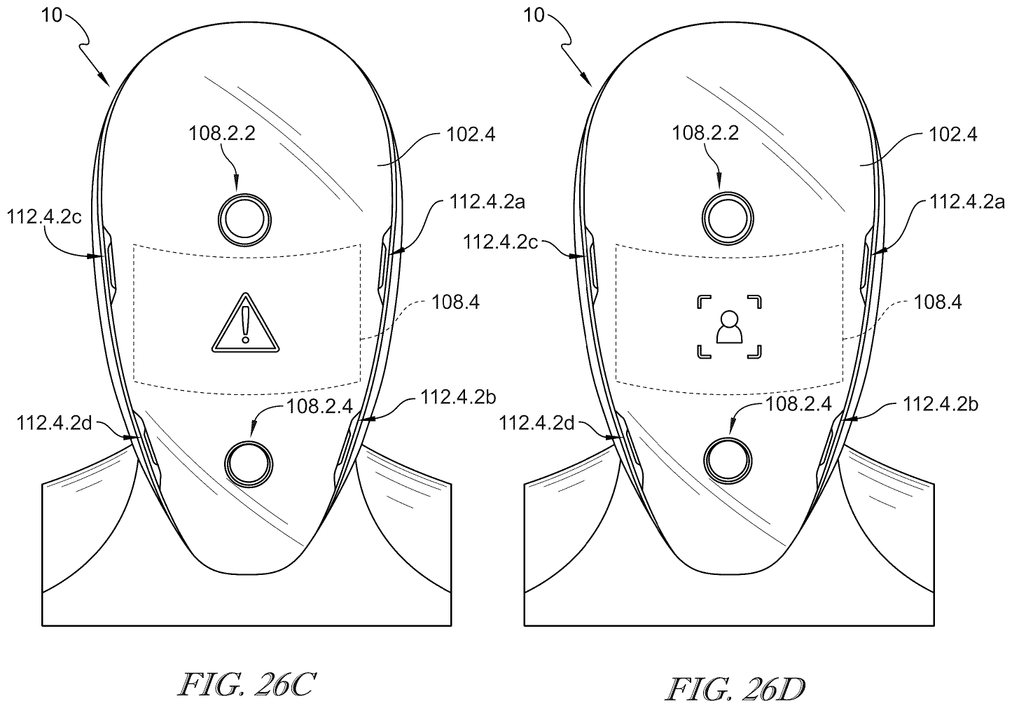

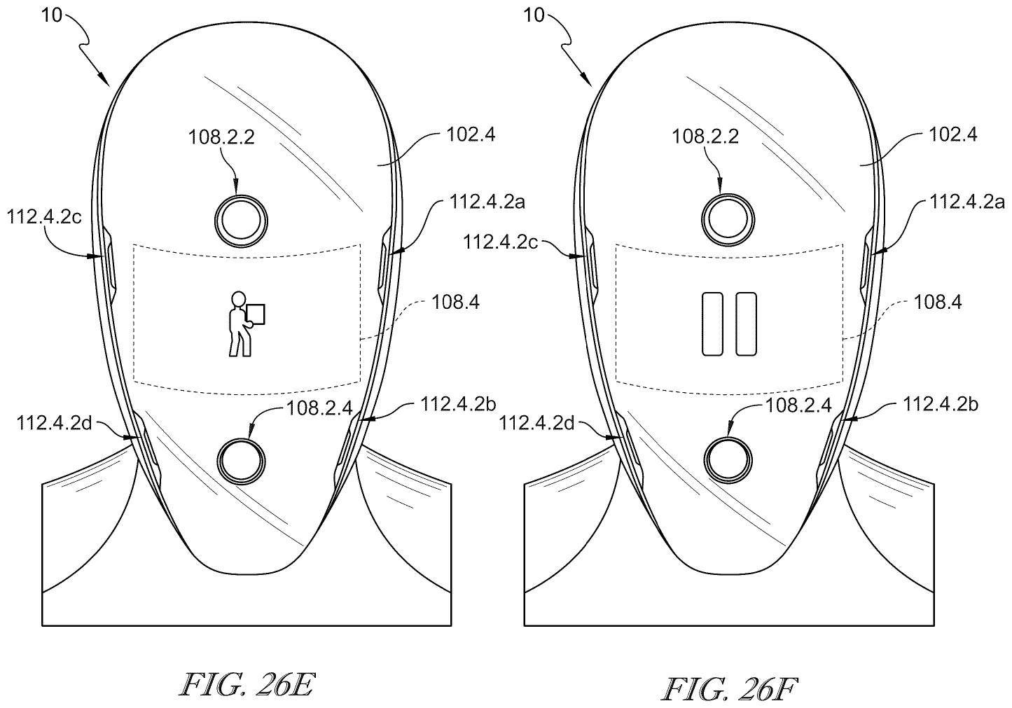

When required (for an environment), the robot 1 shall be provided with warning devices in accordance with IEC 60073. A warning device could deliver an alert notification that is audible, visual, tactile, or some combination thereof to facilitate the exchange of safety-related information in compliance with IEC 61508-2:2010. Safety-related information can include: information regarding the state of the robot 1; identification and location of detected objects and individuals; raw sensor feedback from onboard sensitive protective equipment; and changes to the position and/or trajectory of the robot 1 as a function of obstacle avoidance or collision avoidance. In various embodiments, the robot 1 may be configured to render one or more images in its display 108.4 to indicate a corresponding status message. For example, prior to mode change or movement, the robot 1 shall indicate that mode change or movement is intended under automatic control (FIG. 26E). In other embodiments, the visual alert notification may be combined with other modes of notification. In some embodiments, the alert notification may be transmitted to another device or system to expedite a response.

FIGS. 26A-26F show various statuses and corresponding indications or visual representations that are contemplated by this disclosure. It should be noted that the present disclosure is not limited to these statuses and corresponding indications or visual representations, and that these are merely examples that can be displayed by the display 108.4. Information displayed by display 108.4 may include device status (e.g., camera status and robot start-up status), robot part status (e.g., a specified joint status), and a battery level status. The various statuses disclosed herein can update as the status changes. For example, during start-up of a camera, the display 108.4 may display text, an icon, or another visual representation indicating that the camera is initializing and is not ready for use. The status can change to display an icon, or another visual representation indicating that the camera is active when start-up is complete.

For example, FIGS. 26A-26B illustrate an example of visual alert including an icon indicating a battery status. The icon is generally in the shape of a battery. The icon further includes a lightning bolt to indicate that the battery is charging (FIG. 26A). The icon(s) can be displayed in a first color (e.g. green) while the battery is charging and/or after the battery is fully charged. For example, FIG. 26B shows another icon is generally in the shape of a battery and includes a level marker to indicate battery charge level. In this example, the level marker is a thin line to one side of the battery icon to indicate that the battery charge is low and should be recharged. The level marker can move or increase in size to indicate the current battery charge level at any time.

FIG. 26C shows another icon indicating an alert or system failure event. The icon includes a triangle with an exclamation mark within it to indicate the alert or system failure event.

Such an icon may be displayed when a part of the humanoid robot 1 has failed, such as an actuator, a camera, or another device included in the humanoid robot 1. Identifying information in the form of text or another icon can also be displayed with the alert or failure icon to specify which part of the robot 1 has failed or needs attention.

FIG. 26D shows an icon indicating a particular mode of the robot 1. Illustratively, mode depicted indicates a follow mode in which the robot 1 is engaged in following a user, another device, or another robot. The icon includes a generally human shaped icon with a border around the generally human shaped icon. Other icons corresponding to additional modes of operation of the robot 1 can also be displayed.

FIG. 26E shows an icon indicating a particular task being performed by the robot 1. Illustratively, the task icon depicted is a generally human shaped icon lifting and carrying a box or another item. Other icons corresponding to additional tasks that can be completed by the robot 1 can also be displayed. For example, prior to mode change or movement, the robot 1 may indicate that mode change or movement is intended under automatic control.

FIG. 26F shows a robot status icon. Illustratively, the status icon depicted is a pause icon. The pause icon can be displayed when the humanoid robot 1 is currently not completing any tasks or modes and is ready for instructions. Other icons corresponding to additional robot statuses that can be completed by the humanoid robot 1 can also be displayed.

Further, the robot 1 may display or provide access to one or more identifiers regarding information and instructions necessary to ensure safe and correct use of the robot 1. The information additionally includes warnings to the user about any residual risks and identifies the locations of the energy-isolating devices. The information may be provided in one or more of the following manners: a physical identifier coupled to an external cover and/or housing component, a digital identifier displayed on a screen coupled to a housing component of the robot 1, and/or an audio identifier provided via a speaker contained within the robot 1. In various embodiments, the covers and/or head 10.1 contains a visual identifier, such as a physical identifier, a tag, a nameplate, or a display, regarding the individual robot 1. In some embodiments, the identifier may be displayed on a screen, for example, display 108.4 or a screen located at the side of the head 10.1.

For example, as shown in FIGS. 26A-26B, an identifier may be physically coupled to the robot 1 at the head 10.1 or displayed in display 108.4. The identifier may include information such as, robot model, serial number, gross weight, maximum speed, maximum grade capability at rated load, manufacturer identity and/or information, the year of construction, identification of battery type, minimum and maximum weight and dimensions of battery(s), rated ampere-hour capacity, and nominal voltage. In some embodiments, the identifiers may be provided by the robot 1 as an audio message, for example, a message delivered via a speaker contained within the robot 1, or as a combination of audio and visual identifiers. In some embodiments, the preferred language may be selected for audio messages or messages that appear in the display 108.4.

iv. Other Electronic Components

Referring to FIGS. 12-15, the electronics assembly 108 of the head 10.1 may also include a microphone 108.6, speaker 108.8, antennas 108.10, as well as a data storage device and/or computing device comprising a processor and memory. Specifically, the microphone 108.6 may be one or more microphones. For example, the microphone 108.6 may be a directional microphone designed to detect sounds and determine a position, which enables the robot 1 to move its head 10.1 toward the sound. In some embodiments, one or more microphones 108.6 may be located in the neck 10.2. Further, one or more speakers 108.8 may be configured to allow the robot 1 to communicate with nearby humans with audible messages or responses. As shown in FIGS. 14-15, the speaker 108.8 can be located in the neck 10.2, shown coupled to actuator coupler 104.2 between the head actuators (J8.1, J8.2). In other embodiments, one or more speakers 108.8 may be located in a different position or coupled in a different manner. In various embodiments, the microphone 108.6 and the speaker 108.8 may be operatively coupled to an audio board 108.14.4 configured to at least process the audio signal received via the microphone 108.6 and/or process the audio signal to be output via the speaker 108.8.

One or more antennas 108.10 may be configured to transmit and receive data wirelessly for data transfer into and out of the robot 1. Specifically, said robot 1 may include wireless communication modules (e.g., cellular, Wi-Fi, Bluetooth, WiMAX, HomeRF, Z-Wave, Zigbee, THREAD, RFID, NFC, and/or etc.) that are connected to said antennas 108.10. For example, said robot head 10.1 may include a 5G cellular radio coupled to one or more of the 5G antennas 108.10.4 (individually 108.10.4a-108.10.4d, collectively 108.10.4) and a Wi-Fi radio (e.g., 5 GHz or 2.4 GHz) coupled to the other antenna 108.10.2. For example, as shown in FIGS. 17-21, the antennas 108.10 can include a Wi-Fi antenna 108.10.2 and four 5G antennas 108.10.4a-108.10.4d to maximize bandwidth and help ensure connectivity. For example, the individual 5G antennas 108.10.4a-108.10.4d may be tuned for different bandwidths. In some embodiments, to save space within the head housing assembly 102, the 5G cellular radios can be positioned in the torso 16 and wired via the neck 10.2 to the antennas 108.10 within the head 10.1.

v. Computing Device

Referring to FIGS. 12-15, the computing architecture 1100 of the robot 1 may include one or more computing devices 108.14 positioned in the head 10.1. For example, the computing device 108.14 may include one or more processors, controllers, or PCB's operatively coupled to various components of the electronics assembly 108. The computing device 108.14 may be coupled to a data store 2900 in the head 10.1 or elsewhere in the robot 1 (e.g., torso 16). For example, the computing device 108.14 may include a main processor 108.14.2 coupled to various sensors 1.2.8, at least one communication interface 1.2.12, and compute 1000 for the robot 1. In other embodiments, the individual electronic components (e.g., cameras 108.2.2, 108.2.4, display 108.4, speaker 108.8, illumination assembly 112) positioned in the head and neck assembly 10 may be coupled to computing architecture 1100 located elsewhere in the robot 1 (e.g., torso 16). In the illustrative embodiment, the computing device 108.14 may include an audio board 108.14.4, a radio board 108.14.6, and/or a screen board 108.14.8.

In some embodiments, the head 10.1 may include a data storage device. The data storage device may include a solid-state hard drive designed to capture all of the data generated by the sensors or a subset of the data generated by the sensors. Said subset of the data may be time-based (e.g., the pre-defined time surrounding the start up/shut down of the robot 1), sensor-based (e.g., only encoder data), movement/configuration-based (e.g., when performing a specific task that requires the robot 1 to put its body in a particular position/configuration), environment-based (e.g., when the robot 1 recognizes a specific item or issue in its environment), or configuration based, error based, or a combination thereof. In addition, the data storage device may be used to store data to train other robots or store data for diagnostic purposes or any other purpose. Finally, the indicator lights or individual light emitting assemblies 112.4 of the illumination assembly 112 may be designed to work with the display 108.4 to indicate a state of the robot 1 (e.g., working, error, moving, etc.) to a nearby human or may illuminate for other reasons.

e. Head Actuators

Referring to FIGS. 12-15, the head and neck assembly 10 includes a head actuator assembly 118 including (i) a head twist actuator (J8.1) 120 and (ii) a head nod actuator (J8.2) 140. In the illustrative embodiment, the head actuators (J8.1, J8.2) may be coupled to each other by the actuator coupler 104.2 of the internal support assembly 104. As such, the internal mounting frame 104.4 of the head 10.1 is coupled to the torso 16 of the robot 1 via head actuator assembly 118 to provide 2 DoF of the head 10.1. In other embodiments, additional or alternative structures may be used to couple the head twist actuator (J8.1) 120 and the head nod actuator (J8.2) 140 in an alternative arrangement. In various embodiments, the speaker 108.8 or other components of the electronics assembly 108 may also be mounted on actuator coupler 104.2.

The actuator coupler 104.2 provides structural support within the neck 10.2 for connecting the head 10.1 to the torso 16. The actuator coupler 104.2 is configured to couple the head twist actuator (J8.1) 120 and the head nod actuator (J8.2) 140 in an orientation such that the axes A8.1, A8.2 of said head actuators are perpendicular to each other to provide the head 10.1 with two degrees of freedom.

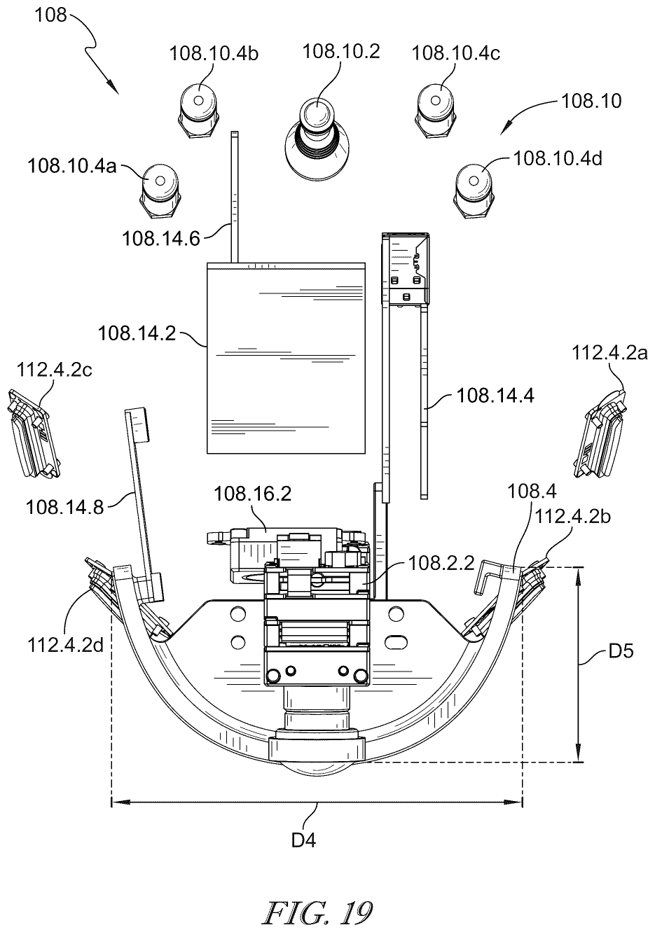

The head twist actuator (J8.1) 120 is configured to twist or rotate the head 10.1 with respect to the torso 16 (e.g. “no” head movement) and the head nod actuator (J8.2) 140 moves to adjust the pitch of the head 10.1 (e.g. “yes” head movement). Arranging the head actuators (J8.1, J8.2) vertically, such that the axes (A8.1, A8.2) are perpendicular to each other allows for the aforementioned “no” and “yes” movements. In some embodiments, the head twist actuator (J8.1) 120 may be positioned above the head nod actuator (J8.2) 140, as shown in FIG. 3B. In some embodiments, the head nod actuator (J8.2) 140 may be positioned above the head twist actuator (J8.1) 120, as shown in FIG. 19. Together, the head actuators (J8.1, J8.2) are configured to provide coordinated movement to position the head 10.1. The head actuator assembly 118 is configured to move the head 10.1 to at least position a sensor or a display 108.4 of the electronics assembly 108 for the robot 1 to perform a particular task or interact with a human or other robot. For example, the head twist actuator (J8.1) 120 and/or the head nod actuator (J8.2) 140 may be used to direct the field of view of one or more cameras contained within the head 10.1 or direct a display 108.4 to face a nearby human to provide information. The actuators (J8.1, J8.2) can be configured to be the same size, with the same torque output, and coupled to cooperate with each other for movement of the head 10.1.

In the illustrative embodiment of FIGS. 14-15, the head twist actuator (J8.1) 120 may be configured to be at least partially housed in the torso 16, where the structural coupling to the torso 16 may provide base support for the head and neck assembly 10. The actuator coupler 104.2 is also configured to provide a vertical extension (neck structure) from the torso 16 and support for the head assembly 10. The actuator coupler 104.2 couples the head nod actuator (J8.2) 140 to the head twist actuator (J8.1) 120. The internal mounting frame 104.4 is coupled directly to the housing of head nod actuator (J8.2) 140. As head twist actuator (J8.1) 120 rotates, head nod actuator (J8.2) 140 also rotates, causing movement of the internal mounting frame 104.4 and entire head 10.1. As the head nod actuator (J8.2) 140 rotates, the internal mounting frame 104.4 changes pitch, changing the pitch of the entire head 10.1. The actuator coupler 104.2 is configured to receive and position the head actuators (J8.1, J8.2). A coupling assembly 104.2.2 is configured to couple with an output adapter 128 of the head twist actuator (J8.1) 120. Aₙ extender 104.2.4 is configured to receive the head nod actuator (J8.2) 140 into an actuator receiving assembly 104.2.6 in a position rotated lengthwise in relation to head twist actuator (J8.1) 120 such that the rotational axes of the head actuators (J8.1, J8.2) are substantially perpendicular.

In another embodiment, the head twist actuator (J8.1) 120 may be contained within the head 10.1 and coupled to the head nod actuator (J8.2) 140 positioned within the neck 10.2, as indicated in FIG. 3B. For example, an alternative structure may be used to couple the head actuators (J8.1, J8.2) and/or one or more components of the electronics assembly 108 may be arranged in a different manner within the head and neck assembly 10.

f. Distances, Angles, and Arcs

The following tables include non-limiting examples of distances, angles, and arcs. Additionally, while the entire figure set is not to scale, it should be understood that the components contained in within each Figures are generally to scale and as such comparison, ratios, and/or other information can be derived from the Figures and even supplemented by the information contained in the below tables.

TABLE 1

| Distance | Lower | Upper | Preferred | Preferred |
|---|---|---|---|---|
| (mm) | Bound | Bound | Lower Bound | Upper Bound |
| D1 | 61.2 | 91.8 | 68.9 | 84.2 |
| D2 | 14.1 | 21.2 | 15.9 | 19.4 |
| D3 | 58.4 | 87.6 | 65.7 | 80.3 |
| D4 | 74.3 | 111.5 | 83.6 | 102.2 |
| D5 | 35.2 | 52.8 | 39.6 | 48.4 |
| D6 | 100.2 | 150.3 | 112.7 | 137.8 |
| D7 | 56.0 | 84.0 | 63.0 | 77.0 |
| D8 | 76.1 | 114.2 | 85.6 | 104.7 |
| D9 | 80.6 | 120.9 | 90.7 | 110.9 |
| D10 | 34.2 | 51.2 | 38.4 | 47.0 |
| D11 | 61.7 | 92.6 | 69.4 | 84.8 |
| D12 | 80.5 | 120.8 | 90.6 | 110.7 |

TABLE 2

| Angle | Lower | Upper | Preferred | Preferred |
|---|---|---|---|---|
| (Degrees) | Bound | Bound | Lower Bound | Upper Bound |
| A1 | 127.3 | 191.0 | 143.2 | 175.1 |
| A2 | 6.0 | 9.0 | 6.7 | 8.2 |
| A3 | 1.7 | 2.5 | 1.9 | 2.3 |
| A4 | 76.3 | 114.5 | 85.9 | 104.9 |
| A5 | 6.0 | 9.0 | 6.7 | 8.2 |
| A6 | 1.7 | 2.5 | 1.9 | 2.3 |
| A7 | 15 | 50 | 20 | 40 |
| A7′ | 90 | 140 | 110 | 130 |
| A8 | 5.7 | 8.6 | 6.4 | 7.9 |

TABLE 3

| Arc | Lower | Upper | Preferred | Preferred |
|---|---|---|---|---|
| (Degrees) | Bound | Bound | Lower Bound | Upper Bound |
| Arc2 | 115.1 | 172.6 | 129.5 | 158.2 |

### 2. Torso

The torso assembly 16 is a central component within the humanoid robot 1, extending vertically between the waist 74 and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional FIGS. herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16) that are housed within various components of the robot 1 to actuate movement of said components. Aₙ additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 are not individually included in the below table

TABLE 4

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, | A₄ |
| | | | lower humerus | |
| (J5) 468 | 2 | lower arm twist | lower arm x, lower arm roll | A₅ |
| (J6) 484 | 2 | wrist flex | wrist/hand y, wrist/hand pitch, | A₆ |
| | | | flick | |
| (J7) 520 | 2 | wrist pivot | wrist/hand z, wrist/hand yaw, | A₇ |
| | | | wave | |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward | A₁₁ |
| | | | kick | |
| (J12) 768 | 2 | hip roll | hip x, hip/leg roll, sideways | A₁₂ |
| | | | kick | |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first | A₁₅ |
| | | | ankle | |
| (J16) 900 | 2 | foot roll | talus, foot roll, foot x, second | A₁₆ |
| | | | ankle | |

It should be understood that in other embodiments, some of these systems, assemblies, components, and/or parts may be omitted, combined, or replaced with alternative systems, assemblies, components, and/or parts.

A substantial majority of the actuators 1.2.4 (e.g., about thirty of the forty-two actuators or about 66.7% of the actuators) in the illustrative embodiment robot 1 are not connected to a drive linkage; instead, they directly drive the associated part of the robot 1. Conversely, in the illustrative embodiment robot 1, fourteen of the forty-two actuators 1.2.4, or about 33.3% (but more than 10%, and preferably more than 25%), of the rotary actuators are coupled to a drive linkage. Drive linkages are coupled to an aggregate total of twelve rotary actuators contained within both hands 56. These drive linkages allow: (i) the fingers and thumb to be under-actuated, meaning they retain the ability to flex, curl, or rotate around an object while eliminating the need for an actuator to control each joint or degree of freedom, and (ii) the foot 92 to pivot around an axis that is located well forward (e.g., more than 10% of the overall length of the foot) of the center of the drive linkage.

The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

ii. External Cover Assembly

The illustrative embodiment robot 1 includes various components (e.g., assemblies) with housings 1.2.2 (e.g., to form an exoskeleton) that are designed to protect the operational systems of the robot 1, such as actuators 1.2.4 and electronics assembly 1.2.6, provide structural support, and give form to the robot 1. Said housings 1.2.2 can be comprised of hard or rigid casings that may include internal mounting features designed to support systems in specific locations, structural features engineered to withstand operational loads, and internal and/or external features that allow for interoperation between adjacent components and/or are formed to resemble human features. Some housings 1.2.2 additionally include one or more detachable shells that may overlay a casing to allow access to internal assemblies or to complete the form of the component.

The requirements of the housings 1.2.2 can vary in shape and form based on the individual structural or material requirements for each specific component. While it may be desirable to utilize a particular material for all housings 1.2.2 to create a consistent exterior appearance, fabrication may be complicated by specific structural or operational needs at different locations. It may not be necessary to utilize the same materials in different housings 1.2.2 that experience different load requirements. Various materials may be preferred for a specific housing 1.2.2 based on properties such as strength, toughness, elasticity, weight, and conductivity. Similarly, the complexity of some housing 1.2.2 designs may be better suited for one type of manufacturing process, such as machining, die casting, injection molding, or composite fabrication, over another. Because there is a desire or need to use different materials within different regions and/or use materials that do not have a consistent exterior appearance, the illustrative embodiment robot 1 includes exterior coverings of the exterior covering assembly 1.2.16 that are designed to at least partially hide the housings 1.2.2 under a textile exterior layer that can be easily swapped if damaged, serve to protect internal components from dust and debris, are designed to fit the form of the robot 1 without substantial wrinkling, and/or allow for venting or address thermal considerations at specified locations.

The exterior coverings may have a multi-layered assembly, which may include: (i) an energy-absorbing material that is coupled to the coupling layer, (ii) a coupling layer (e.g., plastic or polymer based), wherein the coupling layer facilitates attachment to, or attachment at, a housing 1.2.2, and/or (iii) an exterior coverings material (e.g., a textile). Alternatively, the multi-layered assembly may omit the coupling layer, the energy-absorbing material, and/or exterior covering material. In each case, the movement of the nearby joint may cause one housing 1.2.2 to impact or crush the energy absorbing layer instead of another housing 1.2.2, thereby mitigating or eliminating structural stress or load on either housing 1.2.2 and/or the respective actuator 1.2.4. Additionally, the energy attenuation members help to reduce pinch points, and/or allow for a more human-like appearance.

### 1. Energy Attenuation Assembly

The energy attenuation assembly may be composed of a plurality of integrated or removable members, such as pads, panels, or bumpers, that are attached to housings 1.2.2 of the robot 1 and/or are positioned within the external covers. The housings 1.2.2 and/or the energy attenuation members may include attachment features that are configured to receive these energy attenuation members. In some embodiments, they are attached directly to a particular exterior side of a housing 1.2.2, while in other embodiments, they may surround an exterior of a housing 1.2.2 or be attached to or retained by the exterior coverings as described above.

The disclosed robot 1 includes a torso energy attenuation member, elbow energy attenuation members, and leg energy attenuation members. Additionally, energy attenuation members may be included at the hip, shin, and/or foot. Some or all energy attenuation members may also be omitted. Energy attenuation members can be configured to enhance or alter the shape of the robot 1 without adding substantial weight and to provide a deformable structure with energy absorption properties to protect underlying components.

The energy attenuation members can be made from a wide variety of materials, including: (i) polymers, such as polyethylene foam (PE Foam), ethylene vinyl acetate (EVA) foam, polyurethane foam (including Memory Foam and Open-cell Polyurethane Foam); (ii) rubber foams; (iii) natural foams; (iv) engineered foams; (v) composite and hybrid materials; (vi) expanded polystyrene (EPS); (vii) expanded polypropylene (EPP); (viii) Koroyd®; (ix) D3O®; (x) Poron® XRD; (xi) thermoplastic elastomers (TPE) or thermoplastic polyurethane (TPU); (xii) any other material known to one of skill in the art that accomplishes the desired energy absorption characteristics; (xiii) any combination of the above. Furthermore, the energy-absorbing material may alternatively or additionally include other structures of said materials, wherein said structures may include lattices and/or repeating units, such as a cube, sphere, cylinder, cone, pyramid, torus, prism, tetrahedron, dodecahedron, octahedron, icosahedron, ellipsoid, paraboloid, cuboid, or hexahedron. It should be understood that the repeating unit or lattice cell may be contained in a specific region or may propagate throughout the entire energy attenuation member. Additionally, the energy attenuation members and/or the assembly may have varying properties, such as thickness, density, C/D ratio, and stiffness. This variation may be arranged in a gradient manner, wherein the energy-absorbing materials transition from softer to firmer layers or regions to provide progressive energy dissipation. The energy-absorbing material can be made from or include:

### 2. Exterior Coverings

The exterior coverings, which can include a neck cover, a torso cover, an upper leg cover, a shin cover, a foot cover, a lower arm cover, and a hand cover, are designed not to interfere with the robot's range of motion, to allow access to underlying components, to potentially add indicators to the external surface, and to improve the robot's overall aesthetic appearance. As shown in the figures, a single exterior covering does not extend over all actuators in the robot 1, and typically does not cover more than five actuators at a time. In other words, the exterior covering does not resemble an oversized jumpsuit with a closure running from, e.g., the robot's pelvis to its head region, nor does it include a hood that extends around a substantial portion of the robot's head. Instead, the exterior covering is strategically and tightly fitted in certain regions and may include different inserts (e.g., a different textile) that are positioned between the moving aspects of joints.

Exterior coverings materials of the exterior covering assembly 1.2.16 can be made from one or more textiles and can be customized or selected to reduce wrinkling and to allow for the twisting or movement of the underlying components without restriction or substantial distortion. For example, the exterior coverings materials may be designed to allow the lower arm to twist and rotate from about −120 degrees to about 180 degrees. Additionally, the exterior coverings materials may be selected to allow for the cooling of components, the viewing of indicator lights, or the operation of buttons through said exterior coverings. This provides a substantial benefit over conventional systems that lack these advanced features. It should be understood that this disclosure contemplates using or including exterior coverings materials that: (i) integrate lights from the robot 1 into said exterior covering, and specifically into a textile itself, (ii) may be translucent or temporarily translucent (e.g., based on time or environment), and/or (iii) can be formed (e.g., woven) in a manner that allows light to be transmitted through the textile.

As such, various types of lights (e.g., fiber optic lighting, led strip lights, led rope lights, micro-led string lights, led neon flex, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials, electroluminescent paint, laser-illuminated fiber bunches, phosphor-coated electroluminescent (PCEL) materials, smart RGB led strips, light-up silicone tubing (LED or EL-based), laser wire, or other electroluminescent materials such as EL wire, EL tape, or EL film) that are coupled to the humanoid robot 1 may be visible through the exterior coverings material. The exterior coverings material can include reflective yarn or night-luminous yarn that changes its appearance when light is shining on its surface. In other embodiments, a shiny, reflective, iridescent, matte, or textured polyurethane film can be applied to the surface of the exterior coverings material (e.g., a textile) in certain areas to provide an additional reflective effect or for another purpose, such as displaying a logo, pattern, or labels.

The exterior coverings material can also include features to accommodate the thermal considerations of the robot 1. In various examples, the exterior coverings material can be a custom textile that utilize different weaves in different locations to allow for ventilation in specific areas. Additionally, the exterior coverings material can include textiles or threads that are heat-sensitive and change color with a change in temperature. In summary, the exterior coverings may additionally be made from, include, or specifically omit any one or any combination of the following material types: durable materials, flame-resistant materials, waterproof materials, hazard materials, chemical-resistant materials.

Alternatively or additionally, the exterior covering assembly 1.2.16 may include features such as closures (e.g., a zipper that runs a partial or full length of the exterior covering assembly 1.2.16), attachment points, couplers, self-cleaning nanocoatings, thermoelectric materials, photochromic dyes, or electromagnetic shielding layers, as well as modular, quick-release panels or e-textile technology with conductive fibers woven throughout to create a distributed sensor network that is capable of detecting impacts, monitoring joint angles, or even harvesting energy from movement. The exterior covering assembly 1.2.16 may be designed to include inserts (which may also be textiles or may be other materials) that are positioned strategically between moving joint components to further ensure that pivoting motion is not restricted at the joints of the humanoid robot 1. Different textile materials, patterns, knits, weaves, etc. may be incorporated to facilitate movement in specific regions, thereby enhancing the functional dexterity of the robot 1.

iii. Sensors

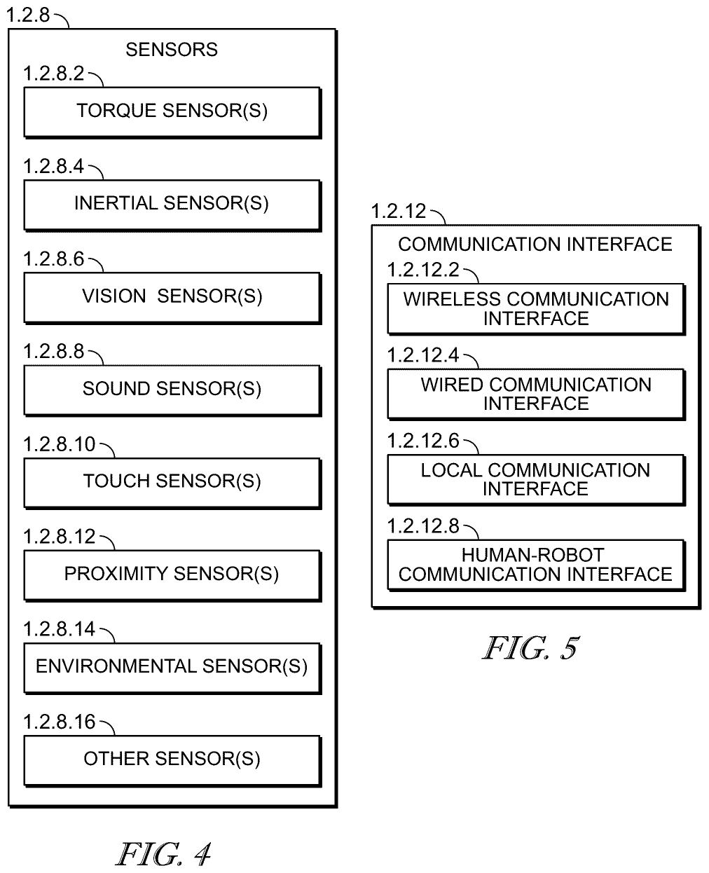

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, visual sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iv. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

v. Data Storage

Referring back to FIG. 2, the data storage 1.2.14 may be embodied as any hardware, software, or circuitry for storing, retrieving, and maintaining data for the humanoid robot 1. More particularly, the data storage 1.2.14 may be embodied as any type of device configured for short-term or long-term storage of data. The data storage 1.2.14 may be embodied as memory devices and circuits, solid state drives (SSDs), memory cards, hard disk drives, USB flash drives, or other data storage devices. The data storage 1.2.14 can be embodied as one or more SSDs that expose internal parallelism to components of the humanoid robot 1, allowing the humanoid robot 1, for example, via the compute 1000, to perform storage operations on the data storage 1.2.14 in parallel.

The data storage 1.2.14 may also include memory devices, which may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards, and similar standards, may be referred to as DDR-based standards and communication interfaces of the storage devices that implement such standards may be referred to as DDR-based interfaces.

The memory device is a block addressable memory device, such as those based on NAND or NOR technologies. A memory device may also include a three dimensional crosspoint memory device (e.g., Intel® 3D XPoint® memory), or other byte addressable write-in-place nonvolatile memory devices. In an embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the device itself and/or to a packaged memory product. For data storage 1.2.14, a hierarchical storage architecture may be employed, using faster, smaller caches for frequently accessed data and larger, slower storage for archival or less critical data, optimizing both speed and capacity.

### E. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in al particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/038,657, 19/064,596, 19/066,122, and 19/180,106; and (iii) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,941, 63/634,599, 63/634,697, 63/635,152, 63/685,856, 63/696,507, 63/696,533, 63/700,749, 63/706,768, 63/707,547, 63/708,003, 63/722,057, and 63/766,911, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A humanoid robot comprising:
an upper region including: (i) a torso, (ii) a pair of arm assemblies coupled to the torso, and (iii) a head and neck assembly coupled to the torso and having a neck portion and a head portion coupled to the neck portion:
a central region coupled to the upper region;
a lower region coupled to the central region and spaced apart from the upper region, the lower region including a pair of legs; and
wherein, while the humanoid robot is in a neutral state and the head portion is in a forward-facing orientation, the head portion includes:
a first sensor in the head portion and having a first line of sight,
a second sensor positioned in the head portion and having a second line of sight that is substantially parallel with the first line of sight, and wherein the first and cameras sensors are not coupled to a single PCB,
an intermediate cover that includes:
(i) a first sensor opening aligned with an extent of the first sensor, and wherein the first sensor opening does not permit a line of sight of another sensor to extend therethrough, and
(ii) a second sensor opening aligned with an extent of the second sensor, and wherein the second sensor opening does not permit a line of sight of another sensor to extend therethrough,
a shield that is positioned forward of: (i) an extent of the intermediate cover, (ii) an extent of the first sensor, and (iii) an extent of the second sensor, and
wherein at least a portion of the first and cameras sensors is obscured by the intermediate cover.

2. The humanoid robot of claim 1, wherein the humanoid robot further comprises a sagittal plane and a transverse plane, and wherein the first line of sight and the second line of sight are positioned within a reference plane, and said reference plane is parallel to either: (i) the sagittal plane, or (ii) the transverse plane.

3. The humanoid robot of claim 1, wherein the shield has an outer surface that has: (a) a first radius of curvature along an extent of a horizontal plane, and (b) a second radius of curvature along an extent of a vertical plane, and wherein the second radius of curvature is less than the first radius of curvature.

4. The humanoid robot of claim 1, wherein the shield includes a rear edge, and wherein an obtuse angle is formed between an extent of the rear edge and a horizontal reference plane.

5. The humanoid robot of claim 1, wherein the shield includes a rear edge with a recess, whereby the recess causes the rear edge to be non-linear.

6. The humanoid robot of claim 1, further comprising a display that is positioned rearward of an extent of the shield, and wherein an extent of the display is curved.

7. The humanoid robot of claim 6, wherein the head portion further includes:
a rear shell; and
an illumination assembly distinct from the display and configured to illuminate a region on the side of the head portion at a location between the shield and the rear shell, and where the illuminated region is visible from a position away from the humanoid robot where at least a portion of the display is not visible.

8. A humanoid robot comprising:
an upper region including: (i) a torso, (ii) a pair of arm assemblies coupled to the torso, and (iii) a head and neck assembly coupled to the torso and having a neck portion and a head portion coupled to the neck portion:
a central region coupled to the upper region;
a lower region coupled to the central region and spaced apart from the upper region, the lower region including a pair of legs; and
wherein, while the humanoid robot is in a neutral state and the head portion is in a forward-facing orientation, the head portion includes:
a first sensor positioned in the head portion and having a first line of sight,
a head housing assembly:
(i) having an intermediate cover, and wherein said intermediate cover is configured to obscure from an external viewpoint at least a portion of the first sensor,
(ii) an exterior surface that includes a non-zero radius of curvature along an extent of a vertical plane,
an aperture is formed in an extent of the head housing assembly and configured to allow the first line of sight to extend therethrough.

9. The humanoid robot of claim 8, wherein the aperture does not permit a line of sight of any other sensor.

10. The humanoid robot of claim 8, further comprising a second sensor: (i) that is separate from the first sensor, and (ii) is positioned in the head portion and rearward of an head housing assembly, and wherein the second sensor includes a second line of sight that is substantially parallel with the first line of sight.

11. The humanoid robot of claim 8, wherein the head portion further includes an illumination assembly configured to illuminate a region on the side of the head portion.

12. The humanoid robot of claim 11, further comprising a display that is separate from the illumination assembly, and where the illuminated region is visible from a position away from the humanoid robot where at least a portion of the display is not visible.

13. The humanoid robot of claim 8, wherein the exterior surface of the head housing assembly includes a radius of curvature along an extent of a horizontal plane that is greater than the non-zero radius of curvature along the extent of the vertical plane.

14. The humanoid robot of claim 8, wherein an extent of the head housing assembly includes a rear edge, and wherein an obtuse angle is formed between an extent of the rear edge and a horizontal reference plane.

15. The humanoid robot of claim 8, wherein an extent of the head housing assembly includes a rear edge with a recess, whereby the recess causes the rear edge to be non-linear.

16. A humanoid robot comprising:
an upper region including: (i) a torso, (ii) a pair of arm assemblies coupled to the torso, and (iii) a head and neck assembly coupled to the torso and having a neck portion and a head portion coupled to the neck portion:
a central region coupled to the upper region;
a lower region coupled to the central region and spaced apart from the upper region, the lower region including a pair of legs;
a vertical reference plane abuts an extent of a rear surface of the neck portion;
a horizontal reference plane that intersects with the vertical reference plane and extends through the rear surface of the neck portion; and
wherein, while the humanoid robot is in a neutral state and the head portion is in a forward-facing orientation, the head portion includes:
a head housing assembly with a frontal shield;
a first sensor positioned in the head housing assembly; and
a display positioned in the head housing assembly and rearward of an inner surface of the frontal shield, and whereby a gap is formed between the display and the frontal shield.

17. The humanoid robot of claim 16,
wherein the frontal shield:
(i) has an outer surface that has: (a) a first radius of curvature along an extent of a horizontal plane, and (b) a second radius of curvature along an extent of a vertical plane, and wherein the second radius of curvature is less than the first radius of curvature,
(ii) including a rear edge, and wherein an obtuse angle is formed between an extent of the rear edge and the horizontal reference plane, and
(iii) lacking an extent that is positioned rearward of the vertical reference plane.

18. The humanoid robot of claim 16, wherein the frontal shield includes an aperture that only allows the first sensor to capture data therethrough.

19. The humanoid robot of claim 18, further comprising a second sensor: (i) that is separate from the first sensor, and (ii) is positioned in the head portion and rearward of an extent of the shield.

20. The humanoid robot of claim 19, wherein the humanoid robot further comprises a sagittal plane and a transverse plane, and wherein the first sensor includes a first line of sight and the second sensor includes a second line of sight, and said first and second lines of sight are positioned within a reference plane, and said reference plane is parallel to either: (i) the sagittal plane, or (ii) the transverse plane.

21. The humanoid robot of claim 17, wherein the rear edge of the shield includes a recess, whereby the recess causes the rear edge to be non-linear.

22. The humanoid robot of claim 16, further comprising a second sensor that is positioned below the display.

23. The humanoid robot of claim 22, wherein the head portion further includes:
a rear shell; and
an illumination assembly distinct from the display and configured to illuminate a region on a side of the head portion at a location between the shield and the rear shell.

24. The humanoid robot of claim 16, wherein an extent of the display is curved along a horizontal plane.
